(19) United States
(12) Patent Application Publication
(10) Pub. No.: US 2026/0208892 A1
(43) Pub. Date: Jul. 23, 2026

(54) METHOD AND SYSTEM FOR MANUFACTURING A THERMAL INSULATION DEVICE

(71) Applicant: Aerogel R&D PTE LTD., Chinatown Point (SG)

(72) Inventors: Jong Chul PARK, Daejeon (KR); Christoph LUDWIG, Germany (DE); Kian Wai LIM, Chinatown Point (SG)

(21) Appl. No.: 19/139,193

(22) PCT Filed: Dec. 15, 2023
(86) PCT No.: PCT/SG2023/050837

§ 371 Date: Jun. 13, 2025

(30) Foreign Application Priority Data
Dec. 16, 2022 (SG) 10202260465W

(51) Int. Cl. B65B 1/06; B65B 1/32; B65B 13/02; B65B 31/04; B65B 49/02; B65B 51/14; B65B 51/18; B65B 61/02; B65B 65/00; H01M 10/658

(52) U.S. Cl. CPC B65B 1/06; B65B 1/32; B65B 13/02; B65B 31/04; B65B 49/02; B65B 51/14; B65B 51/18; B65B 61/02; B65B 65/003; H01M 10/658

(57) ABSTRACT

Method and system for manufacturing a Thermal insulation device. The method comprises: forming a bag from a film material comprising perforations; filling the bag with thermal insulation particles having size that does not pass through the perforations; sealing one or more sides of the bag so that the thermal insulation particles will not exit through the one or more sides of the bag; and after an open side of the bag for filling the thermal insulation particles is sealed, compressing the bag to remove gas contained in the bag. Optionally, the bag is heated as the bag is compressed, and optionally, the bag is cooled as the bag is compressed.

### FIELD

The present invention relates to a method and a system for manufacturing a Thermal insulation device. The Thermal insulation device (or product) may be framed or unframed (frameless). One or more fire retardant sheet (or layer) and/or coating may be added to the Thermal insulation device to further enhance its capabilities. The Thermal insulation device may be used in a battery, for instance, a battery of an Electric Vehicle.

### BACKGROUND

Existing thermal insulation devices containing aerogel as its core material and used in a battery is typically made with an aerogel blanket. An aerogel blanket is comprised of a non-woven matrix that acts as a reinforcement material for the aerogel with widespread use in the energy infrastructure market. An aerogel blanket's characteristics make it ideal for use as thermal insulation device for process lines due its unique ability to combat corrosion under insulation (CUI), it is less than ideal for use in batteries, especially in Battery Electric Vehicles. This non-woven matrix of the aerogel blanket can impact thermal insulation performance and mechanical properties, especially under very high compression that can damage the inorganic fibers and alter the compression characteristics of the aerogel blanket.

Existing manufacturing processes for the above-mentioned thermal insulation devices generally involve manufacturing the rolls of aerogel blanket using a super-critical fluid extraction drying method that is further converted by cutting these rolls into pre-defined parts and encapsulating the aerogel blanket parts for use in a battery. The process of converting a roll of aerogel blanket into parts adds an additional manufacturing cost that can significantly raise the final price of the product. It can be labour intensive, high in scrap rates and difficult to deploy a modern, state of the art Quality Management System (QMS).

There exists another kind of Thermal insulation device described in KR patent no. 102560566B1. Such Thermal insulation device may comprise cover layers sealed to contain aerogel powder between the cover layers. The manufacturing of such Thermal insulation device is challenging as aerogel powder is handled.

### SUMMARY

According to an example of the present disclosure, there are provided a method and a system for manufacturing a Thermal insulation device as claimed in the independent claims. Some optional features are defined in the dependent claims.

### BRIEF DESCRIPTION OF THE DRAWINGS

Examples in the present disclosure will be better understood and readily apparent to one skilled in the art from the following written description, by way of example only and in conjunction with the drawings, in which:

FIG. 1 shows a Thermal insulation device according to an example of the present disclosure.

FIG. 1A shows a Thermal insulation device according to another example of the present disclosure.

FIG. 1B shows a film material according to a further example of the present disclosure.

FIG. 1C shows a film material according to yet another example of the present disclosure.

FIG. 2 illustrates a method of manufacturing a Thermal insulation device according to an example of the present disclosure.

FIG. 3 shows a big bag used to contain raw materials.

FIG. 3A shows two examples of dosing systems that may be used in the method of manufacturing the Thermal insulation device described with reference to FIG. 2.

FIG. 3B shows an example of a mixer that may be used in the method of manufacturing illustrated in FIG. 2.

FIG. 3C shows an example of an equipment set-up for mixing materials for filling into a Thermal insulation device according to an example of the present disclosure.

FIG. 4 shows an example of an apparatus for forming, filling and sealing a bag of a Thermal insulation device according to an example of the present disclosure.

FIG. 4A shows an example of a 3-sided sealed bag of a Thermal insulation device according to an example of the present disclosure.

FIG. 5 shows examples of forming, filling and sealing components of the apparatus of FIG. 4.

FIG. 6 shows a top view of an apparatus for checking weight of a bag of a Thermal insulation device according to an example of the present disclosure.

FIG. 6A shows a front view of the apparatus in FIG. 6.

FIG. 6B shows a perspective view of the apparatus in FIG. 6.

FIG. 7 shows a perspective view of a system comprising the apparatus of FIG. 4 and the apparatus in FIG. 6.

FIG. 8 illustrates an example of a bag of a Thermal insulation device according to an example of the present disclosure that is subjected to a pre-flapping (corner folding) process.

FIG. 8A shows an apparatus for performing the pre-flapping process illustrated by FIG. 8.

FIG. 8B shows an enlarged view of the apparatus for performing the pre-flapping process illustrated by FIG. 8.

FIG. 9 shows tape/adhesive application on flaps or sealing areas of a Thermal insulation device according to an example of the present disclosure.

FIG. 10 shows an apparatus for performing a flapping process to fold sealed sides of a Thermal insulation device according to an example of the present disclosure.

FIG. 10A shows roller sets used for folding the sealed sides of a Thermal insulation device according to an example of the present disclosure.

FIG. 11 shows use of a computer vision system to check length of a bag of a Thermal insulation device according to an example of the present disclosure.

FIG. 11A shows use of a computer vision system to check height of a bag of a Thermal insulation device according to an example of the present disclosure.

FIG. 12 shows an apparatus for degassing, heating and cooling a bag of a Thermal insulation device according to an example of the present disclosure.

FIG. 12A shows a plurality of modules installable to the apparatus of FIG. 12 for degassing, heating and/or cooling purposes.

FIG. 12B shows a side view and a top view of the apparatus of FIG. 12 with a different combination of installed modules for degassing, heating and/or cooling purposes.

FIG. 13 shows an apparatus for performing End-Of-Line (EOL) inspection for Thermal insulation devices made according to an example of the present disclosure.

FIG. 14 illustrates an example of a computer vision system that can check taping quality of tape or adhesive applied to a Thermal insulation device according to an example of the present disclosure.

FIG. 14A shows 4 examples of scenarios of how tape or adhesive can be applied to a Thermal insulation device according to an example of the present disclosure.

FIG. 15 illustrates a stacking process performed for stacking a plurality of Thermal insulation devices according to an example of the present disclosure.

FIG. 15A illustrates a fully stacked bundle of the plurality of Thermal insulation devices of FIG. 15.

FIG. 16 shows 4 examples of compositions comprising a combination of a Thermal insulation device according to an example of the present disclosure, Fire-Retardant devices and/or intumescent sheet/coating.

FIG. 16A shows an example of a Framed Thermal insulation device comprising a Thermal insulation device according to an example of the present disclosure, Fire-Retardant devices and a frame structure.

FIG. 16B shows an example of a Framed Thermal insulation device comprising a Thermal insulation device according to an example of the present disclosure and a frame structure.

FIG. 16C shows possible dimensions of the examples of the Framed Thermal insulation device of FIG. 16A and FIG. 16B.

FIG. 17 shows an example of the steps of a method of manufacturing the Framed Thermal insulation device described in examples of the present disclosure.

FIG. 18 shows an example of a film material used to make a Thermal insulation device according to an example of the present disclosure.

FIG. 18A shows an example of the film material of FIG. 18 containing perforations.

FIG. 18B shows a photograph of a Thermal insulation device having 4-sided seals according to an example of the present disclosure.

FIG. 19 shows an apparatus for making a 4-sided sealed Thermal insulation device according to an example of the present disclosure.

FIG. 19A illustrates sealing area dimensions of a 4-sided sealed Thermal insulation device according to an example of the present disclosure.

FIG. 20 illustrates a process for framing a Thermal insulation device according to an example of the present disclosure.

FIG. 20A illustrates adhesive application for framing a Thermal insulation device according to an example of the present disclosure.

FIG. 21 shows an apparatus for degassing a framed or frameless Thermal insulation device according to an example of the present disclosure.

FIG. 21A shows a bottom perspective view of a top plate of a top conveyor of the apparatus of FIG. 21.

FIG. 21B shows a top perspective view of the top plate of FIG. 21.

FIG. 21C shows a simplified cross-sectional side view comprising of the top plate of FIG. 21B, the Thermal insulation device according to an example of the present disclosure, and a bottom plate of a bottom conveyor of the apparatus of FIG. 21 during a degassing process.

FIG. 21D shows an enlarged view of the apparatus of FIG. 21 to feature adjustable roller guides.

FIG. 21E shows a side view of almost an entire length of the apparatus of FIG. 21.

FIG. 22 illustrates a framing process of the Thermal insulation device according to an example of the present disclosure involving Fire-retardant device insertion.

FIG. 22A illustrates a sealing process of the Framed Thermal insulation device obtained from the framing process of FIG. 22.

FIG. 22B shows an apparatus that can be used for the sealing process described with reference to 22A.

FIG. 23 shows a checkweigher that can be used for weight checking.

FIG. 24 illustrates another framing process of the Thermal insulation device according to an example of the present disclosure.

FIG. 24A illustrates another sealing process of the Framed Thermal insulation device obtained from the framing process of FIG. 24.

FIG. 25 shows a front, rear and side views of a first example of a Thermal insulation device according to an example of the present disclosure with flapped or folded seals.

FIG. 25A shows a front, rear and side views of a second example of a Thermal insulation device according to an example of the present disclosure with flapped or folded seals.

FIG. 25B shows a front, rear and side views of a third example of a Thermal insulation device according to an example of the present disclosure with flapped or folded seals.

FIG. 25C shows a front, rear and side views of a fourth example of a Thermal insulation device according to an example of the present disclosure with flapped or folded seals.

### DESCRIPTION

In the present disclosure, an Electric Vehicle (EV) refers to a vehicle that uses one or more electric motors for propulsion and is typically powered by a battery. Such EV is also known as a Battery Electric Vehicle (BEV). EVs include but are not limited to, road and rail vehicles (e.g. electric scooters, electric bicycles, electric cars, space exploration vehicles, etc.), surface and underwater vessels, electric aircraft (e.g. manned/unmanned planes and air-drones etc.), and electric spacecraft.

### (A) Thermal Insulation Device

In the present disclosure, there is provided a Thermal insulation device with compressible heat shields containing for example, aerogel suitable for, but not limited to, use in a battery suitable for Electric Vehicle (EV). The Thermal insulation device is relatively lightweight in the context of its application in a battery of an Electric Vehicle. The term “Thermal insulation device” refers to said Thermal insulation device throughout the present disclosure.

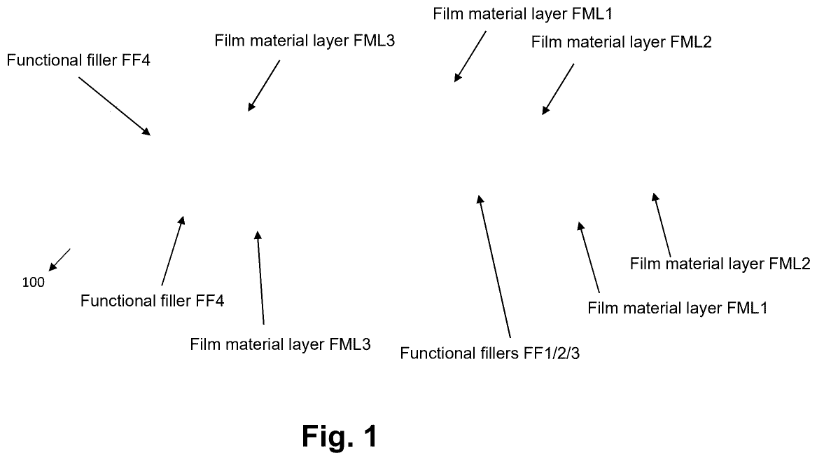

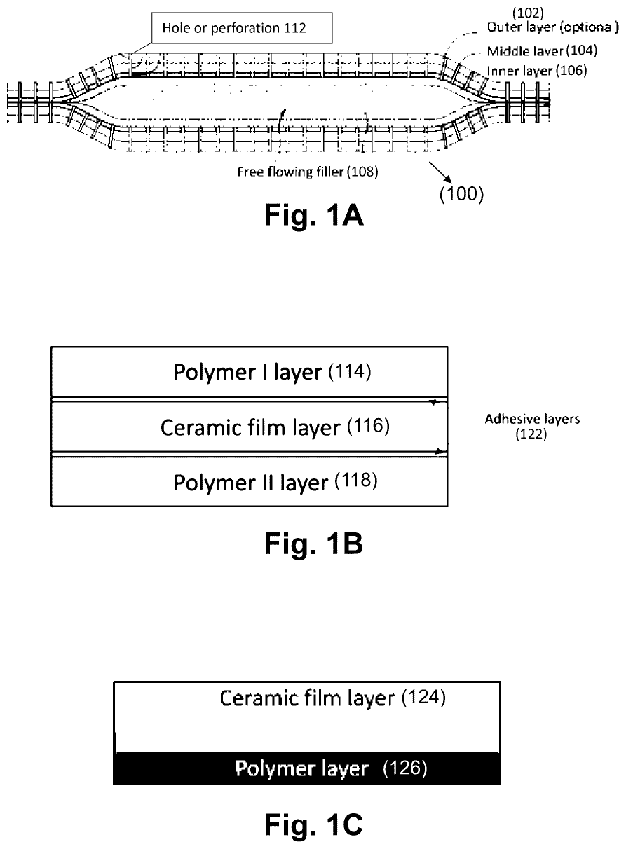

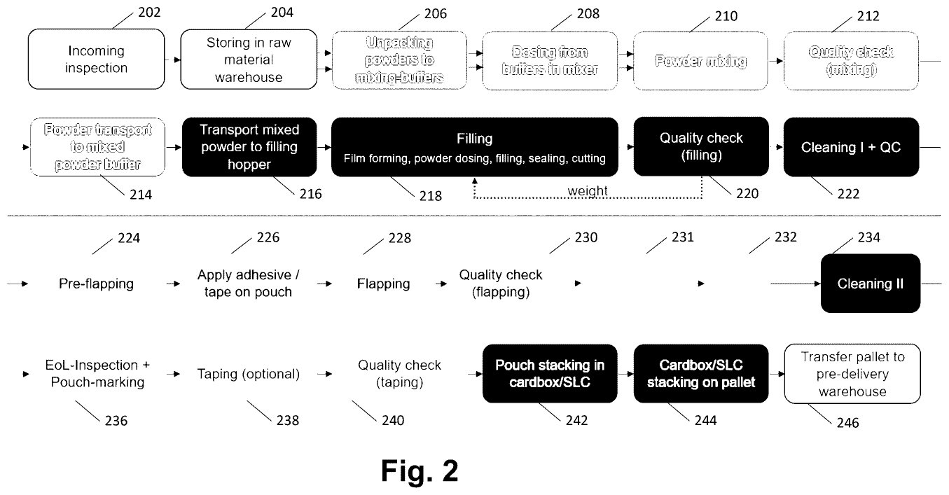

With reference to FIG. 1, one example of the Thermal insulation device 100 is a bag (or packet or sachet or package or pouch or container) filled with aerogel sealed into a “blade” structure. The bag 100 includes 3 film material layers FML1, FML2 and FML3, with the film material layer FML1 being a cover layer, the film material layer FML3 being an inner layer, the film material layer FML2 being disposed between the film material layers FML1 and FML3. The film material layer FML1 is optional and can serve to protect the insulation device 100 from an external environment. The film material layer FML2 blocks heat and fire and provides mechanical strength as a reinforcement layer of the insulation device 100. The film material layer FML3 serves to maintain the shape of the insulation device 100. In one example, the film material layer FML3 may also improve the insulation performance of the insulation device 100 and form an internal structure capable of maintaining a uniformly distributed state of the functional filler. There are perforations (or holes or micro-perforations or pores or openings or orifices) in the film material layers. The average diameter of the perforations (or holes or pores or openings or orifices) may be 15 μm or less. The film material layer FML3 and/or other layer or layers may have a characteristic that when it is heated and cooled to shape during a heating and cooling step to be described later (see step 232 in FIG. 2), the perforations are sealed. Sides of the film material layers are sealed to form the bag 100 with the functional filler contained therein. The functional filler may include are essentially thermal insulation particles.

For example, a first functional filler FF1 may include at least one of an aerogel powder, a fumed silica and glass bubbles. The aerogel powder includes fine particles of silica (SiO₂) with diameters 100 μm or lower.

A second functional filler FF2 may include at least one of titanium dioxide (TiO₂), iron oxide (Fe₂O₃), and aluminum oxide (Al₂O₃). It serves to improve the insulation performance by suppressing the increase in thermal conductivity of the insulation device even in a high temperature environment.

A third functional filler FF3 may include at least one of magnesium hydroxide (MDH), aluminium hydroxide (ATH), and zinc borate. When placed in an EV battery and a fire occurs in the battery pack, the functional filler 3 can be decomposed during the combustion process to release water and non-combustible gases such as nitrogen, ammonia, or carbon dioxide, thereby cooling and diluting oxygen, and simultaneously producing water, which may delay the fire.

A fourth functional filler FF4 may be a reinforcement fiber that encloses the functional fillers FF1-3 therein and is adjacent to the film material layer FML3. The functional filler FF4 includes at least one of glass fiber, a silica wool, a mineral wool, a ceramic wool, a woven fiber, and a non-woven fiber. FF4 may also be a glass fiber veil bound by acrylic resin, which can be a continuous filament glass fiber product. FF4 is an optional layer. FF4 can be said to be an innermost layer in the present disclosure because it contacts FF1, FF2 and/or FF3. If FF4 is not present, FML3 will be such innermost layer.

In one example, FF1 is a key component, whereas FF2 and FF3 are optional . . . . They have to be mixed uniformly or homogeneously prior to filling into the bag of the Thermal insulation device 100.

A table 1 below shows examples of the composition of the Thermal insulation device.

TABLE 1

| | |
|---|---|
| Functional Filler | 0.1 to 0.3 g/cm³ |
| Density | |
| Functional Filler FF1 | 50-100 weight % (wt %) [at least one of aerogel powder, fumed |
| | silica, and glass bubbles] |
| Functional Filler FF2 | 1-20 wt % [at least one of titanium dioxide (TiO₂), iron oxide |
| | (Fe₂O₃), and aluminum oxide (Al₂O₃)] |
| Functional Filler FF3 | 1-20 wt % [at least one of magnesium hydroxide (MDH), |
| | aluminium hydroxide (ATH), zinc borate, aluminium polyphosphate, |
| | and melamine cyanurate] |
| Functional Filler FF4 - | 0.1-2 mm thick and density 30 g/m2 to 200 g/m2 [at |
| This can be an | least one of glass fiber, a silica wool, a mineral wool, a |
| inorganic fiber layer. | ceramic wool, a woven fiber, and a non- woven fabric fiber]. |
| | FF4 can also be a glass fiber veil bound by acrylic resin. |
| Film Material Layer | 10-50 μm thick Polymer film [e.g. at least one of |
| FML1 - This is a cover | polycarbonate (PC), polyimide (PI) film, a polyethylene |
| layer and can be an | terephthalate (PET) film, a cyclic olefin polymer (COP) film, |
| inorganic fiber layer | a casting polypropylene (CPP) film, and a nylon film |
| or polymer layer too. | Or |
| | 10-190 μm thick Woven ceramic fiber or Woven inorganic |
| | fiber e.g. E-glass (nominal weight 10 g/m² to 200 g/m²)] |
| Film Material Layer | 10-190 μm thick, Woven ceramic fiber or Woven inorganic |
| FML2 - This can be an | fiber e.g. E-Glass (nominal weight 10 g/m² to 200 g/m²)] Or |
| inorganic fiber layer | 10-50 μm thick, at least one of Aluminum and mica |
| or polymer layer. | Or |
| | 50-100 μm thick flame retardant thermoplastic composite |
| | where polymers include polycarbonate (PC), and at least one of |
| | polyimide (PI) film, a polyethylene terephthalate (PET) film, |
| | a cyclic olefin polymer (COP) film, a casting polypropylene (CPP) |
| | film, and a nylon film |
| Film Material Layer | 50-150 μm thick polymer [polycarbonate (PC), Polyethylene |
| FML3 - This is a | (PE), polypropylene (PP), polyvinyl chloride (PVC) etc.] |
| polymer layer. | Or its composite with flame retardant |

In the present disclosure, inorganic fiber refers to fiber made from inorganic materials that include, individually or in combination, glass, carbon (referring to the inorganic type), ceramic, basalt, Asbestos, Alumina, Wollastonite, Potassium Titanate, Silicon Carbide, and others.

There may be adhesives used between the film material layers which are laminated to form a single sheet. In some examples, due to high lamination temperature, the polymers in one Film Material layer may penetrate through another Film Material layer (especially when woven inorganic fiber is employed), resulting in less defined layer boundaries. Hence, in the actual physical product, the layers may not be as distinct and neatly stacked as shown in FIG. 1 and there can be some overlap or mix-up in the materials of the layers.

By utilising woven inorganic fiber e.g. E-glass with extremely low organic binder (0.05 wt % to 1 wt %) as component of film material or filler, the resulting insulation device will have lower overall organic contents for better thermal and fire resistance while maintaining good dielectric properties and mechanical strength. To attain higher tensile strength, S-glass fiber could be used. In the case that even higher thermal resistance is required, T-glass fiber could be used.

With the composition and structure of the above-mentioned example in Table 1 above, the typical installed density of the Thermal insulation device insulation device in a battery module assembly under pressure is 0.2 to 0.5 g/cm³. At the relaxed state with no pressure exerted, the apparent density of the Thermal insulation device is 0.05 to 0.4 g/cm³.

The Thermal insulation device 100 may be made, for example, via the following simplified overview of a manufacturing process.
1. Mix functional fillers FF1, FF2 and FF3 homogeneously.
2. Film Material Layers FML1, FML2 and FML3 are laminated to form a single sheet, with film material layers FML1 and FML3 on opposite sides of film material layer FML2. Heat/press sensitive adhesives may or may not be used between the layers. Roll to roll thermal lamination may be used.
3. Form the holes (perforations) in the single sheet using for e.g., a needle roller (or a punch).
4. Form a bag-like structure with one opening using a method such as thermal fusion through the film material layer FML3, with film material layer FML1 on the outer most surface.
5. Dispose functional filler FF4 adjacent to the inner surface of the bag, forming a void.
6. Dispose the mixture of functional fillers FF1, FF2 and FF3 into the void, with functional filler 4 enclosing the mixture.
7. Close and seal the opening of the bag using a method such as thermal fusion, to form a “blade” structure insulation device.

Some examples of the Thermal insulation device 100 are as follows.

With reference to FIG. 1A, an example of the Thermal insulation device 100 may have a film structure comprising an optional outer layer 102 (e.g. for protecting against external environment condition; corresponds to FML1), a middle layer 104 (e.g. for mechanical strength and enhancing protection against heat and fire; corresponds to FML2), and an inner layer 106 (e.g. for locking distribution of filler inside a cavity and maintain shape of the bag; corresponds to FML3).

FIG. 1B illustrates a film structure of a second example of the Thermal insulation device 100 comprising a first polymer layer 114 as outer layer (corresponds to FML1), an inorganic film layer 116 as middle layer (corresponds to FML2) and a second polymer layer 118 as inner layer (corresponds to FML3). The layers 114, 116 and 118 are joined via adhesive 122.

FIG. 1C illustrates a film structure of a third example Thermal insulation device 100 comprising an inorganic film layer 124 as outer layer (corresponds to FML2) and a second polymer layer 126 as inner layer (corresponds to FML3). The polymer layer 126 is partially melted and mixed or penetrated 124 into an inorganic film layer. Such melting, mixture and penetration can be achieved through, for instance, heat lamination. Notably, there is no clear boundary between the inorganic film layer 124 and the second polymer layer 126.

With regard to the examples of FIGS. 1A, 1B and 1C, two pieces of the film structure may be arranged to be on opposite sides and be joined and sealed at side edges, and then filled with filler using a machine or apparatus to be described later to form a bag. The filler may be a free-flowing filler 108 such as aerogel-based material i.e. FF1 and may contain additives like FF2 and/or FF3. The filler is free flowing, for instance, in powder form. There may be a plurality of holes or perforations 112 (see FIG. 1A) provided on the film structures of all 3 examples for ventilation and/or degassing purposes.

In other examples, the Film Material Layer FML2 in FIG. 1, Middle Layer 104 in FIG. 1A, Inorganic Film Layer 116 in FIG. 1B, and Inorganic Film Layer 124 in FIG. 1C can be specifically E-glass fiber woven textile or fabric.

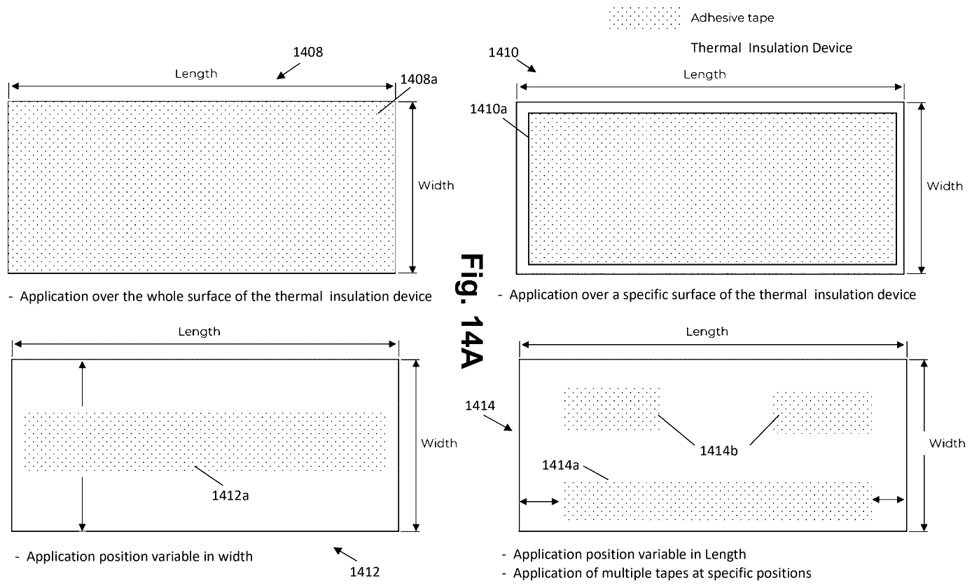

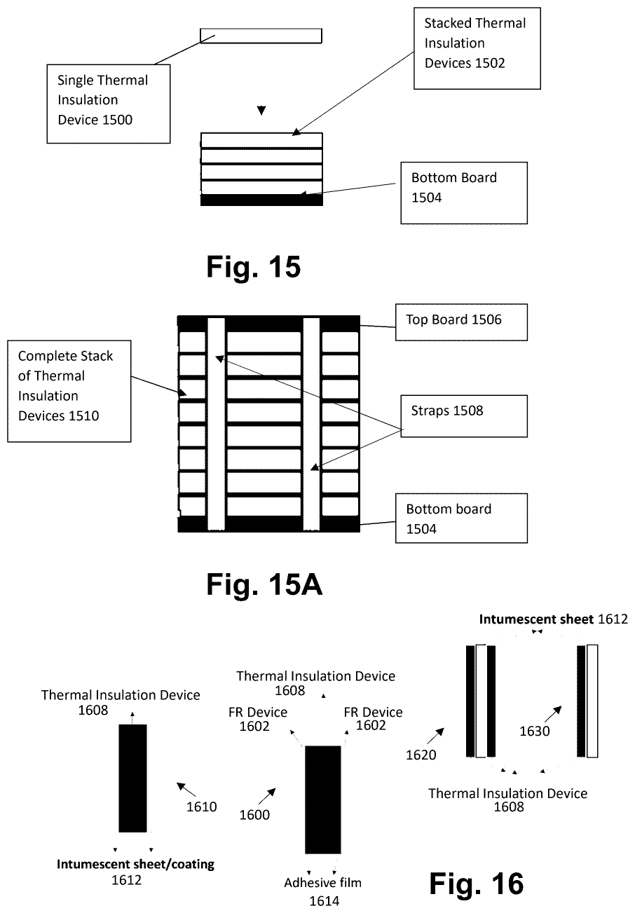

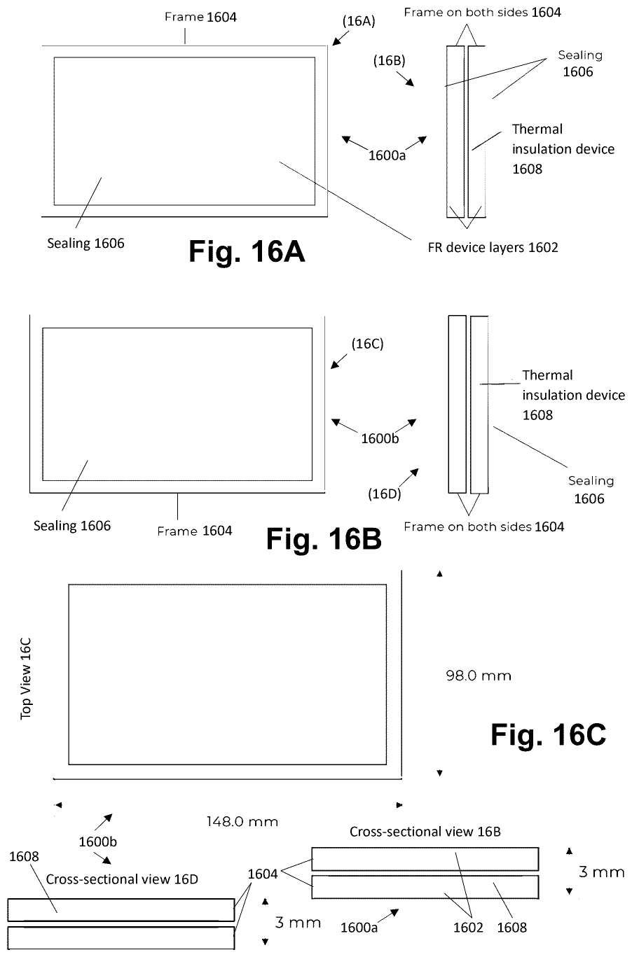

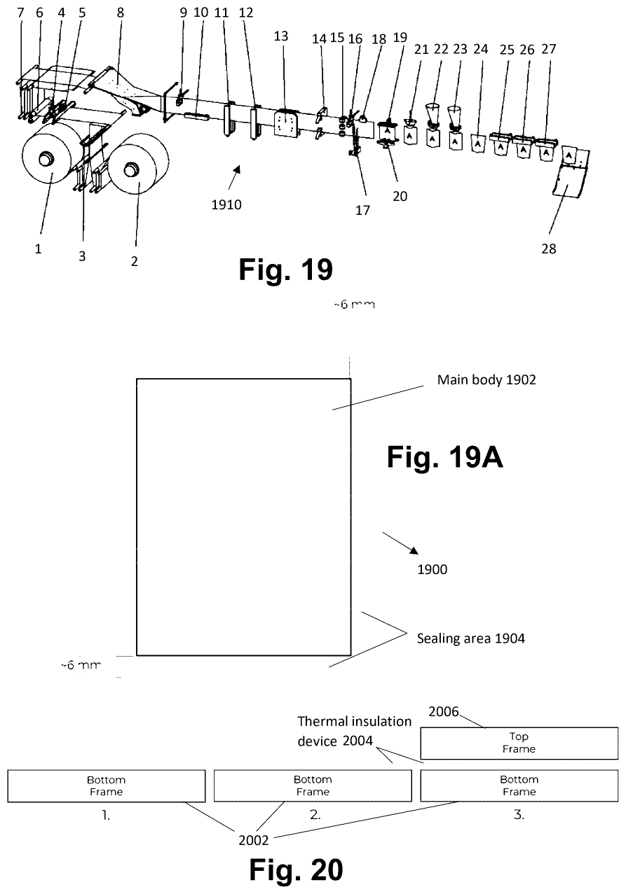

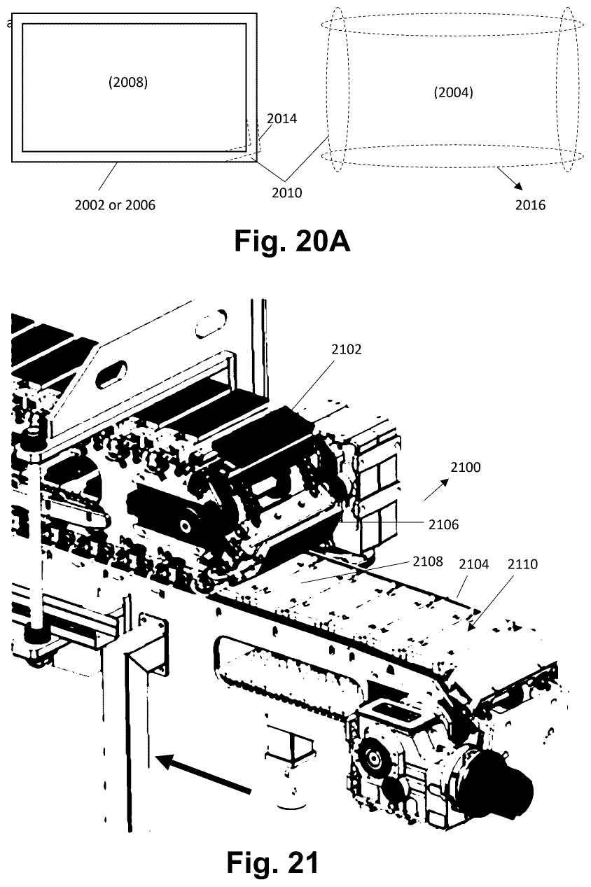

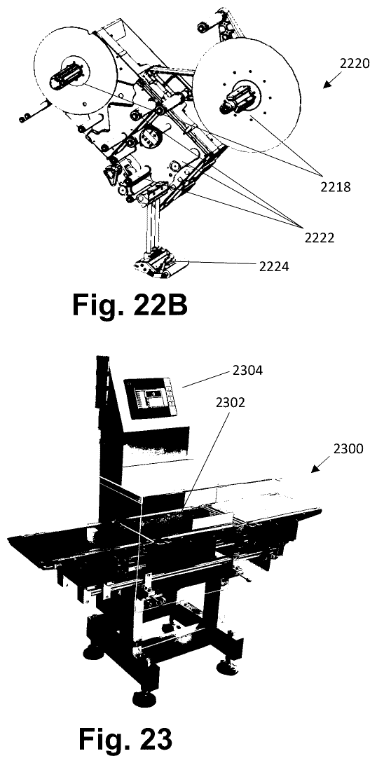

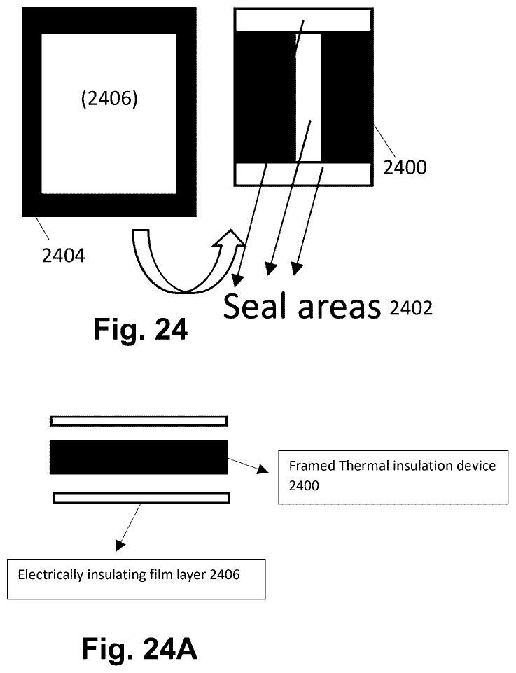

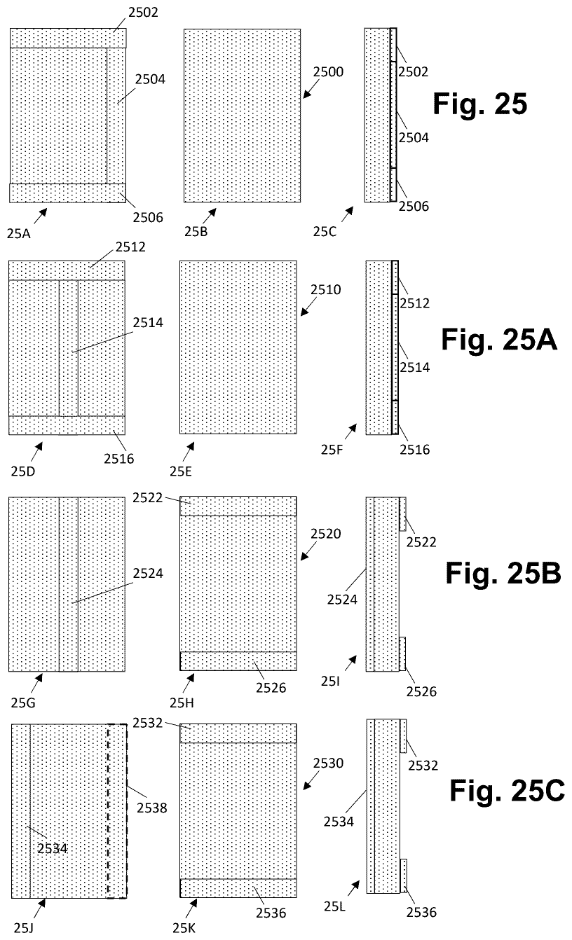

Other examples of fully formed and quality inspected Thermal insulation device are 1500 in FIG. 15, 1608 in FIGS. 16 to 16B, 1800 in FIG. 18 and FIG. 18A, 1804 in FIG. 18B, 1900 in FIG. 19A, 2004 in FIG. 20, 2200 in FIG. 22, 2400 in FIG. 24, 2500 in FIG. 25, 2510 in FIG. 25, 2520 in FIG. 25, and 2530 in FIG. 25.

Another example of the Thermal insulation device may comprise:
functional fillers (e.g. FF1, FF2, and/or FF3) enclosed in a bag, wherein the bag is made of a film material (e.g. a combination of FF4, FML1 to FML3) comprising at least: an inorganic fiber layer (e.g. FML2 102); and a polymer layer (e.g. FML3 103),
   wherein the inorganic fiber layer is layered over the polymer layer,
   wherein the bag comprises sealed sides formed by sealing the film material, the functional fillers are enclosed in the bag such that the functional fillers do not escape through the sealed sides of the bag, and
   the functional fillers comprise thermal insulation particles in powder form (e.g. FF1). With reference to table 1, other combinations of inorganic fiber layer layered over the polymer layer can be:
a) FML1, FML2 or FML3 as polymer layer in contact with the FF4 as inorganic fiber layer;
b) FML1 or FML2 as an inorganic fiber layer in contact with FML2 or FML1 as polymer layer respectively;
c) FML1 as an inorganic fiber layer in contact with FML3 as polymer layer (FML2 is not present in this case), etc.

In this example, “layered over” could mean that the inorganic fiber layer is on top of the polymer layer or the polymer layer is on top of the inorganic fiber layer. The inorganic fiber layer is preferably woven. It is also preferable that the functional fillers are non-matrix in the sense that there is no network forming, no crosslinking with binder, and/or no structural reinforcing materials present in the functional fillers. In this case, the functional fillers are different from the aerogel blanket discussed in the background section of the present disclosure.

All the examples of Thermal insulation device stated in the present disclosure can be used for a Framed Thermal insulation device and its combined use with other products (e.g. a Fire Retardant product called “Fire-retardant device”) which are described below.

### (B) Fire-Retardant Device

In the present disclosure, a Fire-retardant device refers to an intumescent sheet suitable for, but not limited to, thermal runaway management of an Electric Vehicle battery. The thickness of the sheet is less than 2 mm, and preferably lesser than or equal to 1 mm. For example, the intumescent sheet is formed by impregnating non-woven inorganic fiber with alkali-silicate based solution (hereinafter “impregnating solution”). The impregnating solution may be a water-based intumescent coating containing aerogel. The impregnating solution may comprise additives and after it is dried and/or cured, the intumescent sheet has an alkali silicate based coating with the additives. This Fire-retardant device is the FR Device 1602 in FIG. 16 and FIG. 16A. The intumescent sheet 1612 in FIG. 16 may also be this Fire-retardant device. The term “Fire-retardant device” refers to said Fire-retardant device throughout the present disclosure.

The composition of the intumescent sheet (after drying) and the composition of the impregnating solution of an example of the Fire-retardant device is described as follows.

The intumescent sheet may comprise a non-woven inorganic fiber mat (or fabric) e.g. ECR-50 from Owen's Corning (a type of E glass). The impregnating solution used for this product comprises a sodium-silicate based binder and aerogel fine particles with hydrophobic surface groups. The particle size of the aerogel particle is between 10-60 μm and its porosity is more than 90%. Alumina (a type of metal oxide) and metal dihydroxide (a type of metal hydroxide) is added as an additive into the impregnating solution to improve the mechanical robustness, insulation and fire-retardant properties of the char.

The tables 1a and 1b below shows examples of the composition of the Fire-retardant device after drying and the composition of the impregnating solution. Table 2 below shows selected properties of the Intumescent Sheet.

TABLE 1a
Composition of the Intumescent Sheet (After Drying)

| | | Preferred loading |
|---|---|---|
| | | level (weight % |
| | | of the intumescent |
| Constituents | Function | sheet) |
| Dried sodium silicate | Binder | 75-85 |
| Surfactant | Dispersing Agent | 0.2-1.2 |
| Aerogel fine particles | Main Performance | 1-5 |
| with hydrophobic | Agent (Thermal | |
| surface groups | insulation imparting | |
| | additive) | |
| Metal oxides/hydroxides | Sub Performance | 3-8 |
| (e.g. alumina and | Agent (Char strength | |
| magnesium dihydroxide) | enhancing ceramic | |
| | additive) | |
| Non-woven glass fiber mat | Main Performance | 8-16 |
| (e.g. ECR-50 from Owen's | Agent | |
| Corning (a type of E glass) | | |

TABLE 1b
Composition of the impregnating solution

| | | Preferred Loading |
|---|---|---|
| | | level (weight % of |
| Constituents | Function | the solution) |
| Sodium silicate (aqueous, | Binder | 92-97 |
| 60 wt % water) | | |
| Surfactant | Dispersing Agent | 0.2-1 |
| Aerogel fine particles | Main Performance | 0.8-2 |
| with hydrophobic | Agent (Thermal | |
| surface groups | insulation imparting | |
| | additive) | |
| Metal oxides/hydroxides | Sub Performance | 2.0-4.5 |
| (e.g. alumina and | Agent (Char strength | |
| magnesium dihydroxide) | enhancing ceramic | |
| | additive) | |

TABLE 2
Selected properties of the Intumescent Sheet.
Selected Properties of the Intumescent sheet

| Property | Value | |
|---|---|---|
| Density of sheet after curing | 1-2 | g/cm³ |
| Expansion Ratio (Char | 3-4.5 | |
| thickness/original sheet thickness) | | |
| Thermal Conductivity of | 0.04-0.15 | W/mK |
| char after expansion | | |

| | |
|---|---|
| Compressive Strength of char | At 20% strain: 40-300 kPa; |
| | At 40% strain: 250-300 kPa; |
| | At 60% strain: 1000-1400 kPa; and |
| | At 80% strain; 1650-2100 kPa |

Surfactant that is stable in a range of pH 2 to 12 may be added to the impregnating solution to improve the ability to spread and wet the non-woven inorganic fiber mat. Preferably, the surfactant is chosen from a group comprising of an amine oxide, an alkyl carbohydrate ester, an alkoxylated polysiloxane and a poly alkyl acrylate. The surfactant loading level may be between 0.2 to 0.5 wt % of the impregnating solution, whereas the preferred loading level may be 0.2 to 1.2 wt % of the intumescent sheet.

With regard to the non-woven inorganic fiber mat of the Fire-retardant device, besides E-type glass, S-type is another preferred option. If E-type glass is used, E-type glass with boron oxide element removed is most preferred. The diameter and length of the fiber should be between 10-15 μm and 15-60 mm.

Other thermal insulation imparting additive (i.e. an agent that enables formation of char with a dense network) that is microporous, such as fumed silica, hollow microglass spheres, can also be used. Other suitable char strength-imparting ceramic additives can also be used, e.g. a combination of metal oxide, metal hydroxide, metal carbonate, metal silicate, and/or metal powder.

In addition to the constituents described above, optionally, the intumescent sheet can be added with 1 to 10 wt % of an opacifier, such as iron oxide, silicon carbide, and/or titania. The opacifier provides high temperature thermal insulation and serves to reflect and thereby reduce heat transfer via radiation at high temperatures.

The organic additive can be added at the impregnation station (where the impregnation of the non-woven inorganic fiber mat and the impregnating solution is performed) to enhance flexibility and water resistance of the intumescent sheet. Glycerol and polyvinyl alcohol are preferred examples of organic additives.

The production of the impregnating solution involves the sequential addition of alkali-silicate solution and one or more surfactant(s), followed by insulation imparting agents, char strength-imparting agents and other additives, and finally the necessary amount of water with stir-mixing after each step (i.e. after adding each component sequentially) for 15 mins and finally stir-mixing solution with all added components for a further 2-3 hours. Hardening agent is the last constituent to be added into the impregnating solution and it is just before impregnating the non-woven inorganic fiber mat. The viscosity is preferably between 200-500 centipoise (cps).

The hardening agent is preferably sodium fluorosilicate or Potassium methyl siliconate (being the most preferred).

If opacifier, hardening agent, and water are added, the composition of the impregnating solution is in Table 3 as follows.

TABLE 3
Composition of the impregnating solution (A
variant of the product in Table 1b above)

| | Loading level (wt % |
|---|---|
| Constituents | of the solution) |
| Sodium silicate (aqueous, 60 wt % water) | 70-95 |
| Surfactant | 0.05-2 |
| Aerogel fine particles with hydrophobic | 0.5-10 |
| surface groups | |
| Metal oxides/hydroxides (e.g. alumina and | 1-10 |
| magnesium dihydroxide) | |
| Opacifier | 1-10 |
| Organic additive (e.g. glycerol) | Less than 10 |
| Hardening agent (e.g. potassium methyl | Less than 10 |
| siliconate) | |
| Water | 2-10 |

To produce the intumescent sheet, the non-woven inorganic fibermat is firstly layered on a non-stick polymeric sheet and impregnated by an aqueous alkali-silicate based solution (i.e. the impregnating solution).

Various methods of impregnation could be adopted such as spraying, brushing and/or doctor-blading. Preferably, doctor-blading is adopted for better thickness control and viability for high volume production. Drying is then performed at a suitable temperature (e.g. room temperature) to remove the water without causing defects such as warping. Optionally, curing can be performed at a higher temperature (e.g. via microwave heating) to quicken the process.

Other char strength enhancing additives that may be added include Zirconium Oxide and Colloidal silica. Sodium Silicate is defined by the molar ratio between Silica:sodium oxide. Increasing the ratio of silica enables the formation of a stronger char and the addition of Colloidal silica can adjust the increase.

### (C) Thermal Insulation Device Manufacturing Process

As described earlier, the Thermal insulation device is essentially a bag (can be also known as packaging, pouch, or container) containing thermal insulation particles including particles in powder form. The thermal insulation particles may include for instance, silica aerogel fine particles and a metal oxide as opacifier. More examples of the film material layers (FML1 to FML3 and FF4) of the Thermal insulation device and the thermal insulation particles (FF1 to FF3) are provided in table 1 above and in later parts of this present disclosure. The thermal insulation particles are filled and sealed in the bag. The bag may be made of a custom designed film comprising of polymer and glass fabric. These bags may be de-aerated and compressed to a desired density to form a compressible and super-insulating Thermal insulation device. The bag is preferably squarish or rectangular in shape and can be sealed at 3 or 4 sides. Other shapes are possible as well depending on the application of the bag. Such Thermal insulation device may be optimized for use as a thermally insulating cell spacer for use in Li-ion batteries typically used in Electric Vehicles.

A manufacturing process overview of the Thermal insulation device is described as follows.

At a step 202, raw materials are received and checked to ensure the right materials and quantity are received.

At a step 204, the raw materials are stored in a raw material warehouse.

At a step 206, powders required for making a mixed powder (i.e. the final powder to fill each bag of the Thermal insulation device) are unpacked and placed in one or more mixing buffers.

A buffer refers to a container or storage for holding or storing powder. The buffer may be a hopper. Each mixing buffer may contain different types of powder. For instance, one of the mixing buffers may hold silica aerogel fine particles and another mixing buffer may hold metal oxide (opacifier) powder. If other materials are to be added, a further mixing buffer can hold them. A mixing buffer may be a bowl or funnel shaped component with a wide receiving area and has sufficient depth or height for holding powder.

At a step 208, powder is dosed or dispensed from the one or more mixing buffers in the right quantities to a mixer.

At a step 210, the mixer mixes the powder dosed or dispensed to the mixer for mixing. A mixing stirrer or other suitable equipment may be provided for mixing the dispensed powders homogeneously.

At a step 212, mixing quality is checked. For instance, computer vision or X-ray may be used to detect whether the mixed powder is sufficiently homogeneous.

At a step 214, the mixed powder that has passed the quality check is dispensed or transported to a mixed powder buffer or storage.

Steps 206 to 214 can be performed onsite as part of a continuous process with steps 216 to 220 or done offsite, and in this case, the mixed powder produced has to be transported to the site where steps 216 to 220 are carried out.

At a step 216, the mixed powder obtained after step 214 is transported to or poured into a filling hopper for filling powder into bags. The filling hopper is attached to an apparatus or a machine and is configured to feed the apparatus with the mixed powder.

At a step 218, the apparatus performs film and/or bag forming, powder dosing, filling of formed bag, sealing of bag and cutting of filled bag to individual bag size. After step 218, a bag containing the mixed powder is formed by the apparatus. Each bag can be made from one or more rolls of film being feed to the apparatus for shaping to form the bag. A sheet of film may be perforated and packaged in a roll of film. Each sheet of film may comprise multilayers, for instance, the film material layers FML1 and/or FML2 and/or FML3 may form the multilayers. In one example, the film material for forming the bag is pre-made and provided in a bulk roll for bag forming. The perforations should be small enough to prevent powder from leaking through the perforations.

At a step 220, a quality check on the filling is done. This is done through a weight check. Each bag is weighed to check that it satisfies a pre-determined weight requirement. A bag not satisfying the weight requirement will be rejected and stored in a rejected product container. Depending on the condition of the rejected products, each of them may be subjected to the weight check again or refilled. Good bags or bags that passed the quality check will be transported to the next station for further processing. Assuming that a squarish or rectangular shaped bag is to be formed, the formed bag at the end of step 220 will have 3 or 4 sides with a flap formed due to the side sealing done by the apparatus at step 218.

At a step 222, a first cleaning step is conducted to clean each bag that has passed the quality check at step 220. After cleaning, an optional quality check on the cleanliness of each bag is done. The cleaning can be done via air purging i.e. air is blown over the bag to clean it and/or the bag is subject to vacuum suction wherein powder (if any) is sucked from the bag and/or through other suitable cleaning methods. This first cleaning step is useful, for instance, in the case that powder leaks (or spills) at the filling hopper or at the apparatus, a bag bursts or leaks at step 218 or 220. Step 222 is optional but recommended.

At a step 224, pre-flapping is done. Such pre-flapping refers to the flapping or folding of each corner of each bag. In the case of a squarish or rectangular bag, each corner refers to each of the 4 pointed corners. This is done to ensure that powder leaks will not occur at the corners of each bag. Step 224 is optional but recommended.

At a step 226, after pre-flapping is done or if pre-flapping is skipped, adhesive or tape is applied on the flaps of the bag in preparation for flapping or folding the flaps to stick them to the body of the bag.

At a step 228, flapping or folding of the flaps of each bag to stick them to the body of the bag is performed. This flapping step helps to prevent the flaps from getting in the way of assembly of the bag in another product such as in an Electric Vehicle battery. The flapping also creates an obstruction for the powder at a folding line of the flaps, which helps to prevent the powder from leaking through the sealed flaps in the case that they are not sealed properly or the seal deteriorates and results in decreased sealing performance due to wear and tear, poor storage, or over long periods of time.

At a step 230, a quality check on the flapping is done. Computer vision techniques can be used for this check.

At a step 231, levelling of each bag is performed to distribute the powder inside the bag homogeneously. For example, this can be done by vibration. This step can be performed independently before degassing, or combined with the degassing process described below.

At a step 232, each flapped bag is transported to a station for conducting 1) degassing, 2) heating and 3) cooling of the bag. These 3 steps can be conducted in the following manner. During degassing, the bag is compressed to let air escape the bag. Such degassing involves exerting pressure on the major surfaces of the bag to flatten the bag. As the film layers of the bag contain micro-perforations, the gas is released through these perforations. After or during pressure exerting, the bag is heated and during heating, for instance, the film layers soften to form the bag, which helps to release more gas from the bag. After heating, the bag is subjected to cooling. The cooling can be active cooling, in which temperature is brought down actively to cool down the bag fast. Alternatively, the cooling can be done naturally as well. Preferably, the bag is put under compression throughout the 3 steps.

At a step 234, a second cleaning step is conducted to clean each bag that has been degassed at step 232. An optional cleaning quality check can be done after cleaning as well. The cleaning can be done via air purging i.e. air is blown over the bag to clean it and/or subject to vacuum suction, wherein powder (if any) is sucked from the bag and/or through other suitable cleaning methods. This second cleaning step is useful, for instance, in the case that powder leaks (or spills) from a bag or a bag bursts during step 232. Step 234 is optional but recommended.

At a step 236, an optional but recommended End of Line inspection (quality check) should be done for each bag. Through computer vision techniques or other suitable methods, the bag weight, dimensions, visual appearance, creasing and flatness, powder leakage, and/or thickness etc. are inspected to ensure that quality requirements are met. An optional bag labelling or marking step can be performed after the inspection. At this labelling or marking step, for instance, an inkjet or laser printer can be used to label or mark out manufacturing details, and/or product details etc. on the external film layer of each bag.

At a step 238, an optional taping step of the bag may be performed to provide the bag with a tape so that the bag can be adhered to a surface as required of the application of the bag. A release liner may be provided on the tape if the bag is not to be assembled immediately into another component, such as an Electric Vehicle battery. A release liner or release paper is basically a paper or plastic-based film sheet used to prevent a sticky surface from prematurely adhering.

At a step 240, the quality of the taping performed at step 238 is checked to ensure that the taping and/or release liner attachment is done properly. Computer vision techniques can be used for this check.

At a step 242, the bag is packaged and made ready for delivery. For instance, this can be done by first stacking and strapping the bags into bundles and the bundles are then packed into cardboard boxes.

At a step 244, cardboard boxes filled with bags are stacked on a pallet.

At a step 246, the pallet is transferred to a pre-delivery warehouse, ready to be delivered.

In general, the key components of the abovementioned manufacturing process are forming of a bag and filling of powder into the bag, flapping of sealed sides of the bag, degassing and heat treatment.

Examples of Steps 206 to 214 directed to powder mixing is described in detail as follows.

In one example, the raw materials required for the mixing process include aerogel particles in powder form and iron oxide particles in powder form.

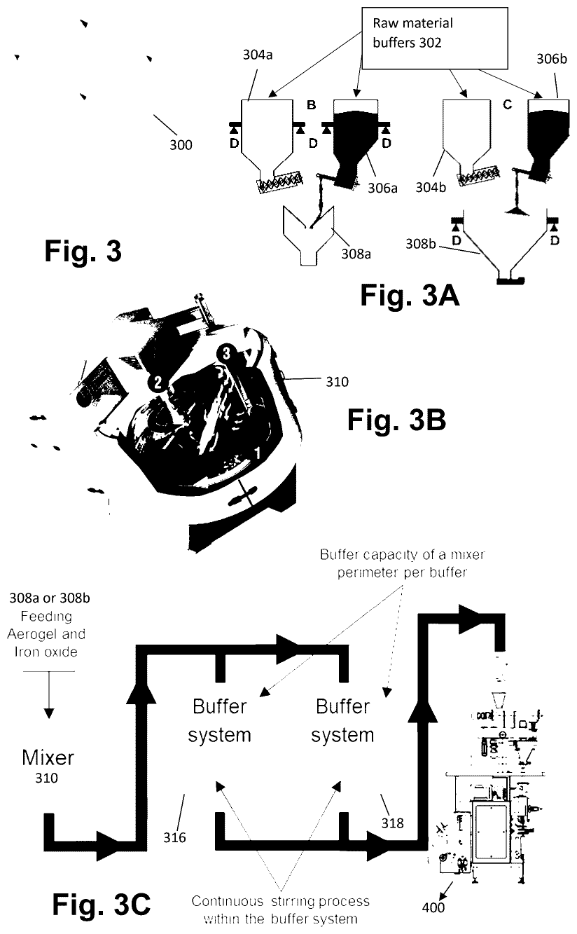

The raw material can be supplied in different ways. One possibility could be in a big or large bag 300 illustrated by FIG. 3. The raw material will be unloaded from such big bag and will be transferred to a dosing system. A powder transport system may be used to transport the raw material powders to the dosing system. The powder transport system may include a vacuum feeder and/or a screw feeder or conveyor for transporting the raw material powders to the dosing system. At the dosing system, there is more than one containers for containing powder of different types of raw material i.e. the containers are sorted by material. Each of these containers can be a hopper.

FIG. 3A shows examples of 2 types of dosing systems, namely B and C, that can be used to obtain the desired powder combination before the combined powder is mixed by a mixer. A vacuum feeder can be used to suck powder contained in the big bag 300 using vacuum suction and transport the powder to respective raw material buffers 302 in the dosing systems B and C. Alternatively, screw feeders or conveyors (e.g. involving use of an auger screw) may be used or used together with the vacuum feeder to transport powder to the respective raw material buffers 302 in the dosing systems B and C. For instance, aerogel powder may be transported to hoppers 304a and 304b in dosing systems B and C respectively. Additives like iron oxide powder may be transported to hoppers 306a and 306b in dosing systems B and C respectively. More buffer hoppers like 304a and 304b may be used if there are more than 2 types of powder to combine.

The dosing system B may comprise screw feeders or conveyors (e.g. involving use of an auger screw) for dosing powder in desired quantities from the buffer 304a and 306a to a holding hopper 308a.

An auger screw is part of a screw conveyor, or auger conveyor, which is an industrial equipment used for transporting bulk quantities of granular solids (e.g., powder, grains, granules), semi-solids, liquids, and even non-flowing materials from one point to another. The holding hopper 308a is used to dispense powder dosed from the buffers 304a and 306a into the mixer. A larger size auger screw can be used for faster dosage of the aerogel powder, which has higher quantity in each bag of the Thermal insulation device and a smaller size auger screw can be used to dose the iron oxide powder, which has lower quantity in each bag of the Thermal insulation device.

Examples of the types of the mixer to use include a pneumatic mixer, a vertical mixer with an agitator and chopper, and a vacuum mixer. Mixing time depends on the mixing process and the type of mixer. FIG. 3B shows an example of the mixer 310. The mixer 310 comprises a mixing chamber 1, a stirrer 2 which rotates to mix the powder fed into the mixing chamber 1, and an air pump 3 to pump air into the mixer to facilitate the mixing process.

Referring back to FIG. 3A, similarly, the dosing system C may comprise screw feeders or conveyors (e.g. involving use of an auger screw) for dosing powder in desired quantities from the buffer 306a and 306b to a holding hopper 308a and 308b. The holding hopper 308b is used to dispense powder dosed from the buffers 304b and 306b into the mixer (e.g. 310 in FIG. 3B).

The dosing system B differs from the dosing system C in that the dosing system B adopts synchronous raw material feeding, whereas the dosing system C adopts asynchronous raw material feeding.

The dosing system B comprises load cells D (load cells are also known as weighing device or weight sensor in the present disclosure) installed at the buffers 304a and 306a respectively to weigh the contents contained in the buffers 304a and 306a respectively. The powders in the buffers 304a and 306a are simultaneously dosed or poured (i.e. at the same time) into the hopper 308a. The right amount of powder dosage is determined by the decrease in weight of each buffer 304a and 306a. It is optional to have the holding hopper 308a and it is possible to have the powders dosed directly into the mixing chamber 308a.

The dosing system C comprises load cells D installed at the holding hopper 308b to weigh the contents contained in the holding hopper 308b. There are no load cells D at the buffers 304b and 306b. In this case, the powders in the buffers 304b and 306b are asynchronously dosed or poured (i.e. at different time) into the hopper 308b. For example, firstly, the right amount of powder is dosed into the hopper 308b from one of the buffers 304b and 306b until the desired weight is measured by the load cells D at the hopper 308b. Secondly, the right amount of powder is dosed into the hopper 308b from the other buffer 306b or 304b until the desired weight is measured by the load cells D at the hopper 308b.

An optional mixing quality check may be performed. Such mixing quality check may involve obtaining only a powder sample from one batch of powder mixture output from the mixer for checking, or to check all the mixed powder in one batch of powder mixture output from the mixer. In the case of powder sample checking, if the powder sample passes the check, the entire batch of powder mixture passes the check. The objectives of the mixing quality check may include checking that the powder composition, the particle size distribution and the homogeneity of the powder mixture meet requirements. The check or checks may involve use of, for instance, Scanning electron microscopy (SEM) imaging, X-ray system, or techniques involving Laser Diffraction (LD), Dynamic Light Scattering (DLS), Dynamic Image Analysis (DIA) and/or Sieve Analysis. In the case that the quality of all mixed powder is checked, powder mixture passing the check and identified as good will be transferred to one or more buffer systems to get ready for further processing. Not good (NG) powder can be transferred to a station for re-working or be rejected and discarded.

An example of a system architecture for powder mixing, storage, and transfer is shown in FIG. 3C. This example is described as follows. The holding hopper 308a or 308b of the dosing system B or C respectively feeds a powder mixture of aerogel particles and iron oxide into the mixer 310. If mixing quality check is involved, the mixing quality check is conducted on the powder mixture output from the mixer 310 and good powder that passed the quality check is transferred to one or more buffer systems 316 and/or 318. A buffer system refers to a storage (or store) for the powder mixture and in addition to storage, the buffer system may be configured to have a stirrer or to blow air to provide continuous stirring of the powder mixture to ensure homogeneity. If no quality check is involved, the mixed powder or powder mixture is transferred to the one or more buffer systems 316 and/or 318. The use of at least two buffer systems is preferred as the second or more buffer systems allows the traceability of mixture by powder batches. That is, each buffer system can be associated with one batch of powder mixture. It is preferable to produce the mixed powder by batches for better accountability. The contents of each batch of mixed powder may be defined in terms of buffer capacity of a mixer perimeter per buffer system. The mixed powder in each buffer system 316 and 318 can be transferred in batches to an apparatus 400 for bag forming, powder filling and sealing. The mixed powder can be transferred to the apparatus 400 via a vacuum feeder and/or a screw feeder or conveyor.

The system of FIG. 3C can comprise a control station (not shown), which comprises one or more processors or controllers for controlling the process. The control station may have a display for showing a graphical user interface for user control and setting. The display may be a touch screen display. The control station may comprise light indicators for indicating whether the system is in operation, in various stages of operation, or not working. A plurality of user interfaces such as buttons, knobs, switches etc. may be provided at the control station for controlling the system. The system also comprises one or more motor or engine for driving its moving parts and a power supply.

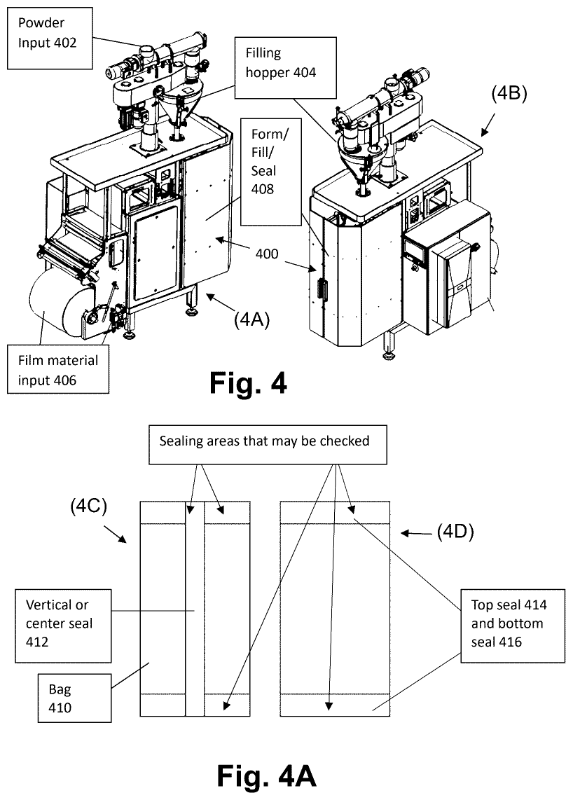

Steps 216 and 218 are described in more detail below with reference to an example illustrated by FIG. 4. FIG. 4 shows a front perspective view 4A and a rear perspective view 4B of the apparatus 400 in FIG. 3C. This apparatus 400 is a vertical form, fill and seal machine. The apparatus 400 comprises one or more motor or engine for driving its moving parts and a power supply.

The key components performed by the apparatus 400 are bag forming, powder filing, and bag sealing. In the case that steps 206 to 214 of FIG. 2 are performed onsite as part of a continuous process with steps 216 to 220, the inputs to the apparatus 400 include firstly, the mixed powder to be transferred from the last powder mixing step 214 through a powder input point 402 into a filling hopper 404 and secondly, film material 406 provided from a roll of film. The film material 406 is pre-made and can have, for instance, the film structure of the examples described earlier in Table 1 and shown in FIG. 1A, FIG. 1B and FIG. 1C, and the examples having short names of PET/EG/PE or PET/AL/PE that would be described later. In the present example, the output from the apparatus 400 is a three-sided sealed bag, filled with the mixed powder. In another example, the bag may be a four-sided sealed bag. The forming, filling and sealing components 408 are locked in a cabinet of the apparatus 400 and are not visible in FIG. 4.

FIG. 4A shows a rear view 4C and a front view 4D of an example of a bag 410 made by the apparatus 400 that is rectangular in shape and having 3-sided sealing. The 3-sided sealing comprises one vertical or centre seal 412, and two side seals, namely a top seal 414 and a bottom seal 416. The vertical seal 412 is disposed between the two side seals 414 and 416 and joined to the two side seals 414 and 416 at the ends of the vertical seal 412. The vertical seal 412 can be said to be orthogonal to the two side seals 414 and 416, which are disposed horizontally relative to the bag 410. For example, the seals 412, 414 and 416 of the bag may have a sealing width of between 10-20 mm.

An overview of how the bag 410 is formed is as follows. The film material (i.e. 406 of FIG. 4) from the roll of film is rolled to form a tubular structure and two opposite sides of the film material are joined through the sealing of the vertical seal 412. After the vertical seal 412 is sealed, the bottom seal 416 is sealed and a preformed bag with an open top side or end is formed. The powder is dosed or fed into the preformed bag through the open top side or end. Once the preformed bag is filled, sealing to form the top seal 414 is done to close the opening of the open top side or end.

The forming, filling and sealing components 408 of FIG. 4 for performing the respective forming, filling, sealing processes are combined and performed by one machine i.e. by the apparatus 400. Such components 408 are configured to fill powdery and/or granulated products, such as the mixed powder output from the buffer systems 316 and/or 318 in FIG. 3C, into the bag (e.g. 400 in FIG. 4).

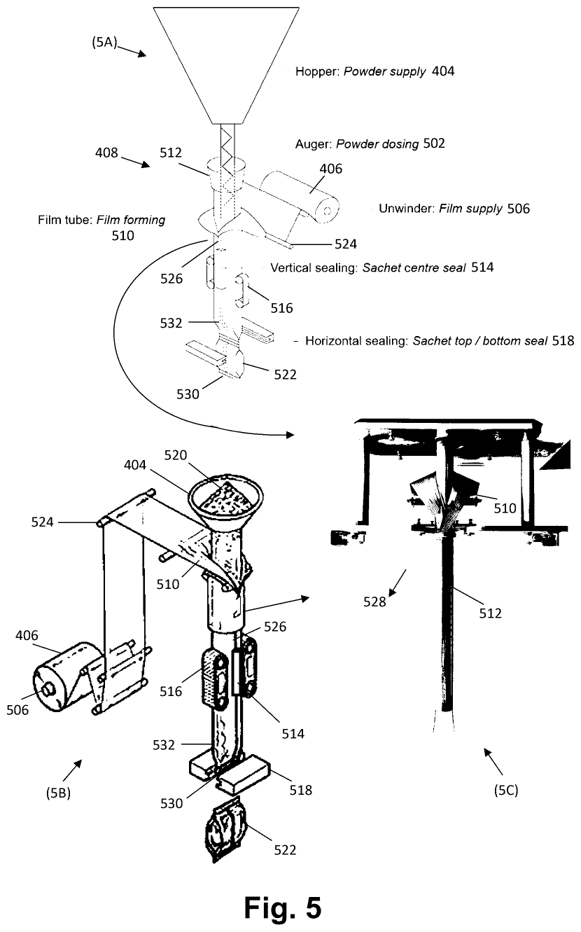

The forming, filling and sealing components 408 of FIG. 4 are shown in FIG. 5. FIG. 5 shows 3 drawings, 5A, 5B and 5C. Drawing 5A shows a first example illustrating the forming, filling and sealing components 408, drawing 5B shows a second example illustrating the forming, filling and sealing components 408, and drawing 5C shows a bag forming tool 528 comprising a bag forming shoulder 510 and a forming tube 512.

Specifically, the drawing 5A shows the filling hopper 404, which is the mixed powder supply. The forming tube 512 is connected to the filling hopper 404. An auger screw 502 is provided for powder dosing, in particular, for transporting the mixed powder fed into the filling hopper 304 into each bag formed. The auger screw 502 extends from a space holding mixed powder in the filling hopper 404 through a hollow core of the forming tube 512. One end of the forming tube 512 is connected to the filling hopper 404 and the opposite end of the forming tube 512 is an opening for dispensing mixed powder transported by the auger screw 502.

Film material 406 in FIG. 4 is in a roll and it is supplied by an unwinder device 506, which works with a plurality of cylindrical rods or guide rollers 524 to unwind the film material 406 from the roll and transfer the film material 406 to the bag forming shoulder 510. The width of the film roll may define the width of the formed bag.

At a first step, the film material 406 is folded over the bag forming shoulder 510, which shapes the flat film material 406 into a round tube. The round tube is formed over the forming tube 512, which maintains the tubular shape. A film removal (or take-off) unit is provided below the bag forming shoulder 510 to pull the film material 406 and remove it from the film forming area. The film removal unit comprises a pair of moving devices 516 with endless tracks (or belt straps) placed against the sides of the film material 406. Each moving device 516 is driven by a motor to move the endless track 516 to pull the film material 406 downwards by friction. The endless tracks are moved synchronously so that the pulling effect on the film material 406 is even.

At a second step, after the tube is formed over the forming tube 512, the ends 526 of the film material 406 are placed adjacent to each other and vertical sealing is performed using a vertical sealer 514 at these ends 526 to form the center seal of a bag (or sachet). The vertical sealer 514 comprises a heater to soften the film material 406 to enable the ends 526 of the film material 406 to adhere together to form the center seal (e.g. 412 in FIG. 4). It is understood that the film material 406 in this example comprises one or more layers of material suitable for such sealing process. Powder to be dispensed into a bag to be formed is not expected to escape through the center seal.

At a third step, horizontal sealing is performed using a horizontal sealer 518 to seal off a bottom end 530 of a bag to be formed (or pre-formed bag) 532. The horizontal sealer 518 comprises a pair of sealing jaws for pressing on two layers of film material 406 that are used to form the round tube. The horizontal sealer 514 comprises heater elements at one or two of the sealing jaws to melt or soften the film material 406 when the jaws are pressed against the two layers of film material 406. The melting or softening of the two layers of film material 406 makes them adhere together to form the bottom seal (e.g. 416 in FIG. 4) at the bottom end 530 of the preformed bag. Powder to be dispensed into the bag is not expected to escape the bottom end 530 after such sealing. Sealing the bottom end 530 of the preformed bag 532 also seals the top end of an earlier bag 522 that was filled.

After the bottom end 530 is sealed off, at a fourth step, the mixed powder in the filling hopper 404 is dosed or dispensed by the auger screw 502 to the predetermined amount into the preformed bag 532. The accurate dosing is defined by the number of revolutions and speed of movement of the auger screw 502.

When the predetermined amount of mixed powder is filled into the preformed bag 532, at a fifth step, the film material 406 is moved downwards for horizontal sealing to be performed by the horizontal sealer 518 to seal the top end of the preformed bag 532. Sealing the top end of the preformed bag 532 will also seal the bottom end of the next bag to be filled.

At a sixth step, the filled bag, such as bag 522, with its top end sealed by the horizontal sealing is cut away from the film material.

The second example illustrated by drawing 5B works in the same way and has the same elements sharing the same reference numerals as the first example of drawing 5A. The only difference lies in the way the powder is dosed or dispensed into the preformed bag 532. Instead of an auger screw 502, the mixed powder is dispensed by letting the powder drop into the preformed bag 532 by gravity from the filling hopper 404. Drawing 5B also shows the same elements present in drawing 5A more clearly.

During the 6 steps described above, the film material length may be measured or determined using computer vision to detect printed markings on the film material 406. For example, the length of a final formed bag may be defined by print marks printed onto the film material 406. the film material length may be measured or determined using encoders, which provide motion feedback for linear measurement by generating pulses in response to linear displacement of the film material to be measured. Such encoders then send those pulses to a controller, which converts those pulses into distance. A measuring wheel may be used with such encoder.

Examples of the machine parameters of the apparatus 400 are provided in table 4 as follows.

TABLE 4

| Description: | Data: |
|---|---|
| Possible bag width: | Up to 260 mm |
| Sealing method: | Heat sealing |
| Sealing width (horizontal | 20 mm |
| seal): | |
| Range of bag length: | Up to 550 mm |
| Film length detection: | Print marks/Encoder |

The apparatus 400 comprises a control station (not shown), which comprises one or more processors or controllers for controlling the forming, filling, and sealing process. The control station may have a display for showing a graphical user interface for user control and setting. The display may be a touch screen display. The control station may comprise light indicators for indicating whether the apparatus 400 is in operation, in various stages of operation, or not working. A plurality of user interfaces such as buttons, knobs, switches etc. may be provided at the control station for controlling the apparatus 400.

After a bag containing the mixed powder is formed, an optional but recommended filling quality check (corresponding to step 220 in FIG. 2) may be conducted. This check ensures the accuracy of the bag filling process, the dosed powder weight should be measured right after the bag filling process is completed.

The inputs for the filling quality check are the filled and sealed bags from the bag forming, filling and sealing process. The weight of each filled bag is measured. Not good (NG) bags, which are filled bags that do not satisfy a predetermined weight requirement, are rejected. NG bags may be rejected by transferring them into a reject bin. Good bags that satisfy the predetermined weight requirement are transferred downstream for further processing.

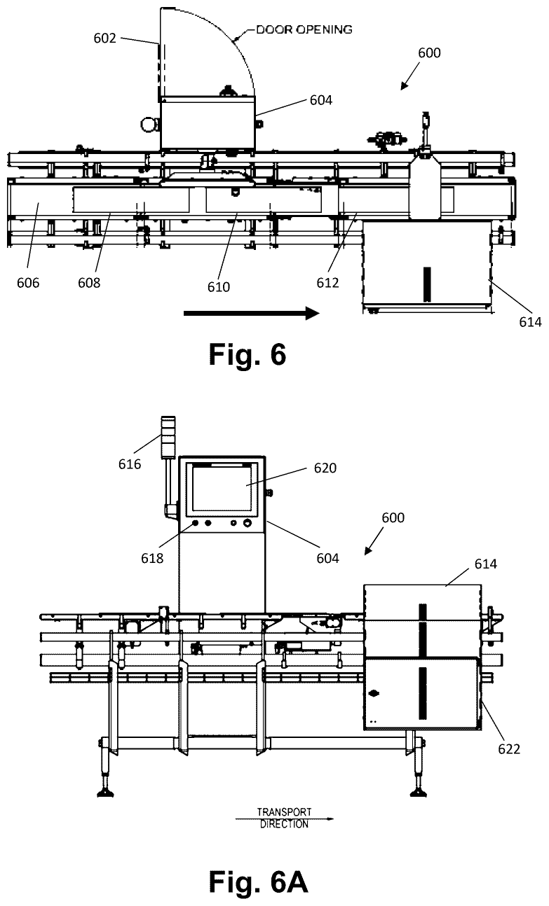

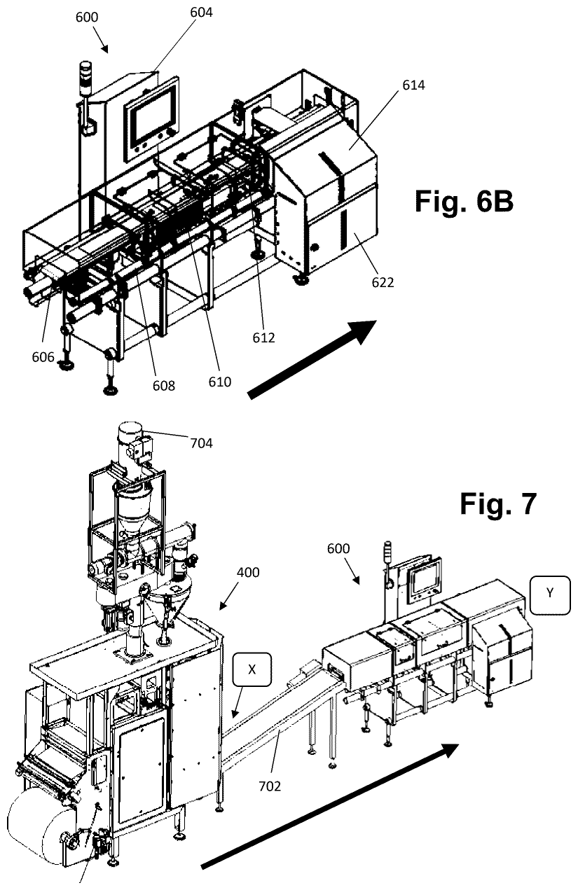

An example of an apparatus 600 for performing the filling quality check is shown in FIGS. 6, 6A and 6B. FIG. 6 shows a top view of the apparatus 600, FIG. 6A shows a front view of the apparatus 600, and FIG. 6B shows a perspective view of the apparatus 600. With reference to FIGS. 6, 6A and 6B, the apparatus 600 can be a checkweigher machine comprising a conveyor system for moving filled bags to different sections of the apparatus 600 for performing different tasks. The arrows in FIGS. 6, 6A and 6B show the transport direction of the bags.

The apparatus 600 comprises a control station 604, which comprises one or more processors or controllers for controlling the filling quality check process. The control station 604 may have a display 620 for showing a graphical user interface for user control and setting. The display 620 may be a touch screen display. The control station 604 may comprise light indicators 616 for indicating whether the apparatus 600 is in operation or not working. A plurality of user interfaces such as buttons, knobs, switches etc. may be provided at the control station 604 for controlling the apparatus 600. The apparatus 600 comprises one or more motor or engine for driving its moving parts and a power supply.

The apparatus 600 comprises a feeding conveyor section 606, which receives filled bags from an upstream process such as from the apparatus 400 in FIG. 4 (i.e. the bag forming, filling and sealing machine). Moving downstream, the apparatus 600 comprises one or more weighing conveyor sections, such as 608 and 610, which comprises load cells for weighing filled bags placed on them. Each weighing conveyor section may be configured to weigh a specific range of bag sizes. For instance, the weighing conveyor section 608 may weigh smaller and lighter bags and the weighing conveyor section 610 may weigh larger and heavier bags. Bags of different sizes may be made in different batches. In a batch of larger size bags, the weighing conveyor section 608 may be deactivated and the weighing conveyor section 610 would be activated to weight the larger size bags. The same can happen for smaller size bags but the weighing conveyor section 608 will be activated and the weighing conveyor section 610 would be deactivated.

The apparatus 600 also comprises an output conveyor section 614, which is a reject station for rejecting Not good (NG) bags that failed a predetermined weight requirement by transferring them into a reject bin 622 or for transferring good bags that passed the predetermined weight requirement downstream for further processing. The transferring of an NG bag into the reject bin 622 can be done by air purging in which air is used to blow the NG bags into the reject bin 622, by using a mechanical pushing flap or other pushing mechanism to push the NG bag into the reject bin 622, or by other suitable means. The reject bin 622 may be locked to prevent mishandling of rejected bags.

The apparatus 600 may be equipped with feedback control to work with the apparatus 400 in FIG. 4. The weight requirement may be an acceptable weight range for a particular bag size. If the weight of the bags seemed to be getting close or has exceeded the tolerance or limits of the acceptable weight range, a feedback data signal to adjust the dosage of the powder can be communicated electronically to the apparatus 400 of FIG. 4. The apparatus 400 will then automatically increase or decrease the dosing amount of the powder to be filled into each bag.

An optional step of sealing quality check may be included right after the filling quality check (corresponding to step 220 in FIG. 2) or just before such filling quality check. The inputs for the sealing quality check are filled and sealed bags from the apparatus 400 in FIG. 4. The sealing quality check may be conducted using computer vision techniques to check that each bag is properly sealed and check whether powder is present around or inside sealing areas to be checked. FIG. 4A shows the sealing areas corresponding to the center seal 412, top seal 414 and bottom seal 416, that may be checked. For instance, a computer vision system with a backlight may be used. Not good (NG) bags that are not properly sealed and/or has powder present around or inside the sealing area will be rejected and transferred to a reject bin. Good bags that meet the requirements will be transferred to the next process.

After the filling quality check or the sealing quality check, a first cleaning process (corresponding to step 222 in FIG. 2) may be conducted to ensure that the surfaces of the filled bags are clean. The main purpose is to clean the surfaces of each bag, especially the horizontal sealing areas (i.e. the top seal 414 and the bottom seal 416 in FIG. 4A.)

The inputs for the first cleaning process are the good bags from the filling quality check or the sealing quality check. The good bags are first cleaned. The cleaning process may be divided in several steps such as cleaning with a rotating air nozzle blowing air at surfaces of each bag, followed by cleaning with brushes brushing over the surfaces of each bag. The surfaces may include the horizontal sealing areas and the vertical sealing area (i.e. center seal 412 in FIG. 4A).

A cleaning apparatus comprising said air nozzle and/or brushes may be used for the first cleaning process. This apparatus can comprise a control station, which comprises one or more processors or controllers for controlling the process. The control station may have a display for showing a graphical user interface for user control and setting. The display may be a touch screen display. The control station may comprise light indicators for indicating whether the apparatus is in operation, in various stages of operation, or not working. A plurality of user interfaces such as buttons, knobs, switches etc. may be provided at the control station for controlling the apparatus. The apparatus comprises one or more motor or engine to drive its moving parts and a power supply.

After cleaning, each bag may be checked for cleanliness. The cleaning result can be verified using UV light, X-Ray or a highly sensitive camera system. Not good bags that not properly cleaned may be rejected and transferred into a reject bin. Good bags that are clean will be transferred to the next process.

An example of a combined or integrated system comprising the components of the bag forming, filling and sealing process i.e. the apparatus 400 in FIG. 4 and the filling quality check station i.e. the apparatus 600 is shown in FIG. 7. Positions X and Y marked in FIG. 7 are possible locations to install one station for the sealing quality check discussed earlier. A conveyor 702 is provided between the apparatus 400 and the apparatus 600 to transfer filled bags from the apparatus 400 to the apparatus 600 for the filling quality check. A vacuum feeder not shown in FIG. 4 for feeding mixed powder from the mixing process described with reference to FIG. 3C is shown in FIG. 7 as installed to the apparatus 400. The direction of transportation of the bags is shown by an arrow in FIG. 7. Instead of having separate control stations for the apparatus 600 and the apparatus 400, there may be a common control station for controlling both apparatuses.

After the bags are cleaned, an optional but recommended pre-flapping (or corner folding) process (corresponding to step 224 in FIG. 2) commences. The main purpose of this pre-flapping process is to prevent powder leaks through the sealed corners of each bag. The bag would be subjected to compression and heat treatment at a later stage, which may cause the sealed sides or ends of the bag to give way and cause powder leak or worse, cause the bag to burst. The inputs to this pre-flapping process are the cleaned bags that have passed the cleanliness check from the first cleaning process.

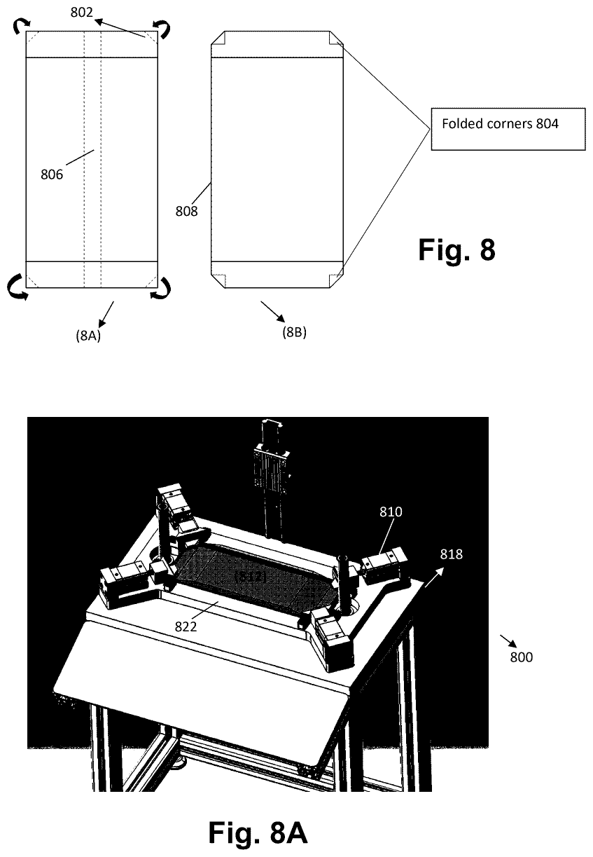

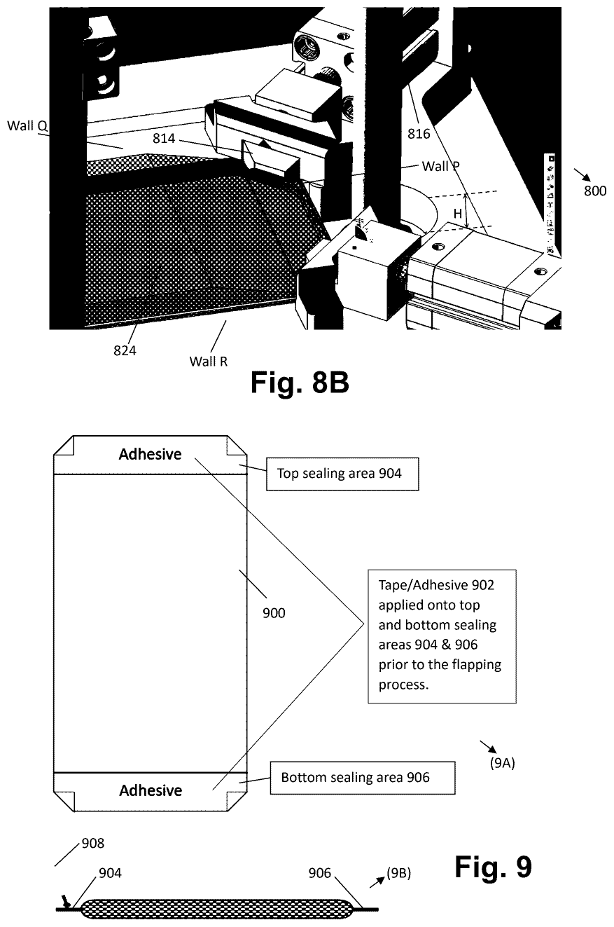

FIG. 8 shows a rear view 8A of a bag 808, which has a center seal 806 and the corners of the bag 808 are about to be folded. FIG. 8 also shows a front view 8B of the bag 808 with folded corners 804 that are locked in position. The pre-flapping process involves aligning each bag 808 into position for folding its corners, defining a folding line 802 at each corner for folding the corner, flap or fold the corners of the bag 808 in the manner as illustrated by the arrows in FIG. 8, and locking the corners in a fold configuration by exerting pressure to form the folded corners 804. The outputs of the pre-flapping process would be the pre-flapped (or corner folded) bags, which look like the bag 808 in the front view 8B.

An example of an apparatus 800 for performing the pre-flapping process is shown in FIG. 8A. The apparatus 800 comprises one or more motor or engine for driving its moving parts and a power supply. In the present example, a bag to be subjected to corner folding is rectangular in shape. FIG. 8B shows an enlarged view of some of the four corner folding devices 810 used for folding the four corners of the bag. With reference to both FIGS. 8A and 8B, the apparatus 800 comprises a raised platform 822 installed on top of a table 818. The four corner folding devices 810 are installed at four corners of the raised platform 822. The raised platform has a recessed portion 824 with a depth H and having walls such as walls P, Q and R marked out in FIG. 8B. Wall P is located at a position corresponding to a corner position of a bag and it is configured to be angular relative to walls Q and R to facilitate corner folding of the bag. Walls similar to Wall P are provided at other corners of the recessed portion 824 for facilitating corner folding of the bag.

The apparatus 800 comprises a folding fixture 812 for resting a pre-corner folding bag. The folding fixture 812 is configured to be raised and lowered in the recessed portion 824. The pre-corner folding bag has to be aligned and positioned on the folding fixture 812 for its corners to be folded. The folding fixture 812 can be sized to closely match the size of the bag or have a bag holding area sized to closely match the bag so that when the bag is detected to be seated in the folding fixture, the bag is aligned. This can be done with the help of a computer vision system. The pre-corner folding bag can be held in position by vacuum suction. The vacuum suction may be applied to hold in position the folding fixture 812 with the aligned bag. The folding fixture 812 may also have an opening for the vacuum suction to suck and hold or secure the bag in position on the folding fixture 812. The table 818 may be installed with a vacuum suction system, which comprises one or more holes for the vacuum suction to act on the folding fixture 812 and/or the aligned bag. In another example, the bag may be picked up by a pick and place device (or robotic arm) using vacuum suction, aligned and placed at the right position in the folding fixture 812.

Each corner folding device 810 comprises a sliding cylinder 816 connected to a folding jig 814. A linear motor or actuator is used to drive the motion of the sliding cylinder 816. The folding jig 814 is shaped for folding the corner of the bag, for instance, it may have sloped edges for facilitating folding. As mentioned earlier, the folding fixture 812 is configured to be raised and lowered in the recessed portion 824. When the bag is secured in position on the folding fixture 812 and the folding fixture 812 is not yet lowered into recessed portion 824, a vertical downwards movement of the folding fixture 812 to lower it into the recessed portion 824 would cause the corners of the bag to contact the angular walls in the recessed portion 824, such as wall P, which is configured to flap or fold a corner of the bag. With the help of the walls such as wall P, the vertical downwards movement of the folding fixture 812 into the recess will pre-fold the corners of the bag to an approximately 90 degrees angle. When the bag is in the pre-folded position, the sliding cylinders of the four corner folding devices 810 will move forward, along with the respective folding jigs 814, to further fold the corners at approximately 90 degrees to an angle of approximately 180 degrees. Each corner folding device 810 also comprises a heating element installed at the folding jig 814 for applying heat to the folded corners. The heating element softens the folded film material to ensure that the folded corners stay in folded configuration. After the corner folding process is finished, the sliding cylinders 816 will move back to a home position and the pre-flapped bag with folded corners can be removed from the folding fixture 812 to be transferred to the next process.

The apparatus 800 can comprise a control station (not shown), which comprises one or more processors or controllers for controlling the process. The control station may have a display for showing a graphical user interface for user control and setting. The display may be a touch screen display. The control station may comprise light indicators for indicating whether the apparatus 800 is in operation, in various stages of operation, or not working. A plurality of user interfaces such as buttons, knobs, switches etc. may be provided at the control station for controlling the apparatus 800.

After the pre-flapping process, a tape and/or adhesive application process (corresponding to step 226 in FIG. 2) commences. Such tape/adhesive application process can be performed before the pre-flapping process or after the pre-flapping process. The main purpose of this tape/adhesive application process is to allow the flaps of the ends of a pre-flapped bag having the top seal and the bottom seal to be adhered and secured in position at a further folding or flapping process to be performed later.

FIG. 9 shows a front view 9A and a side view 9B of a pre-flapped (corner folded) bag 900. The inputs to the tape/adhesive application process are tape/adhesive 902 and the pre-flapped (corner folded) bags such as the bag 900 shown in FIG. 9 or the cleaned bags if the pre-flapping process is skipped. The tape/adhesive application process involves aligning and positioning the bag 900 for the tape/adhesive application, cutting and applying a tape or an adhesive 902 onto sealing areas at the flaps (or sealed sides) of the bag, in particular, a top sealing area 904 or a bottom sealing area 906 of the bag, which are also known as the horizontal sealing areas of the bag. The outputs of the tape/adhesive application process are bags with a tape or adhesive applied onto the bag flaps or the top and bottom bag sealing areas. For example, double-sided tape (or transfer tape or double adhesive coated tape) can be applied onto the bag flaps. In another example, adhesive (hot glue) may be applied onto the flaps. For the application of the double-sided tape or transfer tape, a tape applicator 908 is used to ensure the required tape length and repeatability of the application. If an adhesive such as hot glue is used, a dispensing equipment 908 is used to dispense a specific amount of adhesive onto the flaps.

After the tape/adhesive application on the horizontal sealing areas of a bag, a flapping process (corresponding to step 228 in FIG. 2) is performed to flap or fold the horizontal sealing areas so that the portions applied with tape/adhesive adhere to a main body (or core area) of the bag. Folding or flapping the sealing areas onto or under the main body of the bag, effective insulation coverage is maximised. Furthermore, when high temperature and/or pressure is applied on the bag in later processes, the flapped or folded seals will push onto the main body of the bag more securely and hence, the sealed sides or edges of the bag are less susceptible to the risk of opening and spilling the filled contents. The inputs to this flapping process are the corner folded bags with adhesive/tape applied on the horizontal sealing areas or the cleaned bags with adhesive/tape applied on the horizontal sealing areas if the pre-flapping (corner folding) process is skipped. The flapping process involves defining a folding line, folding a flap of a bag to an approximately 180-degrees angle towards a front or rear side of the bag, securing the folded flap by adhering it to the main body of the bag. The outputs of the flapping process are bags with flapped (or folded) sides.

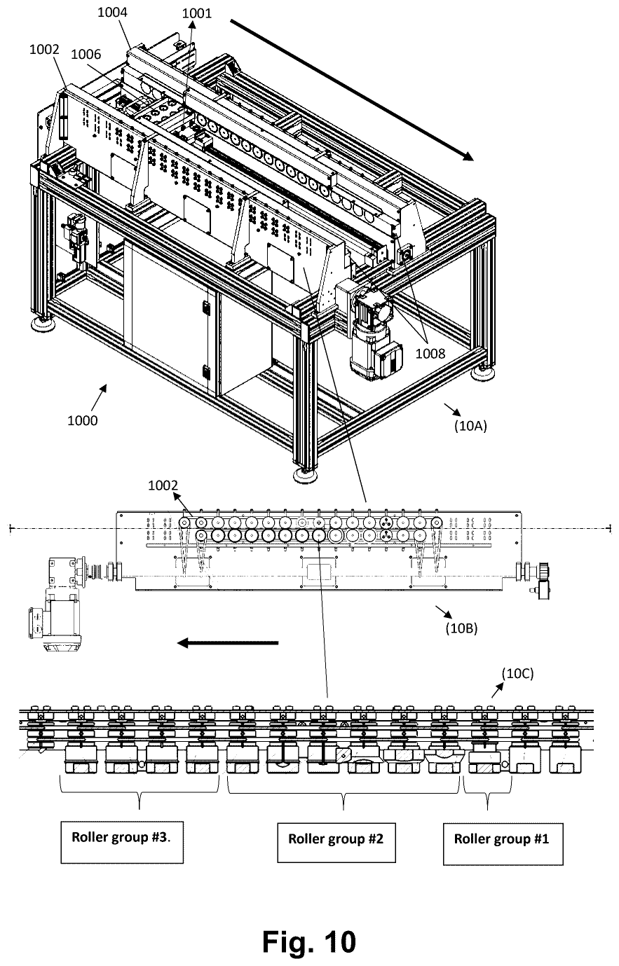

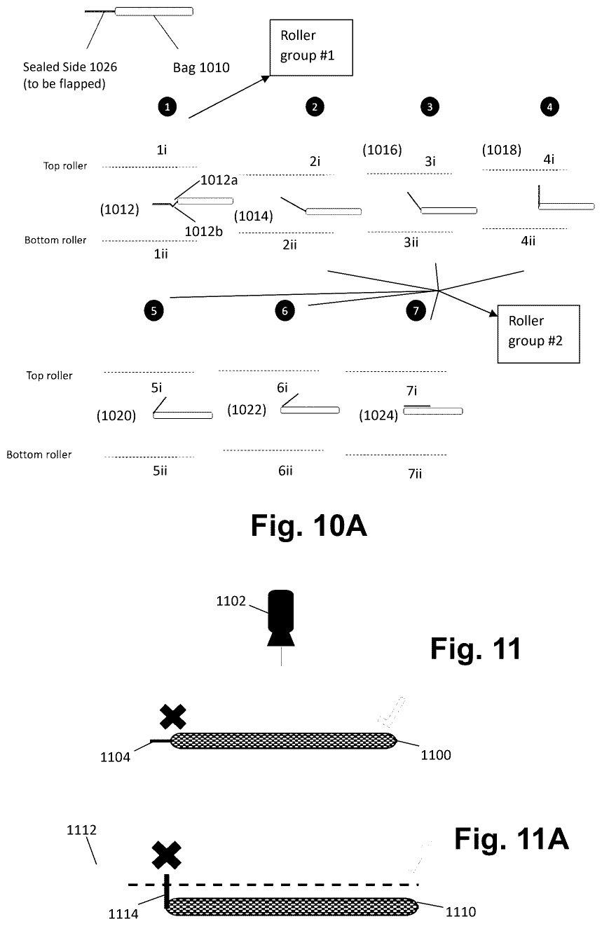

FIG. 10 shows an example of a perspective view 10A of an apparatus 1000 for performing the flapping process. The apparatus 1000 comprises two rows of rollers 1002 and 1004 arranged in a manner for flapping or folding the top sealed side and bottom sealed side respectively of each bag inputted to the apparatus 1000. Moving a bag through the two rows of rollers 1002 and 1004 will fold and adhere the opposite sealed sides (i.e. the top sealed side and the bottom sealed side) of the bag concurrently. FIG. 10 also shows a side view 10B of the row of rollers 1002 and a top view of the row of rollers 1002. Each row of rollers 1002 and 1004 comprises a plurality of groups of roller sets. In the present example, there are 3 roller groups #1, #2 and #3 in the row 1002 and they are marked out in the top view 10C. The roller group #1 is used to define a folding line of the top sealed side (or top flap) of a bag to be flapped or folded. The roller group #2 is used to fold the top sealed side of the bag from 0 to 180 degrees. The roller group #3 is used to adhere, secure or lock a portion of the top sealed side that has been applied with tape/adhesive to the main body of the bag. The row of rollers 1004 is used to fold and adhere the bottom sealed side (or bottom flap) and is configured in a similar manner as the row of rollers 1002. It should be noted that the terms top and bottom of a bag is interchangeable because the bag is symmetrical along an axis cutting the centre of the bag and parallel to the horizontal sealed sides of the bag.

The apparatus 1000 can comprise a control station (not shown), which comprises one or more processors or controllers for controlling the process. The control station may have a display for showing a graphical user interface for user control and setting. The display may be a touch screen display. The control station may comprise light indicators for indicating whether the apparatus 1000 is in operation, in various stages of operation, or not working. A plurality of user interfaces such as buttons, knobs, switches etc. may be provided at the control station for controlling the apparatus 1000. The apparatus 1000 comprises one or more motor or engine to drive its moving parts and a power supply.

The apparatus 1000 comprises a transporter 1001 comprising one or more movable fixtures 1006 located between the two rows of rollers 1002 and 1004 for moving bags pass the rows of rollers 1002. FIG. 10 shows one such fixture 1006. The one or more fixtures 1006 are mounted to a pair of rails 1008 and are slidable along the pair of rails 1008. In the case of more than one fixtures 1006, they may be placed adjacent to one another. A suitable motor or actuator is used to move the one or more fixtures 1006. Each fixture 1006 is used to hold a bag with sealed sides to be flapped or folded in position. The bag may be clamped mechanically using clamps to secure the bag to each fixture or the bag may be secured to each fixture though the use of vacuum suction. Top-down parallel pressure may be exerted on the bag by the clamps or through the use of vacuum suction. The bag has to be secured in the fixture 1006 and the sealed sides of the bag have to be aligned to interact with the roller groups 1, 2 and 3 of the two rows of rollers 1002 and 1004. Thereafter, moving the fixture 1006 carrying the bag through the roller groups #1, #2, and #3 of the two rows of rollers 1002 and 1004 would cause the sealed sides of the bag to be folded and adhered to the main body of the bag. It is preferable to move the bag through the roller groups #1, #2 and #3 of the two rows 1002 and 1004 at a constant speed.

A vacuum conveyor more suitable for continuous processing involving moving a plurality of bags through all the roller groups 1, 2, and 3 for flap folding may be used. A vacuum conveyor refers to a suctioning machine that utilises air or reduced pressure to hold the bags in position. In the case that a vacuum conveyor is used, each bag may be positioned on a vacuum jig. The vacuum jig may make use of vacuum suction to hold the bag. There may be a plurality of such vacuum jig positioned adjacent to one another. In another example, the vacuum conveyor may comprise a moveable endless belt that is perforated. Bags with sealed sides to be folded are placed onto the belt sequentially as the belt is driven by drivers such as a motor, an engine or the like. The perforations of the belt are in fluid connection with a vacuum suction unit. When the vacuum suction unit is activated, bags placed onto the moving endless belt will be attached to the endless belt by the suction force provided through the perforations. The flapping process is finished when the bag reaches the end of the rows of rollers 1002 and 1004.

The rollers in each roller group #1, #2 and #3 are configured differently. FIG. 10A shows simplified cross-sectional side views of one roller set 1012 (marked “1”) in roller group #1 and 6 rollers 1014, 1016, 1018, 1020, 1022, and 1024 (marked “2” to “7”) in roller group #2. Each roller set in roller group #3 is configured in the same manner as roller set 1024 in roller group #2. FIG. 10A also shows a bag 1010 with a non-flapped or non-folded sealed side 1026, which is to be folded. Each roller set comprises a top roller for working on a top facing surface of the bag 1010 or a top facing surface of the sealed side 1026 to be folded, and a bottom roller for supporting a bottom facing surface of the bag 1010 or a bottom facing surface of the sealed side 1026. The various stages of folding the sealed side 1026 of the bag 1010 are shown in FIG. 10A. The rollers of each row 1002 and 1004 are driven by for instance, a belt or a chain. The rollers of each row 1002 and 1004 may be configured to move and the speed of movement of the rollers is adjustable. The rollers of the two rows 1002 and 1004 should be moved synchronously to ensure even folding of the sealed side 1026.

Specifically, in the present example, roller set 1012 has a top roller 1i with a ring of pointed protrusion 1012a and a bottom roller 1ii with a corresponding ring groove for receiving the pointed protrusion 1012a. The pointed protrusion 1012a and the corresponding ring groove are used to form a folding line on the sealed side 1026 of the bag 1010 when the sealed side 1026 is moved pass the roller set 1012.

Roller set 1014 has a top roller 2i for pressing the body of the bag 1010 against a flat surface of a bottom roller 2ii of the roller set 1014 to support the bag 1010 between the top roller 2i and the bottom roller 2ii. The bottom roller 2ii is configured to have a gentle angle slope (e.g. angled at 45 degrees or less relative to a horizontal axis) for guiding the sealed side 1026 to fold along the folding line at a gentle angle when the sealed side 1026 is moved pass the roller set 1014.

Roller set 1016 has a top roller 3i for pressing the body of the bag 1010 against a flat surface of a bottom roller 3ii of the roller set 1016 to support the bag 1010 between the top roller 3i and the bottom roller 3ii. The bottom roller 3ii is configured to have a steep angle slope (e.g. angled more than 45 degrees but lesser than 90 degrees relative to the horizontal axis) for guiding the sealed side 1026 to fold along the folding line at a steep angle when the sealed side 1026 is moved pass the roller set 1016.

Roller set 1018 has a top roller 4i for pressing the body of the bag 1010 against a flat surface of a bottom roller 4ii of the roller set 1018 to support the bag 1010 between the top roller 4i and the bottom roller 4ii. The bottom roller 4ii is configured to have a right-angled slope (i.e. 90 degrees relative to the horizontal axis) for guiding the sealed side 1026 to fold to 90 degrees (relative to the horizontal axis) when the sealed side 1026 is moved pass the roller set 1014.

Roller set 1020 has a top roller 5i configured to have a gentle angle slope for guiding the sealed side 1026, which has been folded pass 90 degrees (relative to the horizontal axis), to fold towards the main body of the bag 1010. The roller set 1020 has a bottom roller 5ii with a flat surface for supporting the bag 1010 i.e. to let the bag rest on it. The bottom roller 5ii is not tapered or sloped in the cross-sectional view shown in FIG. 10A.

Roller set 1022 has a top roller 6i configured to have a steep angle slope for guiding the sealed side 1026, which has been folded by roller set 1020, to further fold towards the main body of the bag 1010. The roller set 1020 has a bottom roller 6ii with a flat surface for supporting the bag 1010 i.e. to let the bag 1010 rest on it. The bottom roller 6ii is not tapered or sloped in the cross-sectional view shown in FIG. 10A.

Roller set 1024 has a top roller 7i and a bottom roller 7ii that are both not tapered or sloped in the cross-sectional view shown in FIG. 10A. They are used to fold and hold the sealed side 1026 at 180 degrees relative to the horizontal axis. At this angle, the portion of the sealed side 1026 applied with tape/adhesive earlier is adhered to the main body of the bag 1010. The top roller 7i and the bottom roller 7ii work together to hold and press the sealed side 1026 against the main body of the bag 1010.

Each roller set in roller group #3 is configured in the same manner as roller set 1024 in roller group #2 because the folding is completed at the roller set 1024. The roller sets in roller group #3 are provided to reinforcement the adhesion of the sealed side 1026 to the main body of the bag 1010 through continuous pressure exertion on the sealed side 1026.

The distance between the two rows of rollers 1002 and 1004 may be adjusted to accommodate different bag lengths. The distance between the rollers in each row may also be adjusted to accommodate different bag widths. The fixture 1006 or vacuum jig for holding the bag may be configured accordingly to accommodate different bag dimensions. For instance, the supported bag length by the apparatus 1000 may be 100-550 mm and the supported bag width by the apparatus 1000 may be 70-120 mm.

Table 5 below summarises the description of the respective top and bottom rollers of roller sets 1012, 1014, 1016, 1018, 1020, 1022, and 1024, and their purposes.

TABLE 5

| Roller set | Description | Purpose |
|---|---|---|
| 1012 | Top roller (1i): Defined edge | Imprint a defined folding edge or line into |
| | Bottom roller (1ii): Comes with a | the bag flap. |
| | clearance. | |
| 1014 | Top roller (2i): Flat roller to secure | Fold the sealing area (flap) upwards |
| | the pouch. | |
| | Bottom roller (2ii): Specific incline. | |
| 1016 | Top roller (3i): Flat roller to secure | Fold the sealing area (flap) upwards |
| | the pouch. | |
| | Bottom roller (3ii): Increased | |
| | incline compared to roller set | |
| | 1014. | |
| 1018 | Top roller (4i): Flat roller to secure | Fold the sealing area (flap) to 90 degrees. |
| | the pouch. | |
| | Bottom roller (4ii): With a 90 | |
| | degrees angle | |
| 1020 | Top roller (5i): Inclined surface. | Fold the sealing area (flap) downwards. |
| | Bottom roller (5ii): Flat surface | Angle between 90 degrees and 180 |
| | | degrees. |
| 1022 | Top roller (6i): Inclined surface. | Fold the sealing area (flap) downwards. |
| | Bottom roller (6ii): Flat surface | Angle between 90 degrees and 180 |
| | | degrees. |
| 1024 and | Top roller (7i): Flat surface | Flapping is finished at 180 degrees. |
| roller sets | Bottom roller (7ii): Flat surface | Press onto the flapped side or edge to |
| in roller | | secure the flap with the tape/adhesive. |
| group #3 | | |

Examples of a fully flapped or folded bag are illustrated in FIG. 25, FIG. 25A, FIG. 25B, and FIG. 25C. These figures will now be described. Note that these figures are not drawn to scale and the thicknesses of the flaps in the side views shown are exaggerated for better illustration.

FIG. 25 shows a rear view 25A, a front view 25B and a side view 25C of a folded bag 2500. The folded bag 2500 has a first folded horizontal seal 2502 (or folded top seal), a second folded horizontal seal 2506 (or folded bottom seal) and a folded vertical seal 2504 (or folded center seal) that is orthogonal to the first folded horizontal seal 2502 and the second folded horizontal seal 2506. The folded vertical seal 2504 is folded when it is vertically sealed at the bag forming stage in step 218 of FIG. 2, for example, by using the vertical sealer 514 in FIG. 5. The present flapping process is used to fold the first folded horizontal seal 2502 and the second folded horizontal seal 2506. In the example of FIG. 25, all the folded seals 2502, 2504 and 2506 are visible in the rear view 25A. The folded vertical seal 2504 is located at an edge of the folded bag 2500 (with respect to FIG. 25, at the left side edge of the folded bag 2500).

FIG. 25A shows a rear view 25D, a front view 25E and a side view 25F of a folded bag 2510. The folded bag 2510 has a first folded horizontal seal 2512 (or folded top seal), a second folded horizontal seal 2516 (or folded bottom seal) and a folded vertical seal 2514 (or folded center seal) that is orthogonal to the first folded horizontal seal 2512 and the second folded horizontal seal 2516. The folded vertical seal 2514 is folded when it is vertically sealed at the bag forming stage in step 218 of FIG. 2, for example, by using the vertical sealer 514 in FIG. 5.

The present flapping process is used to fold the first folded horizontal seal 2512 and the second folded horizontal seal 2516. In the example of FIG. 25A, all the folded seals 2512, 2514 and 2516 are visible in the rear view 25D. The folded vertical seal 2514 is located at a central area of the folded bag 2500.

FIG. 25B shows a rear view 25G, a front view 25H and a side view 25I of a folded bag 2520. The folded bag 2520 has a first folded horizontal seal 2522 (or folded top seal), a second folded horizontal seal 2526 (or folded bottom seal) and a folded vertical seal 2524 (or folded center seal) that is orthogonal to the first folded horizontal seal 2522 and the second folded horizontal seal 2526. The folded vertical seal 2524 is folded when it is vertically sealed at the bag forming stage in step 218 of FIG. 2, for example, by using the vertical sealer 514 in FIG. 5. The present flapping process is used to fold the first folded horizontal seal 2522 and the second folded horizontal seal 2526. In the example of FIG. 25B, the folded seal 2524 is visible in the rear view 25G and the folded seals 2522 and 2526 are visible in the front view 25H. The folded vertical seal 2514 is located at a central area of the folded bag 2500.

FIG. 25C shows a rear view 25J, a front view 25K and a side view 25L of a folded bag 2530. The folded bag 2530 has a first folded horizontal seal 2532 (or folded top seal), a second folded horizontal seal 2536 (or folded bottom seal) and a folded vertical seal 2534 (or folded center seal) that is orthogonal to the first folded horizontal seal 2532 and the second folded horizontal seal 2536. The folded vertical seal 2534 is folded when it is vertically sealed at the bag forming stage in step 218 of FIG. 2, for example, by using the vertical sealer 514 in FIG. 5. The present flapping process is used to fold the first folded horizontal seal 2532 and the second folded horizontal seal 2536. In the example of FIG. 25, all the folded seals 2532, 2534 and 2536 are visible in the rear view 25A. In the example of FIG. 25C, the folded seal 2534 is visible in the rear view 25J and the folded seals 2532 and 2536 are visible in the front view 25K. The folded vertical seal 2534 is located at an edge of the folded bag 2530 (with respect to FIG. 25, at the right side edge of the folded bag 2530). In another example, the folded vertical seal 2534 may be located at an edge 2538 of the folded bag 2530 (with respect to FIG. 25, at the left side edge of the folded bag 2530).

After the flapping process, a flapping quality control check (corresponding to step 230 in FIG. 2) may be performed. The main purpose of this check is to prevent non-flapped or improperly flapped bags from entering the next degassing, heating and cooling process. Improper flapping can lead to bursting of a bag in the downstream process. The inputs for the flapping quality control check are the flapped bags output from the flapping process. The process of the flapping quality control check involves checking that the sealed sides i.e. the top and bottom sealed sides of each flapped bag are flapped or folded.

A computer vision system may be used to check whether both sealed sides of the bag are properly flapped or folded. The computer vision system may conduct this check by checking the dimensions of the bag, for instance, by measuring the length of the bag. In this case, if the bag is too long, it is indication that there is improper folding or no folding. FIG. 11 shows an overhead camera 1102 used to capture images of a bag 1100 to check whether the length of the bag 1100 satisfies a predetermined length requirement. This predetermined length requirement is set based on the length of a bag with both of the sealed sides flapped properly. One of the folded sides of the bag 1100 is marked with a tick, indicating that the folded sealed side is properly adhered to the body of the bag 1100. The other side of the bag 1100 has a sealed side 1104 that appears to be not folded and a cross is marked to indicate that the length of the bag 1100 fails to meet the predetermined length requirement.

In addition, the computer vision system may be configured to check the height of each bag to spot improperly flapped bags. The bag should have a height that includes the thickness of the sealed sides. For example, if the height of the bag is too low, it is indication that the sealed sides are not flapped or improperly flapped. If the height of the bag is too high, it is also indication that the flaps are not fully folded and adhered to the body of the bag, or the adhesion loosen and the flaps unfolded. FIG. 11A shows a height sensor 1112, which can be a laser or infrared sensor, or the like. The height sensor 1112 is used to check whether the height of a bag 1110 satisfies a predetermined height requirement, which is illustrated by the dashed line. The predetermined height requirement is set based on the height of a bag with both of the sealed sides flapped properly. One of the folded sides of the bag 1110 is marked with a tick, indicating that the folded sealed side is properly adhered to the main body of the bag 1110. The other side of the bag 1110 has a sealed side 1114 that is folded at 90 degrees relative to a horizontal axis, which would cause the measured height to cross the predetermined height requirement defined by the dashed line. Hence, a cross can be seen marked in FIG. 11A to indicate that the height of the bag 1110 fails to meet the predetermined height requirement.

The bags that passed the flapping quality check are transferred to the next process. The bags that fail the check will be rejected.

After the flapping quality check, degassing, heating and cooling processes (corresponding to step 232 in FIG. 2) can commence. The degassing, heating and cooling can be performed sequentially for one bag at a time or for one batch of bags comprising a plurality of bags. Alternatively, the degassing and heating processes can be concurrently performed for one bag at a time or for one batch of bags, while the cooling process has to be separate. The inputs for the degassing, heating and cooling processes are the flapped pouches that have passed flapping quality control check. In the case that pre-flapping and flapping are skipped, the inputs would be the bags from the earlier process that is not skipped.

The degassing, heating and cooling processes may involve an optional first step to level powder inside each bag by vibration, a second step to degas the bag by mechanical pressing and/or vacuum support (i.e. vacuum suction is applied to degas the bag), a third step of subjecting the bag to heat treatment, and a fourth step of subjecting the bag to cooling. The outputs of the degassing, heating and cooling processes would be heat treated Thermal insulation devices. An example of the heat treatment temperature range may be between 130 Degrees Celsius to 150 Degrees Celsius. The Thermal insulation device temperature after cooling should drop to less than 50 Degrees Celsius.

The types of apparatus to be used for the above-mentioned processes may be classified into the following categories:
1. Static hot presses or Multi-Layer-Hot presses (MLHP), or
2. Double belt presses (DBP).

DBP is better for automated continuous production process, whereas the MLHP approach is better for a static (batch) production process.

An example of an apparatus based on MLHP would comprise a compression and heating chamber for placing one or more bags, wherein compression and heating of the one or more bags can be performed concurrently. The same or a separate chamber can be used for cooling the one or more bags after compression and heating.

The optional first step to level powder inside each bag, for instance, by vibration can be done outside the chamber by using a vibration device, which may comprise a fixture for securing each bag. The fixture can be activated to vibrate to perform the powder levelling of the bag. After powder levelling is done, the bag is transferred to the compression and heating chamber.

Alternatively, the chamber may be configured to vibrate to perform the powder levelling and, in this case, there is no need to transfer the bag from a vibration station to the chamber. In this case, the vibration process can be done concurrently with the compression of the bag, wherein degassing and powder levelling are done together.

In the compression and heating chamber, there may be a plurality of plates connected to one another. One or more bags may be placed in between every two plates of the plurality of plates. The plurality of plates are adjustable to move closer to one another to compress the bags placed between the plates. Heating elements are provided to heat the plurality of plates. In this manner, compression and heating can be performed concurrently. The heating should be done when the one or more bags are compressed. After heat treatment is performed for a predetermined period of time, the plurality of plates along with the one or more bags compressed therebetween are cooled either naturally, or through active cooling, for instance, by channeling cooling fluid through pipes linked or attached to the plurality of plates. The cooling should also be done when the bag or bags are compressed.

The apparatus based on MLHP can comprise a control station, which comprises one or more processors or controllers for controlling the process. The control station may have a display for showing a graphical user interface for user control and setting. The display may be a touch screen display. The control station may comprise light indicators for indicating whether the apparatus is in operation, in various stages of operation, or not working. A plurality of user interfaces such as buttons, knobs, switches etc. may be provided at the control station for controlling the apparatus. The apparatus comprises one or more motor or engine to drive its moving parts and a power supply.

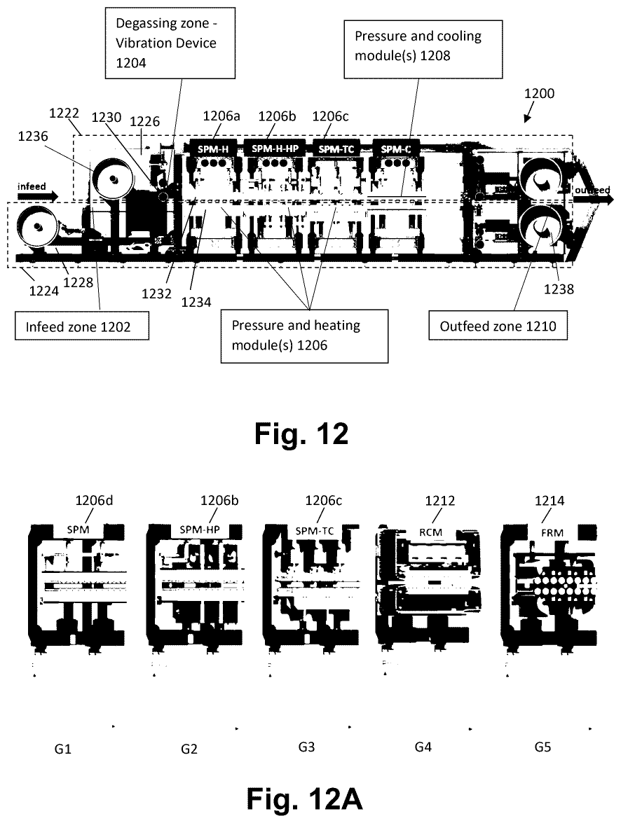

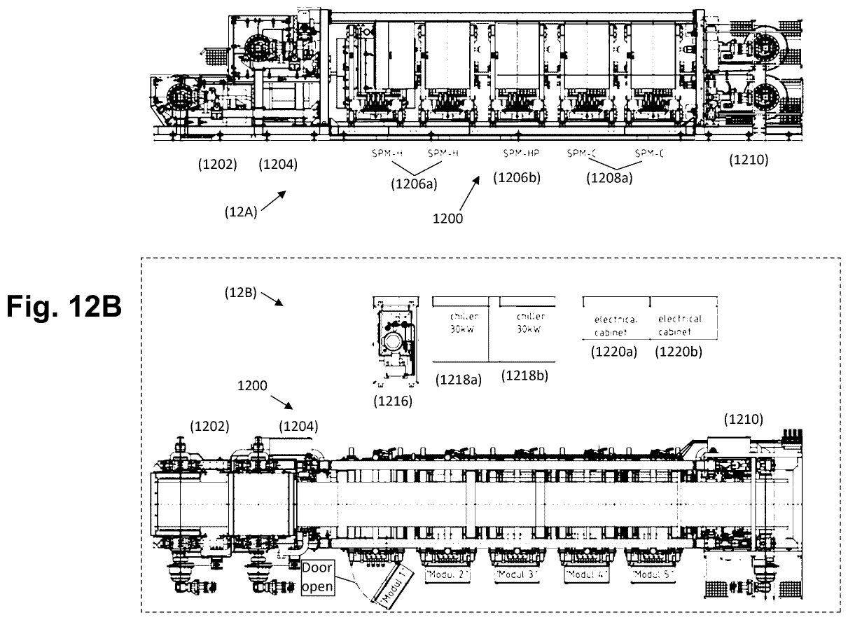

An example of a side view of an apparatus 1200 based on DBP for performing the degassing, heating and cooling processes described above is illustrated by FIG. 12.

The apparatus 1200 comprises several machine components and zones. The zones are stated as follows:
1. Infeed zone 1202 for feeding one or more bags from an upstream process;
2. Degassing zone for starting or beginning the process of degassing the one or more bags, wherein the degassing zone comprises a vibration device 1204 for levelling powder inside the one or more bags;
3. Heating and/or pressure zone 1206 comprising one or more heating and/or pressure modules such as modules 1206a, 1206b and 1206c;
4. Cooling zone 1208 comprising one or more cooling modules; and
5. Outfeed zone 1210 for outputting bags that have been degassed, heat treated and cooled. The outputs can be said to be finished Thermal insulation devices. Checks and inspections, or further processing on the finished Thermal insulation devices may be performed later.

Notably, the apparatus 1200 has a modular setup or design in which the heating, compression, and/or cooling modules can be plugged and removed as required to obtain the best manufacturing results.

FIG. 12A also shows a side view 12A of the apparatus 1200 with a different combination of modules for degassing, heating, and/or cooling compared to FIG. 12. FIG. 12 shows the inside of each module whereas FIG. 12B shows that the doors for covering the inside of each module are shut. FIG. 12B also shows a top view 12B of the apparatus 1200 having modules 1 to 5 (short form: modul 1 to 5) corresponding to the two modules 1206a, one module 1206d, and two modules 1208a shown in the side view 12A. A door of module 1 in FIG. 12B is open.

With reference to FIG. 12 and FIG. 12B, the apparatus 1200 comprises a top conveyor 1222 comprising a top endless belt 1226 (or first endless belt) and a bottom conveyor 1224 comprising a bottom endless belt 1228 (or second endless belt). The belts may be made of interlocking pieces of metal such as steel (known as a steel belt). The top conveyor 1222 and the bottom conveyor 1224 are configured with the required motor or engine and driving gears or wheels such as 1236 and 1238 to drive their respective belts synchronously. The bottom belt 1228 is used to convey one or more bags placed on it at the infeed zone 1202 pass the intermediate zones 1204, 1206 and 1208 and to the outfeed zone 1210. The one or more bags can be placed by a robot (e.g. pick-and-place robot) or an interconnected upstream conveyor system.

The gap between the bottom and top conveyor where the one or more bags are placed can be automatically adjusted. The top belt 1226 will contact a top facing surface of each bag conveyed by the bottom conveyor 1224 after the bag is conveyed for a distance by the bottom belt 1228. The speed of belt movement of the conveyors is adjustable. After the bag is contacted by the top belt 1226 and the bag is between the top belt 1226 and the bottom belt, the distance between the top belt 1226 and the bottom belt 1228 will be reduced gradually. As this distance reduces the top belt 1226 and bottom 1228 compresses the bag and degassing of the bag occurs.

The vibration device 1204 is installed between the infeed zone 1202 and the first heating module 1206a, which corresponds with the degassing zone. In the present example, the vibration device 1204 comprises a vibration member 1230 (which may be a roller or a bar) for contacting the top belt 1226. Vibration produced by the vibration device 1204 is channelled (through the vibration member 1230) to the top belt 1226, which in turn vibrates the one or more bags conveyed between the top belt 1226 and the bottom belt 1228. The combination of vibration and compression help to level the powder homogeneously inside each bag.

One or more layers of fabric or coating (e.g. Teflon based fabric or coating, silicone coated fabric) may be attached to surfaces of the top belt 1226 and the bottom belt 1228 that would be in contact with the one or more bags. These one or more layers of fabric or coating helps to ensure that air can flow from inside the bag through the perforations of the bag. The one or more layers of fabric or coating may be configured with a pattern that will, under pressure, imprint such pattern onto the surface of a bag that will contact the one or more layers of fabric or coating. Such imprinted pattern can help to improve the stiffness of the bag.

As mentioned earlier, the apparatus 1200 has a modular setup for compression, heating and/or cooling. Such heating, pressure, and/or cooling modules can be arranged according to the required process. Each module comprises a top or upper plate 1232 and a bottom or lower plate 1234 that are adjustable to move closer to each other or move away from each other to exert or release pressure on an object placed between the top plate 1232 and the bottom plate 1234. In the apparatus 1200, the top plate 1232 and the bottom plate 1234 will not contact the one or more bags directly. When pressure is to be exerted on a bag between the top belt 1226 and the bottom belt 1228, the top plate 1232 will press on the top belt 1226 and the bottom plate 1234 will press on the bottom belt 1228.

The temperature can be controlled specifically for each module. The compression provided by the modules can exert pressure that is in addition to the pressure exerted through the adjustment of the distance between the top belt 1226 and the bottom belt 1228 on the one or more bags. The pressure exerted by the modules on the top belt 1226 and bottom belt 1228 is adjustable within a specific range. The pressure, heating, and/or cooling conditions can be different for each individual module in the heating and/or pressure zone 1206 and the cooling zone 1208.

Examples of the modules in the modular setup are 1206a, 1206b, 1206c and 1208 in FIGS. 12, 1206d, 1206b, 1206c, 1212 and 1214 in FIG. 12A, and 1206a, 1206d, and 1208a (and corresponding module 1 to 5) in FIG. 12B. The abbreviations used for the modules in FIG. 12, FIG. 12A and FIG. 12B and their corresponding description is provided in table 6 below. Reference is made to the Pressure versus Time graphs, G1 to G5, of the modules 1206d, 1206b, 1206c, 1212 and 1214 shown in FIG. 12A respectively,

TABLE 6

| Abbreviations | Description |
|---|---|
| SPM | Sliding Plate Module for constant Low Pressure Exertion as shown in |
| | graph G1. |
| SPM - H | Sliding Plate Module for Heating. A constant Low Pressure Exertion as |
| | shown in graph G1 may be applied. |
| SPM - H - HP | Sliding Plate Module for Heating and High Pressure Exertion, wherein |
| (short form: | the high pressure exertion can be exerted with high amplitude peaks as |
| SPM - HP in | shown in graph G2. The high pressure is exerted by 3 high pressure |
| FIG. 12A and | zones along the plates of this module. Each high pressure zone |
| 12B) | corresponds to a blade mounted to the plates. Therefore, 3 spaced apart |
| | blades are present to exert the 3 high pressure amplitude peaks shown |
| | in graph G2. |
| SPM - TC | Sliding Plate Module with Temperature Control to adjust Heating/Cooling |
| | temperature, wherein the temperature is adjustable manually or |
| | automatically. This module can be configured to exert constant Pressure |
| | having longer time period, wherein such constant Pressure can be lower |
| | than the High Pressure exerted by other modules but higher then the |
| | Low Pressure exerted according to graph G1. Graph G3 shows an |
| | example of the pressure profile of this module. |
| SPM - C | Sliding Plate Module for Cooling at pre-set temperature and/or Pressure |
| | Exertion. The constant Low Pressure Exertion as shown in graph G1 |
| | may be applied. |
| RCM - H | Roller Carpet Module for Heating (Optional) - This module uses a carpet |
| | to press and exert a constant pressure and rollers to exert pressure in a |
| | wave-like manner in addition to constant pressure exerted. The pressure |
| | profile is shown in graph G4. This module also heats to a pre-set |
| | temperature. |
| FRM - H | Fixed Roller Module for Heating (Optional) - This module uses a fixed |
| | roller to exert and release pressure with periodic sharp amplitude peaks. |
| | The pressure profile is shown in graph G5. This module also heats to a |
| | pre-set temperature. |

In table 6, “sliding plate” means that the module comprises two plates slidable vertically to move closer to each other or move away from each other. Note that the pressure exertion profiles of each module can be adjusted as required to achieve best results and are not limited to the profiles shown in the graphs of FIG. 12A.

The module combination of 2 heating modules (SPM-H) 1206a (or modules 1 and 2), 1 high pressure module (SPM-H-HP) 1206b (or module 3), and 2 cooling modules (SPM-C) 1208a (or modules 4 and 5) shown in the side view 12A of FIG. 12B is recommended for making the Thermal insulation device according to the examples of the present disclosure. That said, of course, there could also be other possible module combinations.

For illustration purposes, the heat treatment and cooling process for one or more inputted bags based on the module combination shown in FIG. 12B is described as follows. The working temperature range can be between 20 Degrees Celsius-250 Degrees Celsius, wherein temperature closer to the upper limit is used for heat treatment and temperature closer to the lower limit is for cooling. An example of the belt width of the top belt 1226 and the bottom belt 1228 can be 1 to 1.5 m. The belt movement speed (or line speed) can be 0.1-4 m/min.

A control station 1216 comprising one or more processors/controllers, and which may comprise one or more displays (i.e. monitors (e.g. based on LCD, LED, OLED etc.), touchscreens, etc.) for displaying a graphical user interface for user control and/or one or more user input/output interfaces (buttons, mouse, keyboard etc.) may be electrically connected to the apparatus 1200 and the modules to provide control over the movable parts (e.g. adjust positioning, adjust orientation, switch on/off, etc.), sensors, and process parameters (e.g. line speed, pressure, temperature etc.). Wiring/cables and other required electrical components/equipment can be stored in electrical cabinets 1220a and 1220b provided. The apparatus 1200 also comprises a power supply.

After powder levelling, heat treatment of the one or more bags is performed at modules 1 to 3. In modules 1 and 2, the temperature will increase gradually, meaning that the temperature of module 2 will be hotter than module 1. Such increase in temperature will support the ongoing degassing process as the air will expand inside each bag due to rising temperature. Low or no pressure may be exerted by the plates of the modules 1 and 2 individually. However, a preset compression of the top belt 1226 on the bottom belt 1228 may still be performed and the one or more bags are still subjected to this compression.

The final (or highest) heating temperature will be reached at module 3. In addition, module 3 will exert high pressure on the one or more bags. The higher pressure ensures that the one or more bags are being compressed properly. The pressure profile of module 3 can be according to graph G2 in FIG. 12A or according to other pressure profile as required.

Modules 4 and 5 are used for the cooling process. Active cooling is performed by the modules 4 and 5, in which the plates of modules 4 and 5 are chilled or cooled down to a low temperature by onsite (e.g. with 30 kW rating) chillers or coolers 1218a and 1218b. Modules 4 and 5 are configured such that the one or more bags are kept under compression during the cooling process. A constant pressure may be applied. The cooling process may decrease the temperature of each bag gradually until a requirement of lesser than 50 Degrees Celsius. This means that the temperature of module 5 will be lower than the temperature of module 4. After the requirement is satisfied, the cooling process is deemed finished and the one or more bags will be transferred to the outfeed zone 1210 of the apparatus 1200, which will transfer the made products i.e. the Thermal insulation devices to the next process.

Another type of double belt press apparatus may be used for the degassing, heating and cooling process. The main difference between such apparatus and the apparatus 1200 as described can be in the belt material of the top belt 1226 and the bottom belt 1228. Instead of a steel belt, a 3 ply (non-steel) composition belt may be used. For such belt, the overall pressure that can be applied during the process will be lower than for a steel belt. In other examples, an apparatus using vacuum to exert pressure and/or use rollers to exert pressure and provide heating may be used as well.

After the degassing, heating and cooling process, the made Thermal insulation device can be subjected to a second cleaning process (corresponding to step 234 in FIG. 2). The purpose of the second cleaning process is to clean the Thermal insulation devices in case they are contaminated by powder from a powder leaking bag or powder from a burst bag. The inputs to the second cleaning process are the made Thermal insulation devices. The second cleaning process is the same as the first cleaning process described earlier. A similar cleanliness check described earlier can be performed to check the cleanliness of each cleaned Thermal insulation device. Clean Thermal insulation devices are transferred to the next process and unclean Thermal insulation devices will be rejected.

Similar to the first cleaning process, the same cleaning apparatus (i.e. the same cleaning apparatus for the first cleaning process) or a second cleaning apparatus comprising air nozzle and/or brushes may be used. This apparatus can comprise a control station, which comprises one or more processors or controllers for controlling the process. The control station may have a display for showing a graphical user interface for user control and setting. The display may be a touch screen display. The control station may comprise light indicators for indicating whether the apparatus is in operation, in various stages of operation, or not working. A plurality of user interfaces such as buttons, knobs, switches etc. may be provided at the control station for controlling the apparatus. The apparatus comprises one or more motor or engine to drive its moving parts and a power supply.

An optional but recommended end-of-line (EOL) inspection process (corresponding to step 236 in FIG. 2) may be performed after the Thermal insulation devices are cleaned. The inputs to this EOL inspection process are the cleaned Thermal insulation devices. The inspections to perform may include one or more of the following:
a) Check the weight of an inputted Thermal insulation device to ensure that it satisfies a predetermined weight requirement (e.g. the concepts of the apparatus 600 in FIG. 6 may be adopted);
b) Check the dimensions of the Thermal insulation device to ensure that it satisfies predetermined dimensions (e.g. width, length, thickness, and/or height) requirement (e.g. techniques similar to the computer vision techniques described with reference to FIG. 11 and FIG. 11A may be used);
c) Check the visual appearance of the Thermal insulation device for creasing and check its flatness (e.g. techniques similar to the computer vision techniques described with reference to FIG. 11 and FIG. 11A may be used).
d) Check the Thermal insulation device to ensure that there is no powder leakage (e.g. techniques similar to the computer vision techniques used for cleanliness check may be used).

The Thermal insulation devices that passed all the inspection tests may be transferred to the next process, which is to have the Thermal insulation devices labelled or marked. Not good devices are rejected.

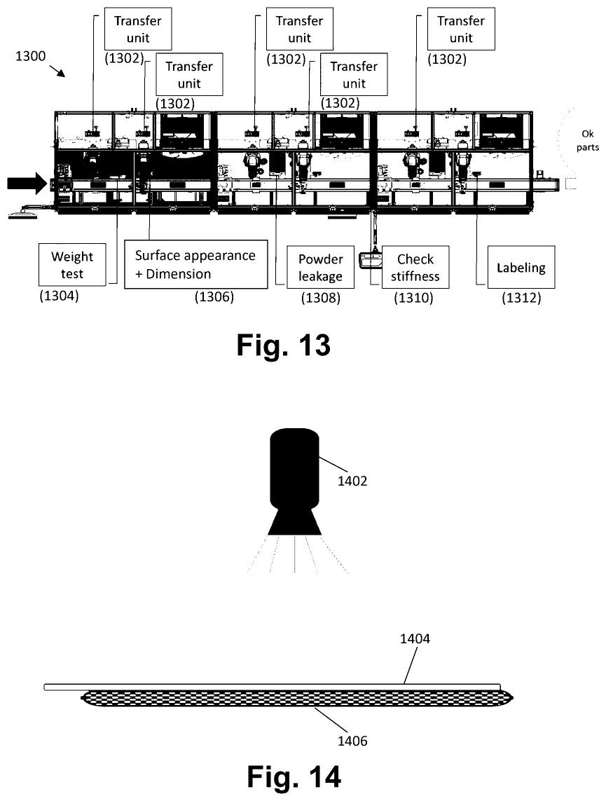

An example of an apparatus 1300 for performing the EOL inspection process and the labelling of the Thermal insulation device is illustrated by FIG. 13. The apparatus 1300 comprises a weight test station 1304 comprising one or more load cells for weighing each inputted Thermal insulation device, an appearance/dimension check station 1306 for conducting surface appearance check and dimension check for each inputted Thermal insulation device, a powder leakage check station 1308 for checking whether there is powder leakage for each inputted Thermal insulation device, a stiffness check station 1310 for checking the stiffness of each inputted Thermal insulation device, and a labelling station 1312 for labelling each good Thermal insulation device with the desired labels and/or markings. The outputs of the apparatus 1300 are good Thermal insulation devices with the labels and/or markings. The apparatus 1300 comprises a plurality of transfer units 1302, which can be robotic arms used to pick and place Thermal insulation devices to transfer them between the stations.

The apparatus 1300 can comprise a control station (not shown), which comprises one or more processors or controllers for controlling the process. The control station may have a display for showing a graphical user interface for user control and setting. The display may be a touch screen display. The control station may comprise light indicators for indicating whether the apparatus 1300 is in operation, in various stages of operation, or not working. A plurality of user interfaces such as buttons, knobs, switches etc. may be provided at the control station for controlling the apparatus 1300. The apparatus 1300 comprises one or more motor or engine to drive its moving parts and a power supply.

Specifically, at the weight test station 1304, an inputted Thermal insulation device is weighed to see if its weight meets tolerance requirements. Preferably, deviation in weight of 5% or less compared to a predetermined desired weight value should be met. The Thermal insulation device that passed the weight test will be transferred by a transfer unit 1302 to the appearance check station 1306. A failed Thermal insulation device will be moved to a reject bin.

At the appearance/dimension check station 1306, an inputted Thermal insulation device is measured to see if its dimensions meet tolerance requirements. A computer vision system is used to check the length and width of the Thermal insulation device. The tolerance requirements to be met may be a deviation of not more than 1 mm and not lesser than 1 mm from a predetermined desired width value and a predetermined desired length value. Another part of the appearance/dimension check is thickness check. Thickness can be checked by computer vision systems and/or mechanical measuring devices such as a thickness gauge. Other suitable methods besides computer vision can also be used to physically measure the length, width, and/or thickness to determine that they are within tolerance requirements. The Thermal insulation device that passed the dimensions test will be transferred by a transfer unit 1302 to check visual appearance. A Thermal insulation device failing the dimensions test will be moved to a reject bin. Appearance check is done to ensure the inputted Thermal insulation device meets visual appearance requirements. There should be no creasing on the surface of the Thermal insulation device. The flatness of the Thermal insulation device is checked to ensure that there is no serious distortion or warping of the Thermal insulation device. The visual appearance can be checked using a computer vision system configured for 2D and/or 3D imaging, laser sensors, and/or an X-Ray system. The Thermal insulation device that passed the appearance test will be transferred by a transfer unit 1302 to the powder leakage check station 1308. A failed Thermal insulation device will be moved to a reject bin.

At the powder leakage check station 1308, an inputted Thermal insulation device is checked to ensure that there is no powder leakage. The powder leakage check can be conducting using a computer vision system. Powder detected in captured images of the Thermal insulation device is an indicator of a leakage. A major powder leak in the Thermal insulation device would have caused it to be rejected the upstream weight test station 1304. The Thermal insulation device that passed the powder leakage test will be transferred by a transfer unit 1302 to the stiffness check station 1310. A failed Thermal insulation device will be moved to a reject bin.

At the stiffness check station 1310, an inputted Thermal insulation device is checked to ensure that the required stiffness is met. For instance, the Thermal insulation device may be gripped at two opposite ends and a predetermined tension or pressure is exerted to see if the Thermal insulation device would bend, distort or warp. When the tension or pressure is exerted or after the tension or pressure is released, the Thermal insulation device would pass the stiffness test if no bending, distortion or warp is detected by for instance, a computer vision system. Another method may be to exert a specific force on the Thermal insulation device via a pin or measuring plate. The distance of the pin or plate that the pin or plate has moved after force exertion will be measured. If the distance exceeds a predetermined value, the Thermal insulation device is not considered sufficiently stiff and will be rejected. The Thermal insulation device that passed the stiffness test will be transferred by a transfer unit 1302 to the labelling station 1312. A failed Thermal insulation device will be moved to a reject bin.

At the labelling station 1312, the inputted Thermal insulation devices will be labelled. An ink jet printer or a laser marking system can be used. The labelling may include product information (e.g. model number, batch number etc.) and/or manufacturing date.

After labelling is completed, an optional taping process (corresponding to step 238 in FIG. 2) may be performed on the labelled Thermal insulation devices. The need for such taping depends on application requirements. For example, such taping may be required to facilitate the securing of the Thermal insulation device on a battery cell during battery assembly. The tape/adhesive may be an adhesive tape that comes with an extended-release liner. Such extended liner can help to simplify the battery assembly process.

The inputs of the taping process are adhesive and liner or transfer tape with a liner, and the labelled Thermal insulation devices or if labelling is skipped, the Thermal insulation devices that passed the EOL inspection checks. The taping process involves applying an adhesive on the body, in particular, on the major (front and rear) surfaces of each Thermal insulation device, and providing a release liner over the adhesive. The adhesive may be in liquid form and sprayed onto the major surface of the Thermal insulation device. Alternatively, double-sided or transfer tape with one side having a release liner may be adhered on the major (front and rear) surfaces of each Thermal insulation device. The outputs of the taping process are Thermal insulation devices with tape/adhesive and release liner on one or both major surfaces of the Thermal insulation devices.

Specifically, the taping process may begin by aligning a Thermal insulation device using a tape or adhesive applicator. In the case of adhesive application, the adhesive is prepared and applied onto the desired surface of the Thermal insulation device. Thereafter, release liner is pasted on the applied adhesive. In another example, a single sided tape with a release liner on one side may be used. In this case, adhesive is applied first on the desired surface of the Thermal insulation device, followed by sticking the side of single sided tape that does not have release liner to the applied adhesive. In the case of double-sided or transfer tape having two sides with release liners, the release liner or one side of such tape is removed first for pasting the tape on the desired surface of the Thermal insulation device. Tape can be cut to size before or after (preferably before) the tape is adhered to the desired surface of the Thermal insulation device.

The tape or adhesive applicator can be part of an apparatus (not shown). Such apparatus can comprise a control station, which comprises one or more processors or controllers for controlling the process. The control station may have a display for showing a graphical user interface for user control and setting. The display may be a touch screen display. The control station may comprise light indicators for indicating whether the apparatus 1300 is in operation, in various stages of operation, or not working. A plurality of user interfaces such as buttons, knobs, switches etc. may be provided at the control station for controlling the apparatus. The apparatus can further comprise one or more motor or engine to drive its moving parts and a power supply.

In the case that two major surfaces of the Thermal insulation device are to be taped or applied with adhesive and release liner, the taping process as described above is performed on one major surface of the Thermal insulation device first. The Thermal insulation device is then rotated and aligned with the tape or adhesive applicator. In the case of double-sided tape, the required tape length can be cut before pasting the tape on the desired surface of the Thermal insulation device on the other major surface. In the case involving adhesive application, the adhesive is prepared and applied on the desired surface of the Thermal insulation device on the other major surface. For double sided tape or transfer tape, two applicators may be used to apply the tape on both sides of the Thermal insulation device at the same time or in sequence. For instance, a first applicator will be located above a first major surface of the Thermal insulation device and a second applicator will be located below a second major surface of the Thermal insulation device. The Thermal insulation device is held suspended at a distance from the second applicator and the second major surface is a surface opposite of the first major surface.

As an additional feature, if required, the release liner of the Thermal insulation device may undergo a labelling process to label or mark on the release liner with desired markings/labels.

FIG. 14A shows different scenarios 1408, 1410, 1412 and 1412 of how tape can be applied on one or both major surfaces or sides of the Thermal insulation device. The actual scenario is dependent on the application and can be any one of these scenarios. For example, with regard to scenario 1408, tape or adhesive 1408a is applied over the whole major surface of the Thermal insulation device. With regard to scenario 1410, tape or adhesive 1410a is applied over a specific surface area of the Thermal insulation device. With regard to scenario 1412, tape or adhesive 1412a is applied over a surface area that is variable with respect to the width of the Thermal insulation device. That is, the surface area to apply tape or adhesive is a function of the width. For instance, the surface area may be located the same distance away from width boundary ends of the Thermal insulation device. Such surface area may extend substantially along the length of the Thermal insulation device. The width boundary ends refer to ends located opposite to each other, which are apart by the distance of the width of the Thermal insulation device. With regard to scenario 1414, tape or adhesive 1414a is applied over a surface area that is variable with respect to the length of the Thermal insulation device. That is, the surface area to apply tape or adhesive is a function of the length. For instance, the surface area may be located the same distance away from length boundary ends of the Thermal insulation device. The length boundary ends refer to ends located opposite to each other, which are apart by the distance of the length of the Thermal insulation device. Furthermore, more than one other tape or adhesive 1414b covering specific surface areas may be applied at specific positions. In this scenario, the tape or adhesive 1414b are relatively smaller size compared to the tape or adhesive 1414a. Peelable release liners are to be provided for the applied tape or adhesive 1408a, 1410a, 1412a, 1414a, and 1414b to enable them to stick to surfaces as required.

After the taping process is completed or during the taping process, a taping quality check process (corresponding to step 240 in FIG. 2) may be performed on the Thermal insulation devices. This taping quality check process may check that tape or adhesive is properly applied on the Thermal insulation device. The taping quality check process may check for correct positioning of the tape/adhesive on one or both major surfaces of the Thermal insulation devices based on a pre-decided decision on where the tape/adhesive is to be applied. Visual appearance of the tape/adhesive can be checked, for instance, a visual check is done to ensure that the release liner is properly pasted. If the visual check is done during the taping process, applied adhesive may be checked to ensure there are no bubbles. Proper tape or adhesive application and bubbles in adhesive can be checked after the taping process is completed as well. This can be done by a computer vision system. The bubbles are visible even if release liner is attached to the tape or adhesive. A peel adhesion test of the adhesive can also be conducted but this may be an offline random check that is not done for every bag. The Thermal insulation device that passed the taping quality check will be transferred to the next process. A failed Thermal insulation device will be moved to a reject bin.

A computer vision system comprising a camera or imaging sensor can be used to check the position of the tape or adhesive on a Thermal insulation device. FIG. 14 shows an example of a camera 1402 of such computer vision system used to check a tape with a release liner 1404 pasted on a Thermal insulation device 1406. For example, it can be set as a requirement that the desired position or location where the tape or adhesive is applied should not have a deviation of greater than 1 mm and lesser than 1 mm from a pre-determined position or location on the Thermal insulation device to apply the tape or adhesive. The computer vision system can also be used to check for bubbles and proper tape or adhesive application. A peel adhesion strength requirement to satisfy for the peel adhesion test for adhesive applied can be greater than or equal to 8N/25 mm.

After the taping quality check or if the taping process is skipped, after the Thermal insulation devices passed the EOL inspection, they are ready to be packaged via a packaging process (corresponding to steps 242 to 246 in FIG. 2). This packaging process can be completely automated. The Thermal insulation devices can be packed into cardboard or re-useable containers (or boxes). A stacking process to stack up the Thermal insulation devices should be performed before the Thermal insulation devices are packed into the containers. Such stacking organises, compacts, and bundles a plurality of Thermal insulation devices together, thereby maximising the storage space of the containers. The Thermal insulation devices are also orientated and arranged in a specific manner and strapped to prevent any negative effect (e.g. knocking into other thermal insulation products resulting in powder leak or bag bursting) to the product (i.e. the Thermal insulation device) characteristics during shipment.

With reference to FIG. 15 and FIG. 15A, the stacking process may involve stacking a plurality of Thermal insulation devices one at a time between two boards. The two boards may be made of cardboard, plywood, reusable plastic board, foam (e.g. expanded polystyrene), and the like. Firstly, a bottom board 1504 is arranged to form a base for stacking the plurality of Thermal insulation devices. Specifically, FIG. 15 shows 4 pieces of stacked Thermal insulation devices 1502 stacked on top of the bottom board 1504. A single piece of Thermal insulation device 1500 is about to be stacked on top of the 4 pieces of stacked Thermal insulation devices 1502. Pressure may be applied on the stacked Thermal insulation devices 1502 when the single piece of Thermal insulation device 1500 is stacked on the stack of Thermal insulation devices 1502. After a predetermined number of Thermal insulation devices are stacked, the stacking of Thermal insulation devices is completed and a top board 1506 is stacked over the complete stack of Thermal insulation devices 1510. Pressure may be exerted on the stacked thermal devices 1510 when the top board 1506 is stacked. After the top board 1506 is stacked on the topmost Thermal insulation device, the stack of Thermal insulation devices 1510 between the top board 1506 and the bottom board 1504 is strapped using staps 1508. The output of the stacking process is a strapped bundle of Thermal insulation devices 1510.

The stack of Thermal insulation devices is preferably stacked under a specific pressure. The strapping using straps can also be done to maintain a specific compression between the stacked Thermal insulation devices. This helps to maintain the required thickness of the Thermal insulation devices and prevents them from inflating, which is possible over time as they contain micro-perforations.

After the Thermal insulation devices are stacked to bundles. The bundles can be packed into a final packaging such as a cardboard or re-usable container. As the inflation of the Thermal insulation devices should be prevented, in one example, vacuum packaging or packing may be done. Vacuum packing is a method of packaging that removes air from the package prior to sealing. This method involves placing items in a plastic film package, removing air from inside and sealing the package.

A stacking and/or packaging apparatus with pick and place robots, a strapping device, etc. may be provided to perform the abovementioned stacking and/or packaging process. This apparatus can comprise a control station, which comprises one or more processors or controllers for controlling the process. The control station may have a display for showing a graphical user interface for user control and setting. The display may be a touch screen display. The control station may comprise light indicators for indicating whether the apparatus is in operation, in various stages of operation, or not working. A plurality of user interfaces such as buttons, knobs, switches etc. may be provided at the control station for controlling the apparatus. The apparatus comprises one or more motor or engine to drive its moving parts and a power supply.

A plurality of the Framed Thermal insulation device described as follows can be stacked, bundled and packaged in the same manner as described above.

### (D) Framed Thermal Insulation Device

In the present disclosure, a Framed Thermal insulation device refers to:
(1) the Thermal insulation device described with reference to the earlier mentioned Figures having sides and/or edges that are framed; or
(2) a combination of the Thermal insulation device layered with one or more sheets of Fire-Retardant device such as the Fire-retardant (FR) device described earlier and/or another Thermal insulation device, wherein such combination has sides and/or edges that are framed. Other examples of Fire-Retardant device in the present disclosure can also be attached in the Framed Thermal insulation device.

In the examples of the present disclosure, the Thermal insulation device, FR device, intumescent sheet and Framed Thermal insulation device described are generally flat, thin and have two major surfaces.

A frame structure used to frame the Thermal insulation device or its combinations with other materials may be used to frame every side and/or edge of the Thermal insulation device or its combinations, or to only frame on selected one or more side and/or edge the Thermal insulation device or its combinations. The frame structure may be made of silicone or other suitable material.

When a framed insulation device is used in a battery such as an Electric Vehicle battery, the frame structure may serve to enhance mechanical performance of the insulation device that is framed. A framed insulation device may suppress expansion pressure of a battery cell over the lifetime of the cell, even in a high temperature environment. The frame structure ensures the thickness of the insulation device (e.g. the Thermal insulation device or its combinations) is maintained throughout the lifetime of a battery cell (i.e. from the Beginning-of-Life to the End-of-Life state). The thickness of the frame structure may be substantially (close to) the thickness of the Thermal insulation device or its combination with other products or devices. If the material of the frame structure is silicone, it may be flexible and expandable.

FIG. 16 illustrates 4 products (or compositions or devices) 1600, 1610, 1620, and 1630 that can be used with or without the frame structure described above. An intumescent (fire retardant) sheet 1612, which may or may not be the Fire-retardant device 1602 described earlier, may be adhered or placed on one or more major surfaces of the Thermal insulation device 1608. Instead of the intumescent sheet 1612, an intumescent coating (also given the reference numeral 1612 in FIG. 16) may be coated over one or more major surfaces of the Thermal insulation device 1608. Examples of such intumescent coating includes fire-retardant paint and the impregnating solution that can be used to make the Fire-retardant device 1602.

The product 1610 comprises the Thermal insulation device 1608 and two intumescent sheets or coating 1612 disposed at the two major surfaces of the Thermal insulation device 1608.

The product 1600 comprises the Thermal insulation device 1608 and two Fire-retardant devices 1602 disposed at the two major surfaces of the Thermal insulation device 1608. Adhesive in the form of tape or a coated film such as the adhesive film 1614 may be used to adhere the two Fire-retardant devices 1602 to the Thermal insulation device 1608.

The product 1620 comprises two Thermal insulation devices 1608 disposed at the two major surfaces of one layer of the intumescent sheet 1612, which may or may not be the Fire-retardant device 1602 described earlier. The intumescent sheet 1612 in product 1620 can also be the abovementioned intumescent coating (also given the reference numeral 1612 in FIG. 16)

The product 1630 comprises one Thermal insulation devices 1608 disposed at one major surface of one layer of the intumescent sheet 1612, which may or may not be the Fire-retardant device 1602 described earlier.

The following disclosure provides an example of a process to make the Framed Thermal insulation device and some of the apparatuses used. The components and assembly of examples of the framed Thermal insulation device are also described.

FIG. 16A shows a top view 16A and a cross-sectional view 16B of a first example of a Framed Thermal insulation device 1600a. The Framed Thermal insulation device 1600a comprises the Thermal insulation device 1608 and two layers of the Fire-retardant (FR) device 1602. Each layer of the FR device 1602 is disposed on each side of the major surfaces of the Thermal insulation device. The Thermal insulation device 1608 is sandwiched between the two layers of the FR device 1602. A frame structure 1604 made up of top and bottom layers of frames is provided to cover the sides or edges along a perimeter of the Thermal insulation device 1608. A layer of sealing 1606 is provided over each major surface of the Framed Thermal insulation device 1600a. The sealing 1606 forms an external protective layer over the exposed major surfaces of the two layers of FR device 1602.

FIG. 16B shows a top view 16C and a cross-sectional view 16D of a second example of a Framed Thermal insulation device 1600b. Common elements in FIG. 16A and FIG. 16B are given the same reference numerals. The Framed Thermal insulation device 1600b comprises the Thermal insulation device 1608, wherein the sides or edges along a perimeter of the Thermal insulation device 1608 are sandwiched in a frame structure 1604 made up of top and bottom layers of frames. A layer of sealing 1606 is provided over each major surface of the Framed Thermal insulation device 1600b. The sealing 1606 forms an external protective layer over the exposed major surfaces of the Thermal insulation device 1608.

Examples of range of dimensions and weight of the Framed Thermal insulation device and its combination with/without Frame and with/without Fire-retardant device for Electric Vehicle Battery application are provided in table 7 below.

TABLE 7
Examples of range of dimensions and weight of the Framed
Thermal insulation device and its combination with/without
Frame and with/without Fire-retardant device

| Description | Minimum | | Maximum | |
|---|---|---|---|---|
| Width and length of 1 pack of | 50 mm × 50 mm | | 200 mm × 700 mm | |
| Thermal insulation device | (Width × Length) | | (Width × Length) | |
| width and length | | | | |
| Thickness of 1 pack of | 1 | mm | 10 | mm |
| Thermal insulation device | | | | |
| Functional filler weight of the | 0.2 | | 280 | g |
| Thermal insulation device (for | | | | |
| filling density of 0.1 to 0.3 | | | | |
| g/cm³) | | | | |
| Weight of film of cover | 1.0 | g | 60 | g |
| material used for the bag of | | | | |
| the Thermal insulation device | | | | |
| (e.g. comprising 3 | | | | |
| layers, PET- Polyethylene | | | | |
| Terephthalate, EG- Fibre | | | | |
| glass and PE- Polyethylene) | | | | |
| Total weight range of a typical | 1.2 | g | 340 | g |
| Thermal insulation device | | | | |
| without Frame | | | | |
| Frame weight (Silicone | 3.7 | g | 120 | g |
| material) | | | | |
| Total weight range of a | 4.9 | g | 460 | g |
| Framed Thermal insulation | | | | |
| device | | | | |
| Width and length of 1 piece | 50 mm × 50 mm | | 200 mm × 700 mm | |
| Fire-retardant device | (Width × Length) | | (Width × Length) | |
| Thickness of 1 piece of Fire- | 0.5 | mm | 1 | mm |
| retardant device | | | | |
| Weight of 1 piece of Fire- | 1.75 | g | 196 | g |
| retardant device | | | | |
| Total weight of Framed | 8.4 | g | 852 | g |
| Thermal insulation device | | | | |
| with 2 pieces of Fire-retardant | | | | |
| device | | | | |

FIG. 16C shows enlarged views of the top view 16C in FIG. 16B, the cross-sectional view 16D in 16B and the cross-sectional view 16B in FIG. 16A. FIG. 16C shows specific examples of possible dimensions of the first example of the Framed Thermal insulation device 1600a and the second example of the Framed Thermal insulation device 1600b. The length and width of the Framed Thermal insulation device 1600b can be about 148 mm and 98 mm respectively. The Framed Thermal insulation device 1600a (top view 16A is not shown in FIG. 16C) can have the same length and width as well. The thickness of the Framed Thermal insulation device 1600a and the Framed Thermal insulation device 1600b, excluding the sealing 1606, can be about 3 mm. Each of the two layers of the frame structure 1604 in the Framed Thermal insulation device 1600a and the Framed Thermal insulation device 1600b can be about 1.5 mm in thickness. The Thermal insulation device 1608 in the Framed Thermal insulation device 1600b can have a thickness of 2 mm. Each of the two layers of the Fire-retardant device 1602 in the Framed Thermal insulation device 1600a can be about 0.5 mm in thickness. The Thermal insulation device 1608 in the Framed Thermal insulation device 1600a can have a thickness of 2 mm.

### (E) Framed Thermal Insulation Device Manufacturing Process

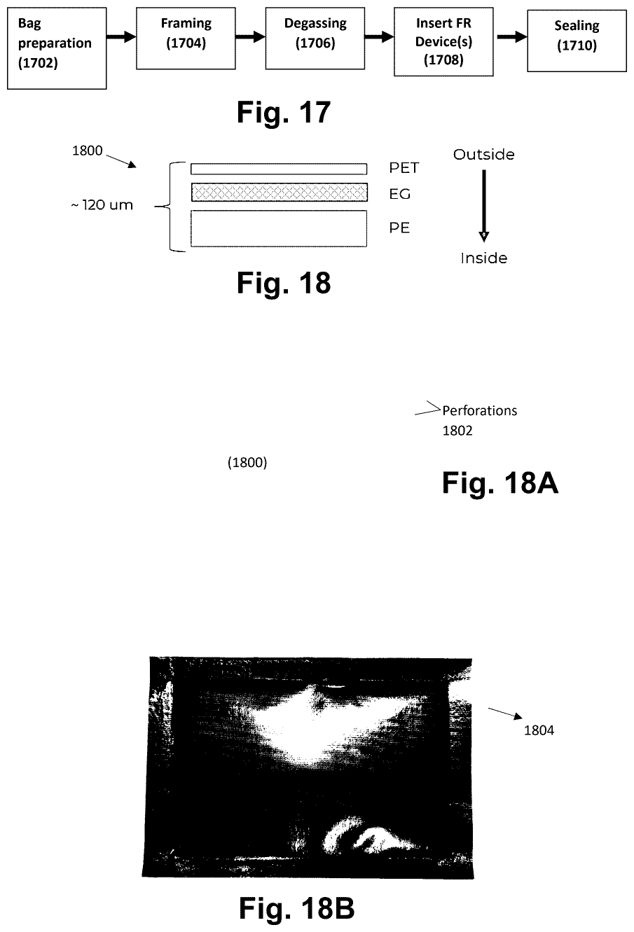

An example of a method for manufacturing the Framed Thermal insulation device and its combinations is illustrated by FIG. 17 and is described as follows. The method of manufacturing includes a step 1702 of Bag preparation and filling, a step 1704 of Framing, a step 1706 of Degassing, a step 1708 of FR Device insertion, and a step 1710 of Sealing. The Framed Thermal insulation device comprises the Thermal Insulation device, which is in the form of a bag containing thermal insulation particles described previously.

The step 1702 of Bag preparation and filling can include steps 202 to 230 in FIG. 2 (with or without the steps previously described as optional). Examples pertaining to steps 202 to 230 described with reference to FIG. 3 to FIG. 11A may be involved. Step 230 is the step before the step 232 of degassing, heating and cooling. The outputs of step 1702 can be bags of the Thermal insulation device that are not yet degassed, heat-treated and cooled. More examples pertaining to step 1702 would be described later. Alternatively, the outputs of step (A) can be bags (i.e. bags already degassed, heat-treated and cooled) that are made by the method of FIG. 2 (with or without the optional steps).

The step 1704 of Framing receives the outputs of step 1702. More details on the framing step 1704 would be described later. The outputs of step 1704 would be Framed Thermal insulation devices. The step 1706 of Degassing is similar to the degassing part of the step 232 in FIG. 2, except that the inputs to step 1706 are the Framed Thermal insulation devices. More examples pertaining to step 1706 would be described later.

After or before degassing, the step 1708 of FR Device insertion can be performed to insert one or more FR Devices into the Framed Thermal insulation device.

Step 1710 involves sealing of the Framed Thermal insulation device, preferably immediately after the FR Device is inserted into the Framed Thermal insulation device.

FIG. 18 shows an example of a film material 1800 that can be used to make the bag of the Thermal insulation device. The composition of the film material 1800 includes a Polyethylene Terephthalate (PET) layer, a Fibre glass (EG) layer (e.g. E-glass woven or non-woven textile, fabric or mat) and a Polyethylene (PE) layer (abbreviation for the film material: PET/EG/PE). The PET layer is an outermost layer (corresponding to FML1 in FIG. 1), the EG layer is a middle layer (corresponding to FML2 in FIG. 1) between the outermost layer and an innermost layer, and the PE layer is the innermost layer (corresponding to FML3 in FIG. 1). In the present example, the PE layer will contact the thermal insulation particles filled in the bag (the optional FF4 in FIG. 1 is not present). The film material 1800 is formed through heat lamination of the 3 layers of materials. The film material 1800 is similar to the example of FIG. 1C, wherein no adhesive is used. During lamination, the polymer layers of PET and PE would soften or melt and stick together, along with the EG layer. It is possible that the boundaries between the 3 layers are not well defined (i.e. materials are mixed) like the boundary of the 2 layers of materials shown in the example of FIG. 1C. The thickness of the film material 1800 is the thickness of all 3 layers combined, which can be about 120 μm.

The surface of the film material 1800 is perforated. Such perforations are provided for ventilation purposes for the bag to be made and to facilitate degassing. The size of each perforation should be smaller than the size of the thermal insulation particles to be filled in the bag. For example, as mentioned earlier, the average diameter of the perforations can be 15 μm or less. To provide sufficient passage for air/pressure release, the centre-to-centre spacing of the perforations may be about 3×3 mm. FIG. 18A shows an enlarged view of a sample of the film material 1800 containing the perforations 1802. FIG. 18B shows a sample of a real-life bag 1804 that can be made. This bag 1804 in FIG. 18B has 4 sided seals instead of the 3-sided seals of the bags described earlier.

Instead of EG, Aluminium (AL) may be used as the middle layer of the film material. The abbreviation for such film material is PET/AL/PE. The properties of EG woven mat and AL are provided in table 8 as follows.

TABLE 8
Comparison between EG and AL

| Raw Material | AL Foil | EG Woven Mat |
|---|---|---|
| Melting point | Al melts at ~660 | Thermogravimetric analysis |
| | Degrees Celsius | (TGA -air) tested up to 1000 |
| | (lit) | Degrees Celsius, which shows |
| | | no degradation in sample |
| | | after test. |
| Thermal | 237 W/m · k (lit) | 1.35 W/m · K (lit) |
| Conductivity | | |
| Electrical | Conducting | Insulating |
| Conductivity | | |

The tensile strength and Thermal conductivity of two examples of the film material are provided in table 9 below.

TABLE 9
Comparison between Film materials PET/AL/PE and PET/EG/PE

| Film Material | PET/AL/PE | PET/EG/PE |
|---|---|---|
| Tensile Strength | 23 MPa (one ply- | 91 MPa (one ply- |
| (Perforated Film) | laminate direction) | laminate direction) |
| | 25 MPa (one ply- | 68 MPa (one ply- |
| | cross direction) | cross direction) |
| Thermal | Inner layer: 0.160 | Inner layer: 0.101 |
| Conductivity | Outer layer: 0.184 | Outer layer: 0.101 |
| (Tci, W/m · K) | | |

The Thermal conductivities of filled (filled with Thermal insulation particles e.g. aerogel powder) and heat treated Thermal insulation devices made with Film materials PET/AL/PE and PET/EG/PE are provided in table 10 below.

TABLE 10
Comparison of Thermal insulation devices made
with Film materials PET/AL/PE and PET/EG/PE

| Filled, Heat Treated | | |
|---|---|---|
| Thermal insulation | | |
| device | PET/AL/PE | PET/EG/PE |
| Thermal Conductivity | 0.0157 (24 Degrees | 0.0141 (24 Degrees |
| at 2 kPa (HFM, W/m · K) | Celsius) | Celsius) |
| | 0.0161 (50 Degrees | 0.0150 (50 Degrees |
| | Celsius:) | Celsius) |

Examples pertaining to step 1702 of FIG. 17 directed to bag preparation and filling for a 4-sided sealed bag (e.g. 1804 in FIG. 18B) will now be described. The bag preparation and filling process performed at step 1702 may comprise 3 main steps, Bag forming, Bag filling and Bag sealing. These 3 steps may be conducted using, an apparatus (or equipment or machine), which is customised for the process. The apparatus may be a machine from Effytec, called GP26. Table 11 below shows examples of customised (unique) GP26 machine specifications for the bag preparation and filling process for making 4-sided sealed bags.

TABLE 11
Machine Specifications

| | |
|---|---|
| Filling system: | 2x auger filler (duplex) |
| Sachet type: | 4 side seal (flat sachet or bag) |
| Machine output: | ~80 ppm |
| | To be determined based on bag size |
| | and film characteristics. |
| Range bag size: | Min: 80 × 100 mm (Width × Length) |
| | Max: 130 × 350 mm (Width × Length) |
| | Actual bag size depends on amount of |
| | powder to be filled. |
| Reel dimension: | Paper core diameter: 150-152 mm |
| | Roll outer diameter: max. 600 mm |
| Electrical data: | 400 V, 3 Ph, 50 Hz, 20 kw |
| Air consumption: | 300 l/min |
| (Programmable | For example, a PLC controller from Omron |
| Logic Controller) | Corporation may be used. |
| PLC controller | |
| Bottom and | Heat sealing to be used for sealing the |
| vertical seal: | bottom and vertical seals. |
| Top seal: | Ultrasonic seal to be used for sealing the top seal. |

The essential components of the customised GP26 machine 1910 are shown in FIG. 19.

With reference to FIG. 19, cover (or film) material in the form of a film or tape for bags are fed from two bulk rolls mounted to a reel axle 1 and a second reel axle 2 respectively. Splicers 3 and 4 for joining two pieces of cover material fed from the two axles 1 and 2 respectively are used. The cover material joined by the splicers is then perforated by a perforating punch 5. Unwinding pulling rollers 6 and pulling tensioner 7 are used to straighten the joined cover material.

In another example, only a single bulk roll of film of the cover material mounted to one reel axle 1 or 2 may be used. The other respective reel axle 2 or 1 may not be present or may still be present to provide feeding of the film of cover material when the reel axle that is currently in use runs out of film. In the case that only a single bulk roll of film of cover material is used, the single bulk roll of film may supply two pieces of adjacent placed films (i.e. already joined at major surfaces) directly from the single bulk roll of film of cover material. In this case, the splicers (e.g. 3 and 4) would be used for straightening and/or guiding the film and not used for joining the films. This example is different from the concept of feeding two separate pieces of films from two bulk rolls and have them joined by splicers 3 and 4 as described in the example of the preceding paragraph.

In a further example, two pieces of film of the cover material to be joined may be provided from one single bulk roll and not fed from two different bulk rolls. In this case, cutting may be required to provide two streams of film of the cover material for joining by, for instance, the splicers such as splicers 3 and 4.

In yet another example, only one bulk roll of film of the cover material may be used and correspondingly one reel axle is used. The bulk roll of film may already be sealed on one or more sides. For instance, the film may be folded to form the sealed side, as well as to form two major surfaces of the bag. Lesser sealing jaws would be required in this case. For instance, the bottom side may already be sealed (or formed by folding the film) so that the top side can remain open for filling and only top, left and right sealing jaws are required. In another case, even if the film supplied is folded to form the sealed side, this sealed side may still be subject to sealing by a sealing jaw (e.g. bottom sealing jaw 10) to further secure it.

The presence and use of the perforating punch 5 is optional, and bag perforation may be optional. In another example, the perforations to be made by the punch 5 may be skipped. In this case, either the film or films of cover material are already perforated when they are provided from the bulk roll or rolls, or that no perforation is to be provided for the bag.

A forming plough 8 configured for automatic film alignment is used to rotate and align the film or films of cover material being fed to enable 3 sealing jaws 10, 11 and 12 to seal and form 3 sides, bottom, left and right sides of a bag respectively. Heat sealing is used. The bag made is squarish or rectangular in shape so sealing the 3 sides leaves the top side open for filling materials into the bag. After sealing the 3 sides, the bag is moved to a cooling jaw 13 to cool down the seals formed for the 3 sides. Thereafter, the bag is moved to an area for cutting die units i.e. to cut the sealed left and right sides of the bag. A pair of scissors 17 that comprises a scissors gripper 18 to grip the bag at one end (e.g. grip the sealed right side of the bag) is used. A servo film pulling unit 15 is used to stretch/tighten at an opposite end (e.g. stretch/tighten from the sealed left side of the bag) of the bag after the scissors gripper 18 grips the bag to set the bag in position for cutting. After cutting, the cut bag is moved to an opening station to open the top side of the bag that is unsealed.

Bottom vacuum cups 20 are used to hold the sealed bottom side of the bag and a blowing cone 21 is used to open the unsealed top side of the bag. Upon detection of opening, the opened bag is moved to one or more filling stations, e.g. a first filling station 22, a second filling station 23, and if required, more filling stations, to fill in the required material. Each filling station may use a cone to fill the bag. Thermal insulation particles in powder form may be filled into the bag. After filling, the filled bag is moved to a stretching station 24 for stretching and closing the open side of the bag. Thereafter, one or more top sealing jaws, e.g. a first top sealing jaw 25 and a second top sealing jaw 26, may be used to seal the top side of the bag. For the sealing method, a heat-sealing process and/or ultrasonic sealing process may be considered. The top side of the bag is then cooled using a top cooling jaw 27. After cooling, the bag is formed and exits the system of the GP26 machine 1910. The bag may exit to a “reject” station for quality check and if the bag is, for instance, the wrong weight, it may be rejected.

A photocell is a light sensitive module and may be a resistor that changes resistance depending on the amount of light incident on it. A plurality of such photocell (e.g. reference numerals 4, 9, and 16 in FIG. 19) is used as sensors for accurate positioning and/or alignment during the bag forming process.

A computer/control system comprising one or more processors/controllers, and which may comprise one or more displays (i.e. monitors (e.g. based on LCD, LED, OLED etc.), touchscreens, etc.) for displaying a graphical user interface for user control and/or one or more user input/output interfaces (buttons, mouse, keyboard etc.) may be connected to the GP26 machine to provide control over the movable parts (e.g. adjust positioning, adjust orientation, switch on/off, etc.), sensors (e.g. photocell), and process parameters (e.g. line speed, pressure, temperature etc.) in the GP26 machine 1910. The GP26 machine 1910 also comprises one or more motor or engine to drive its moving parts and a power supply.

The bags produced by the GP26 machine 1910 described above are 4-sided sealed bags. An example of a 4-sided sealed bag 1900 produced by the GP26 machine 1910 is shown in FIG. 19A. A sealing area 1904 extends from a main body of the bag 1902 around a perimeter of the bag 1900. The main body of the bag 1902 contains the thermal insulation particles i.e. the powder filled into the bag 1900. The width of the sealing area 1904 around the bag 1900 may be about 6 mm. The GP26 machine 1910 (for 4-sided sealed bags) and other apparatus (e.g. the apparatus 400 of FIG. 4 for 3-sided sealed bags) may be customised or modified to cater to different requirements.

Examples pertaining to step 1704 of FIG. 17 directed to Framing for a 3-sided or 4-sided sealed bag of the Thermal insulation device will now be described.

A Framed Thermal insulation device and its variants may comprise of two frames. In an example described as follows, a bag constituting the Thermal insulation device is sandwiched between a bottom frame layer (or bottom frame) and a top frame layer (or top frame). The frame layers cover the side or edges or border around the perimeter of the Thermal insulation device or its combination with other layers of material. In another example, more than one Thermal insulation device may be sandwiched.

In the present example, the Thermal insulation device is 4-sided sealed and rectangular in shape. Correspondingly, each of the top frame layer and bottom frame layer (or bottom frame) is 4-sided and rectangular in shape, and is configured to cover each side border of the Thermal insulation device. In another example, the Thermal insulation device and the frames may be squarish, circular, or any other shape and the frame structure (made up of the top and bottom frame layers) is configured to cover the perimeter of such shape. Table 12 below shows an example of the frame specification.

TABLE 12
Example of Frame specification

| Frame material: | E.g. Silicone or other similar or suitable material | |
|---|---|---|
| Frame size: | 148 × 98 | mm |
| Frame width: | ~5-6 | mm |

| | |
|---|---|
| Frame thickness: | 1.5 mm per frame |
| Frame | E.g. Fire resistant adhesive (to be used to adhere |
| adhesive: | to the Thermal insulation device or its combinations) |

Fig. illustrates 3 process steps for framing a Thermal insulation device 2004, which is an example of the above-mentioned Thermal insulation device 2004. A framing apparatus (not shown) may be used. Such framing apparatus may comprise a frame supply for supplying a top frame 2006 and a bottom frame 2002. The frame supply can be a magazine or stack. During frame assembly, a pick-and-place robot may be used, for example, a 6-axis robot. Such robot is comprised in the framing apparatus. In a first step (1.), the bottom frame 2002 is laid on a platform or fixture of the framing apparatus. In a second step (2.), one or more bags of the Thermal insulation device 2004 is placed on the bottom frame 2002. In a third step (3.), a top frame 2006 is placed over the Thermal insulation device 2004. After the third step, the Thermal insulation device 2004 will be sandwiched in between the top frame 2006 and the bottom frame 2002. For the Thermal insulation device 2004 to be bonded to the top frame 2006 and the bottom frame 2002, there are intermediate bonding steps between the first step (1.), the second step (2.) and the third step (3.). 20

FIG. 20A illustrates how bonding between a bag of the Thermal insulation device 2004, the bottom frame 2002 and the top frame 2006 of FIG. 20 can be done through adhesive 2010. FIG. 20A shows a top view of one of the frames 2002 or 2006 and a top view of the Thermal insulation device 2004. Each of the frames 2002 and 2006 is configured to surround only the border or perimeter or edges 2016 of the Thermal insulation device 2004, and thus has a hollow center 2008. The Thermal insulation device 2004 will fill the hollow center 2008. Each of the frames 2002 and 2006 has a shape (in this case, rectangular) corresponding to the shape of the edges 2016 of the Thermal insulation device 2004 (in this case, the Thermal insulation device 2004 is rectangular in shape).

The framing apparatus may comprise a tape and/or adhesive applicator to apply tape and/or adhesive. The adhesive 2010 may be applied to one side of only frame 2002 or 2006 or applied to one side of both frames 2006 and 2002. Thereafter, in a first scenario, the side or sides of the bottom frame 2002 and/or the top frame 2006 applied with adhesive 2010 can be pasted to the edges 2016 of the Thermal insulation device 2004 or in a second scenario, the side of the bottom frame 2002 or the top frame 2006 applied with adhesive 2010 will be pasted to the side of the other frame 2006 or 2002 respectively. The second scenario can apply if the bag is thick and the top frame 2006 is unable to contact the bottom frame 2002 when they are placed over the bag.

In another example, the adhesive 2010 can be in the form of tape such as double-sided tape or transfer tape, and is pasted to the edges 2016 of the Thermal insulation device 2004 or the frames 2002 and/or 2006 before the 3 framing process steps described with reference to FIG. 20 take place. In this case, the intermediate bonding steps may include additional process steps to remove or peel off a release liner 2014 present on the adhesive tape 2010 pasted to one of or both frames 2002 and 2006, or pasted to the edges 2016 of the Thermal insulation device 2004.

The framing apparatus can comprise a control station, which comprises one or more processors or controllers for controlling the process. The control station may have a display for showing a graphical user interface for user control and setting. The display may be a touch screen display. The control station may comprise light indicators for indicating whether the apparatus is in operation, in various stages of operation, or not working. A plurality of user interfaces such as buttons, knobs, switches etc. may be provided at the control station for controlling the apparatus. The apparatus comprises one or more motor or engine to drive its moving parts and a power supply.

After the framing process described with reference to FIGS. 20 and 20A, degassing can be performed. This is step 1706 of FIG. 17. The degassing process can be performed by an example of a degassing conveyor apparatus/system described as follows. This degassing conveyor system does not perform heating. The step 1706 of degassing can also be done by similar methods and apparatuses described with reference to FIG. 12 to FIG. 12B and if heating is not required, the modules of the apparatus 1200 providing heating does not have to be used.

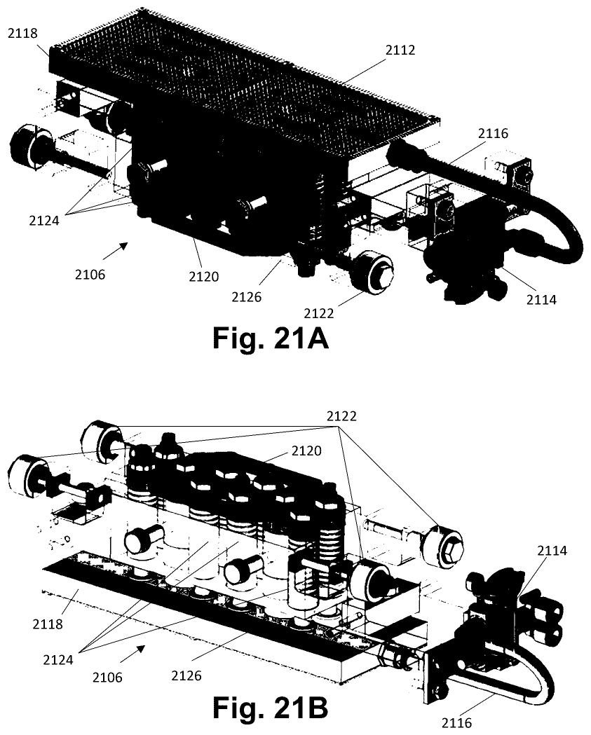

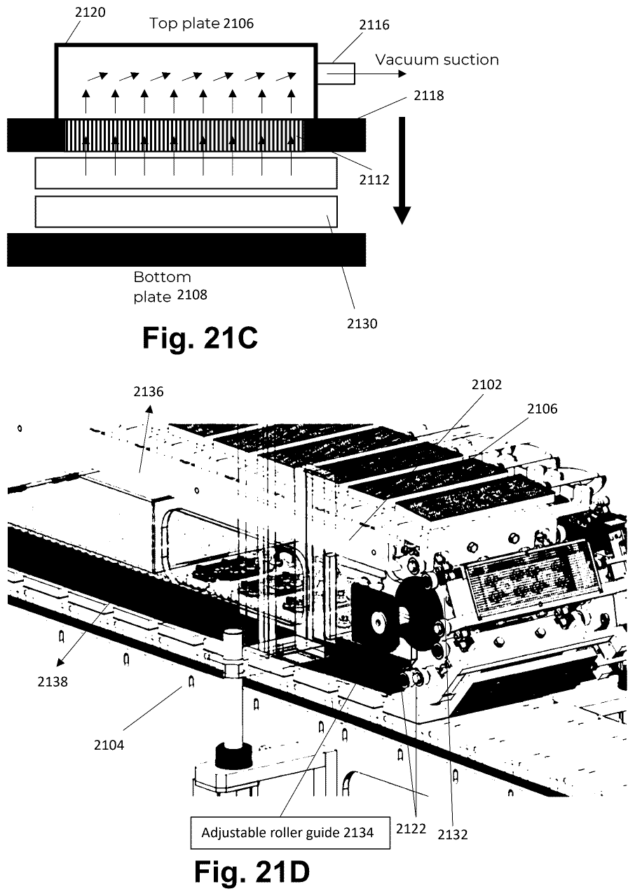

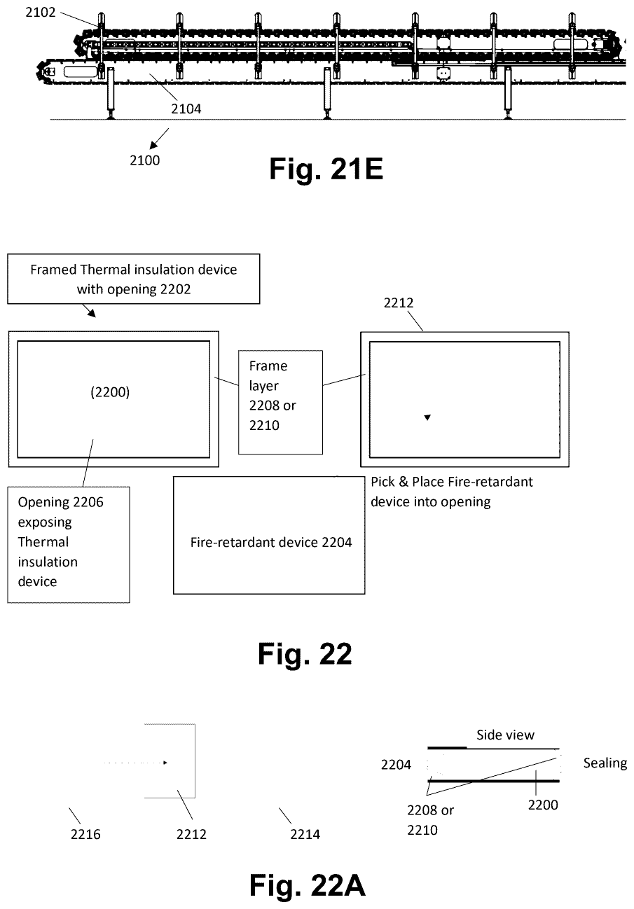

The purpose of the degassing is to remove the excessive air from the inside of each bag of the Thermal insulation device and help to secure the frames of each bag. FIG. 21 shows the example of the degassing conveyor apparatus/system 2100 comprising two conveyors positioned one on top of the other. That is, there is a top conveyor 2102 and a bottom conveyor 2104. The top (or upper) conveyor comprises a plurality of interconnected top plates 2106 (also called top conveyor plates) arranged to move in an endless loop and the bottom (or lower) conveyor 2104 (also called bottom conveyor plates) comprises a plurality of interconnected bottom plates 2108 arranged to move in an endless loop. The distance between both conveyors 2102 and 2104 can be adjusted. In the present example, each top plate 2106 works with a bottom plate 2108 to compress a framed bag (or in another example, a frameless bag) of the Thermal insulation device placed between these plates so as to degas the framed bag. The speed of both conveyors 2102 and 2104 should be synchronized. This can be accomplished either via a mechanical and/or electrical synchronization method.

For example, a framed bag (or in another example, a frameless bag) to be degassed can be placed on the bottom conveyor 2104 at a bottom plate 2110. The direction that the bag to be conveyed by the bottom conveyor 2104 is shown by the big bold arrow in FIG. 21. The size of each bottom conveyor plate 2108 size may be larger in size than the actual framed or frameless bag so that each bag can be placed within the footprint of the bottom conveyor plate 2108.

The following description refers to both FIG. 21A and FIG. 21B. FIG. 21A shows a bottom perspective view of one of the top plates 2106. FIG. 21B shows a top perspective view of the top plate 2106. In FIGS. 21A and 21B, external walls 2126 of a top portion 2120 of the top plate 2106 are deliberately drawn to be transparent to show parts behind the external walls 2126. A bottom base 2118 of the top plate 2106 is shown at the top in FIG. 21A and shown at the bottom in FIG. 21B. The top plate 2106 is configured to facilitate degassing of each bag residing in a bottom conveyor plate 2108 via vacuum suction. The bottom base 2118 of the top conveyor plates 2106 is perforated with a plurality of perforations 2112 and is connected to a vacuum suction unit (or vacuum suction device) 2114 to draw or suck air through the perforations 2112. Vacuum suction will be used to degas a bag in a bottom conveyor plate 2108 when the top conveyor plate 2106 is positioned over the bag in the bottom conveyor plate 2108. The vacuum suction unit 2114 comprises air pumps to provide the suction and an air suction pipe 2116 joins the vacuum suction unit 2114 to the bottom base 2118.

The top portion 2120 of the top plate 2106 is configured to comprise a pushing mechanism comprising one or more cams 2122 i.e. linear cams located at 4 corners and a spring set comprising one or more biasing members. Each linear cam 2122 is in a form of a roller. In the present example, the one or more biasing members are a plurality of springs 2124 used to set the required compression and force onto the bag placed between the top plate 2106 and a bottom plate 2108 (not shown in FIG. 21B). During operation, the one or more cams 2122 are pushed together to compress the springs 2124, which in turn exerts pressure on the bottom base 2118, which is in contact with the bag.

FIG. 21C shows simplified cross-sectional side view of the top plate 2106 in FIG. 20A and FIG. 20B. FIG. 21C also shows a bottom plate 2108 and a framed bag 2130 of Thermal insulation device is placed between the bottom base 2118 of the top plate 2106 and the bottom plate 2108. During degassing, vacuum suction is provided through the vacuum suction unit 2114 and the air suction pipe 2116. Air is drawn from the bottom base 2118, through the perforations 2112, pass the top portion 2120 of the top plate 2106, through the pipe 2116, and towards the air pumps of the vacuum suction unit 2114. The perforations 2112 are configured such that they are within the frame dimensions of the framed bag 2130. This ensures proper vacuum suction to the bag. The directions of the air drawn when degassing of the framed bag 2130 takes place are shown by small arrows in FIG. 21C. A big bold arrow shows a direction of pressure applied from the top plate 2106 towards the bottom plate 2108 to compress the framed bag 2130 to a predetermined frame height.

FIG. 21D shows a partially see-through enlarged view of the top conveyor 2102 and the bottom conveyor 2104. Movement of the plurality of interconnected top plates 2106 is driven by more than one sprocket wheels 2132 (one is shown in FIG. 21D; the other one is located at an opposite end of the top conveyor 2102). A motor or engine (not shown) is used to drive the sprocket wheels 2132 to move. The top conveyor 2102 comprises a top row 2136 of interconnected top plates 2106 and a bottom row 2138 of interconnected top plates 2106. Only the bottom row 2138 of the interconnected top plates 2106 will work with the bottom conveyor 2104 to degas and compress bags.

The force to be exerted on the framed bag 2130 between the top plate 2106 and a bottom plate 2108 is applied on the linear cams 2122 through one or more guides such as two rows of adjustable roller guides 2134 attached on two opposite left and right sides of the top conveyor 2102 respectively. The left side row of adjustable roller guides 2134 is shown in FIG. 21D. The wheels 2132 drive the interlocking top plates 2106 at the bottom row 2138 pass the two substantially parallel rows of adjustable roller guides 2134 (one row is shown in FIG. 21D). Each row of the adjustable roller guides 2134 guides the linear cams (rollers) 2122 to exert pressure on the plurality of springs 2124. The linear cams in turn push the plurality of springs, and the plurality of springs pushes the perforated bottom base 2118 of the top plate 2106.

The overall degassing time can be defined by the total conveyor length and conveyor speed. In the case where the bags are framed bags, the length of each top and bottom conveyor plate 2106 and 2108 depends on the length of the frames. The width of the frames defines the width of the conveyor plates 2106 and 2108. In the case where the bags are frameless, the length and width of each top and bottom conveyor plate 2106 and 2108 depends on the length of the Thermal insulation device or frames. The width of the frames defines the width of the conveyor plates 2106 and 2108. Therefore, in one example, the degassing time is a function of the total conveyor length and conveyor speed. The length of the conveyor is a function of the length of the Thermal insulation device or frames and the width of the conveyor is also a function of the width of the Thermal insulation device or frames.

FIG. 21E shows a side view of almost an entire length of an example of the degassing conveyor system 2100. The top conveyor 2102 and the bottom conveyor 2104 are shown.

As an example, to achieve a degassing time of approximately 30 sec at 50 ppm, the conveyor length can be approximately 8 m.

Although it is described that the degassing is done via vacuum suction through the top conveyor plate 2106 and the pressure is applied through the top conveyor plate 2106, it should be appreciated that in another example, such degassing and pressure application may be implemented on a bottom conveyor plate 2108 instead.

A computer/control system comprising one or more processors/controllers, and which may comprise one or more displays (i.e. monitors (e.g. based on LCD, LED, OLED etc.), touchscreens, etc.) for displaying a graphical user interface for user control and/or one or more user input/output interfaces (buttons, mouse, keyboard etc.) may be connected to the degassing conveyor apparatus/system 2100 to provide control over the movable parts (e.g. adjust positioning, adjust orientation, switch on/off, etc.), sensors (e.g. photocell), and process parameters (e.g. line speed, pressure, temperature etc.) in the degassing conveyor apparatus/system 2100.

With regard to the framed bag (e.g. 2130 in FIG. 21C), a Fire-retardant device, which is an ultra-thin, fire resistant (FR) sheet that reacts rapidly to high temperatures and fire, and is similar to the Fire-retardant device described previously, can be combined and inserted to a Framed Thermal insulation device degassed based on step 1706 of FIG. 17 described above or inserted prior to the degassing step 1706 of FIG. 17.

An example of the Fire-retardant device may have the following intumescent properties such as it is able to react rapidly at temperatures >175 Degrees Celsius, expand to 5 times its original thickness, create an insulating foam that fills voids and reduces heat transfer, is non-combustible, and has an inorganic formulation. The example of the Fire-retardant device may be a flexible sheet material, manufactured in bulk rolls for lamination and die-cutting. The Fire-retardant device may be available in standard thickness of 0.4 mm-1.0 mm. See Tables 13a and 13b below for details of the present example of the Fire-retardant device.

TABLE 13a
Typical Properties

| Property | Value |
|---|---|
| Thickness | About 0.4 mm |
| Weight per unit area | 650 g/sqm +/− 10% (0.133 lb/sq. ft) |
| Expansion activation | 150-200 Degrees Celsius |
| temperature | (302-392 Degrees Fahrenheit) |
| Tensile Strength | >300N (MD), >150N (TD), ISO 1924-2 |
| Expansion Ratio | 4-5 times initial thickness at |
| | 600 Degrees Celsius |
| Compressive Strength | 17% strain at 500 kPa |
| Thermal Conductivity at | <0.06 +/− 0.01 W/(m-K) at |
| five-times expansion | 24 Degrees Celsius) |

TABLE 13b
Product Range

Property

| Colour | White | |
|---|---|---|
| Thickness, mm (in) | 0.40-1.00 (0.016-0.04) | ISO 534: 2011 |
| REACH | Compliant | REACH candidate list of |
| | | SVHC 10 Jun. 2022 |
| RoHS | Compliant | RoHS Directive (EU) |
| | | 2015/863 |

With reference to FIG. 16A, the intention of the insertion process is to attach a Fire-retardant device 1602 on each side of an opening defined by each top frame layer 1604 and each bottom frame layer 1604 of the frame structure of the framed Thermal insulation device 1600a. The dimensions of the Fire-retardant device 1602 must be within the size of the opening defined by each frame layer 1604. After the Fire-retardant device insertion, the surface of the Fire-retardant device should be sealed with a sealing 1606, preferably immediately.

In one example, the Fire-retardant device may be squarish or rectangular in shape to fit a corresponding squarish or rectangular opening defined by a top or bottom frame layer used to frame the Thermal insulation device.

FIG. 22 illustrates an example of an assembly process of a Framed Thermal insulation device comprising the abovementioned Fire-retardant device 2204. The top views of a Framed Thermal insulation device 2202 and an unsealed Framed Thermal insulation device 2212 containing a Fire-retardant device 2204 are shown. The input to this assembly process is the Framed Thermal insulation device 2202 with an opening 2206 exposing the Thermal insulation device 2200 placed between a top frame layer 2208 and a bottom frame layer 2210.

An assembly apparatus can be used for the assembly process. This apparatus can comprise a control station, which comprises one or more processors or controllers for controlling the process. The control station may have a display for showing a graphical user interface for user control and setting. The display may be a touch screen display. The control station may comprise light indicators for indicating whether the apparatus is in operation, in various stages of operation, or not working. A plurality of user interfaces such as buttons, knobs, switches etc. may be provided at the control station for controlling the apparatus. The apparatus also comprises one or more motor or engine to drive its moving parts and a power supply.

At a first step, a first Fire-retardant device 2204 is placed into a first opening 2206 of a top or bottom frame layer 2208 or 2210. The first Fire-retardant device 2204 would contact the Thermal insulation device 2100 after it is inserted.

At a second step, the top or bottom major surface of the Framed Thermal insulation device 2202 is sealed to secure the first Fire-retardant device 2204 in the first opening 2206. More details on the sealing process will be described later. The sealing step is not shown in FIG. 22.

At a third step, the Framed Thermal insulation device 2202 is flipped. The reference numerals for the first Fire-retardant device 2204 and the first opening 2206 are re-used for a second Fire-retardant device and a second opening respectively, which are described as follows.

At a fourth step, the second Fire-retardant device 2204 is inserted into the second opening 2206 of the bottom or top frame layer 2210 or 2208 respectively. The second Fire-retardant device 2204 would contact the Thermal insulation device 2200 after it is inserted.

At a fifth step, the respective bottom or top surface of the Framed Thermal insulation device 2202 is sealed to secure the second Fire-retardant device 2204 in the second opening 2206. More details on the sealing process will be described later. The sealing step is not shown in FIG. 22.

The Fire-retardant device 2204 may be supplied from a bulk roll. Prior to the assembly process, a die-cutting process may be required to cut the Fire-retardant device 2204 into the correct size.

Furthermore, the Fire-retardant device 2204 may be supplied from more than one Fire-retardant devices that are stacked to one another. In this case, a release liner may be provided between the layers of the more than one Fire-retardant devices. This is to prevent the more than one Fire-retardant devices from sticking to each other, which will affect the picking up of each Fire-retardant device 2204 for insertion into the opening 2206 of the top or bottom frame layer 2208 or 2210 of the Framed Thermal insulation device 2202.

Optionally, the Fire-retardant device 2204 to be inserted may be adhered to the exposed surface of the Thermal insulation device 2100 in the opening 2206 of a top or bottom frame layer 2208 or 2210 of the Framed Thermal insulation device 2202.

A pick and place robot may be used to insert each Fire-retardant device 2204 into the opening 2206 defined by a frame layer 2208 or 2210 of the Framed Thermal insulation device 2202. For picking, a vacuum gripper could be considered.

Although in the example above, it is described that only one Fire-retardant device 2204 is picked and placed into each opening exposing the Thermal insulation device 2200, it should be appreciated that more than one Fire-retardant devices may be stacked and placed in each opening to provide enhanced effects.

The sealing step 1710 in FIG. 17 will now be described with reference to FIG. 22 and FIG. 22A. FIG. 22A shows a cross-sectional side view of a sealed and framed Thermal insulation device 2214, a top view of sealing being applied to the Framed Thermal insulation device 2212 and a top view of the sealed and framed Thermal insulation device 2214. After insertion of the first Fire-retardant device 2204, the surface with the inserted first Fire-retardant device 2204 is sealed before the Framed Thermal insulation device 2212 is flipped for the insertion of the second Fire-retardant device 2204. A seal layer 2216 is applied over the Framed Thermal insulation device 2212, which contains the inserted first Fire-retardant device 2204. After the Framed Thermal insulation device 2212 is flipped and the second Fire-retardant device 2204 is inserted, another seal layer 2216 is applied over the surface with the inserted second Fire-retardant device 2204 of the Framed Thermal insulation device 2212. The sealed and framed Thermal insulation device 2214 containing a Thermal insulation device 2200 between 2 Fire-retardant devices 2204 and 2 frame layers 2208 and 2210 is obtained after sealing is completed.

A label (or seal) applicator is a possible equipment to be used to apply the sealing. The seal may be a coating or a thin film of a suitable plastic material (e.g. a polymer sheet). In one example, two applicators may be used to seal both sides of the Framed Thermal insulation device together. FIG. 22B shows an example of the label applicator 2220. The label applicator 2220 comprises one or more spooling devices 2218 for mounting one or more bulk rolls of the sealing material. A plurality of guides 2222 are provided to guide the sealing material from a bulk roll towards a seal application member 2224, which has a cutter to cut the sealing material after a seal applied sufficiently covers the Framed Thermal insulation device. Sealing may be done immediately after framing even if no Fire-retardant device is to be inserted.

The assembly apparatus mentioned earlier may be configured to conduct the abovementioned sealing process. The assembly apparatus may comprise the pick and place robot and the label (or seal) applicator described earlier.

Quality check may be performed at various stages of steps 1702 to 1710 of FIG. 17. One quality criterion is that there should be the correct amount of material (powder) filled inside each Framed or frameless bag of Thermal insulation device. An inline checkweigher may be used to identify bags with an incorrect amount of material. See FIG. 23 for an example of such checkweigher 2300. The checkweigher 2300 comprises a fixture or platform 2302 for placing a bag to be weighed and a control unit 2304 for controlling the quality weight check process. Another example of the checkweigher 2300 is the apparatus 600 shown in FIG. 6 to FIG. 6B. The location of the checkweigher 2300 could be right after the bag filling machine i.e. the bag exiting the machine would be weighed. Bags with a wrong weight can be rejected and removed before the downstream processes commence. Weight checks can also be implemented right after other steps such as Steps 1702 to 1710 of FIG. 17. Checks involving computer vision to detect flaws can also be implemented after each step of FIG. 17.

If line speed is a concern, a two lane checkweigher (i.e. use of two lanes for weighing bags instead of one) can be used to speed up the weight checking. More lanes may be added as required.

The checkweigher 2300 can comprise a control station, which comprises one or more processors or controllers for controlling the process. The control station may have a display for showing a graphical user interface for user control and setting. The display may be a touch screen display. The control station may comprise light indicators for indicating whether the checkweigher 2300 is in operation, in various stages of operation, or not working. A plurality of user interfaces such as buttons, knobs, switches etc. may be provided at the control station for controlling the checkweigher 2300. The checkweigher 2300 comprises one or more motor or engine to drive its moving parts and a power supply.

In another example, with reference to FIG. 24 and FIG. 24A, the steps to frame and seal a bag of Thermal insulation device 2400 are described as follows. In this example, the bag of the Thermal insulation device 2400 is sealed by 3-sided sealing and has 3 seal areas 2402. It should be appreciated that in another example, a 4-sided sealed bag may be used if desired. These 3 seal areas 2402 comprises a first and second horizontal seal areas having the width of the bag 2400 as their length and they are residing at edges of the bag 2400 opposite to each other. The third center seal is orthogonal to the first and second horizontal seal areas.

Firstly, the Thermal insulation device 2400 is inserted into a main opening 2406 of a single piece frame structure 2404 (e.g. a silicone frame) to form a Framed Thermal insulation device 2400. Secondly, electrically insulating film layers 2406 are added or laid entirely or partially over major surfaces of the Framed Thermal insulation device 2400. Heat and Pressure is passed to these film layers 2406 to heat them and soften and/or melt them to become seals.

If a Framed and sealed Thermal insulation device and Fire-retardant device combination (e.g. 1600a in FIG. 16A) is to be made using the framing and sealing process described above, the Thermal insulation device 2400 described can be replaced by a Thermal insulation device adhered to 2 Fire-retardant device layers (e.g. 1602 in FIG. 16A).

Examples of the present disclosure may have the following features. The reference numerals in parentheses refer to the reference numerals of the elements in the Figures.

A method for manufacturing a Thermal insulation device (e.g. 100, 1500, 1608, 1800, 1804, 1900, 2004, 2200, 2400, 2500, 2510, 2520, 2530), wherein the method comprises:
forming a bag (e.g. 100, 400, 410, 522, 532, 808, 900, 1010, 2500, 2510, 2520, 2530, 1110, 1804, 1900, 2130, 2400) from a film material (e.g. FML1, FML2, FML3, FF4, 406, 1800) comprising perforations (e.g. 1802);
filling the bag with thermal insulation particles (e.g. FF1, FF2 and FF3) having size that does not pass through the perforations;
sealing one or more sides (e.g. 904, 906, 2538, 2016, 1904) of the bag so that the thermal insulation particles will not exit through the one or more sides of the bag; and
after an open side of the bag for filling the thermal insulation particles is sealed, compressing the bag to remove gas contained in the bag. The method may further comprise:
optionally, heating the bag as the bag is compressed; and optionally, cooling the bag as the bag is compressed. In another example, there could be more than one open sides of the bag for filling the thermal insulation particles.

The method may comprise:
applying tape and/or adhesive (e.g. 902) on a portion of the one or more sealed sides (e.g. 904, 906) of the bag; and
folding the one or more sealed sides of the bag to adhere the portion with the applied tape and/or adhesive to a main body of the bag (e.g. step 226).

The method may comprise:
passing the bag and the one or more sealed sides through a plurality of roller sets (e.g. 1012, 1014, 1016, 1018, 1020, 1022, 1024) to fold the one or more sealed sides of the bag to adhere the portion with the applied tape and/or adhesive to the main body of the bag, wherein the plurality of roller sets comprises roller sets configured with angled slopes to guide the one or more sealed sides to fold towards the main body of the bag (e.g. step 228).

The method may comprise:
imprinting a folding line on the one or more sealed sides of the bag prior to folding the one or more sealed sides.

The method may comprise:
folding one or more corners (e.g. 804) of the bag before folding the one or more sealed sides of the bag to adhere the portion with the applied tape and/or adhesive to the main body of the bag (e.g. step 224).

The thermal insulation particles may comprise a mixture of particles from more than one types of materials, wherein the method may comprise:
transferring the particles of the more than one types of materials into different containers (e.g. 302, 304a, 306a) sorted by the type of material;
weighing each container (e.g. 304a, 306a); and
dispensing the particles of each type of the materials from the respective container simultaneously into a mixing container (e.g. 308a, 310),
wherein the dispensing of the particles from the respective container (e.g. 304a, 306a) is stopped when the weight of the respective container reaches a predetermined weight (e.g. steps 206, 208 and 210). Dosing system B of FIG. 3A is an example performing these method steps.

In another example, the thermal insulation particles may comprise a mixture of particles from more than one types of materials, wherein the method may comprise:
transferring the particles of the more than one types of materials into different containers (e.g. 302, 304b, 306b) sorted by the type of material;
dispensing the particles of each type of the materials from the respective container (e.g. 304b, 306b) into a mixing container (e.g. 308b); and
weighing the mixing container,
wherein the dispensing of the particles is stopped when the weight of the mixing container reaches a predetermined weight (e.g. steps 206, 208 and 210). Dosing system C of FIG. 3A is an example performing these method steps.

The particles in the mixing container (e.g. 308a, 310) may be mixed homogeneously and transferred to more than one stores (e.g. 316, 318), wherein each storage is regarded as one batch of the mixed particles and the mixed particles are transferred to fill a plurality of the bag in batches.

The method may comprise:
feeding more than one layers of film and/or fabric (e.g. 1, 2 in FIG. 19);
pressing and heating the more than one layers of film and/or fabric to form the film material; and
perforating the film material to form the perforations.

The method may comprise:
feeding the film material to form the bag;
sealing the film material to form the one or more sealed sides of the bag but leaving one side of the bag unsealed;
filling the thermal insulation particles through the unsealed side of the bag; and
sealing the unsealed side of the bag after the filling of the thermal insulation particles into the bag is finished (e.g. step 218). Examples of these steps are described with reference to FIG. 5 and FIG. 19.

The method may comprise:
placing the bag between two plates (e.g. plates of an apparatus based on MLHP, plates of modules for pressure and heating 1206), wherein distance between the plates is adjustable to exert or release pressure on the bag to degas the bag; and heating the plates to provide heat treatment to the bag as pressure is exerted on the bag (e.g. step 232).

The method may comprise:
cooling the plates to cool the bag as pressure is exerted on the bag (e.g. step 232).

The method may comprise:
placing the bag in double-belt press conveyor (e.g. 1200) comprising a first endless belt (e.g. 1226) and a second endless belt (e.g. 1228), wherein the bag is to be positioned between the first endless belt and the second endless belt and be conveyed along a length of both the first endless belt and the second endless belt through synchronous movements of the first endless belt and the second endless belt, wherein the distance between the first endless belt and the second endless belt is adjustable to exert or release pressure on the bag (e.g. step 232).

A first piece of fabric may reside between the first endless belt and the bag, and a second piece of fabric may reside between the second endless belt and the bag, wherein the method comprises:
imprinting a pattern provided by the first piece of fabric and/or the second piece of fabric on the bag when pressure is exerted on the bag by the first endless belt and the second endless belt respectively.

A surface of the first endless belt contacting the bag may be coated, and a surface of the second endless belt contacting the bag may be coated, wherein the method may comprise: imprinting a pattern provided by one of or both the coated surfaces of the first endless belt and the second endless belt on the bag when pressure is exerted on the bag by the first endless belt and the second endless belt respectively.

The method may comprise:
heating the first endless belt and/or the second endless belt to provide heat treatment to the bag as pressure is exerted on the bag by the first endless belt and the second endless belt (step 232).

The method may comprise:
gradually increasing temperature of the first endless belt and/or the second endless belt in a direction the bag is conveyed by the first endless belt and/or the second endless belt to heat the bag while maintaining pressure on the bag; and exerting a predetermined highest pressure on the bag when the temperature is increased close to or is at a predetermined highest temperature (step 232).

The method may comprise:
cooling the first endless belt and/or the second endless belt to cool the bag as pressure is exerted on the bag by the first endless belt and the second endless belt (step 232). 50

The method may comprise:
gradually decreasing temperature of the first endless belt and/or the second endless belt until a predetermined cooling temperature in a direction the bag is conveyed by the first endless belt and/or the second endless belt to cool the bag while maintaining pressure on the bag (step 232).

The method may comprise:
cleaning the bag after the thermal insulation particles are sealed in the bag and before compressing the bag to remove gas contained in the bag (step 222); and
cleaning the bag after the bag is cooled (step 234).

The method may comprise:
applying tape and/or adhesive (e.g. 1408a, 1410a, 1412a, 1414a, and 1414b) on the bag to enable the bag to be adhered to another object,
wherein a release liner is provide on the tape and/or adhesive (e.g. step 238).

The method may comprise:
stacking more than one of the bag (e.g. 1500) on a bottom board (e.g. 1504) and stacking a top board (e.g. 1506) over a topmost stacked bag; and
strapping a bundle comprising the bottom board, the top board and the bags stacked between the bottom board and the top board.

The method may comprise:
adhering the bag on a first frame layer (e.g. 1604, 2006, 2208); and
adhering a second frame layer (e.g. 1604, 2002, 2210) over the bag to form a framed bag (e.g. 1600a, 1600b, 2130, 2214, 2400) comprising the first frame layer and the second frame layer as a frame structure.

The method may comprise:
adhering a single piece frame structure (e.g. 2404) to the bag to form a framed bag (e.g. 1600a, 1600b, 2130, 2214, 2400).

The method may comprise:
inserting a first layer of Fire-retardant device (e.g. 1602, 2204) into a first opening of the frame structure (e.g. 1604, 2006, 2208, 2404) to cover an exposed surface of the bag; and
inserting a second layer of Fire-retardant device (e.g. 1602, 2204) into a second opening of the frame structure to cover another exposed surface of the bag.

The method may comprise:
sealing a first external side of the framed bag; and sealing a second external side of the framed bag, wherein the second external side is opposite of the first external side.

The method may comprise:
drawing air from the bag using vacuum suction to degas the bag.

The method may comprise:
weighing the bag after the bag is sealed and filled, wherein if the weight of the bag is close to or has exceeded limits of an acceptable weight range, a feedback data signal to adjust dosage is communicated electronically to increase or decrease dosing amount of the thermal insulation particles to be filled into each bag. For example, the apparatus 600 in FIG. 6 may be equipped with such feedback control to work with the apparatus 400 in FIG. 4 for adjusting dosing amount in real-time.

The method may comprise:
during or prior to compressing the bag to remove gas contained in the bag, vibrating the bag to level the thermal insulation particles filled in the bag.

The method may comprise:
disposing a framed or frameless version of the bag (e.g. 2130, 1500) between a top conveyor plate (e.g. 2106) of a plurality of top conveyor plates and a bottom conveyor plate (e.g. 2108) of a plurality of bottom conveyor plates,
wherein the top conveyor plate is configured to exert pressure on the framed or frameless bag between the top conveyor plate and the bottom conveyor plate to degas the framed or frameless bag.

The top conveyor plate or the bottom conveyor plate may comprise one or more biasing member (e.g. 2124) to facilitate release of pressure acting on the framed or frameless bag.

The top or bottom conveyor plate may comprise a pushing mechanism comprising one or more cams (e.g. 2122) mounted to the top or bottom conveyor plate, wherein the method may comprise:

moving the top or bottom conveyor plate pass a plurality of guides (e.g. 2134) configured to exert pressure on the one or more cams to push the top or bottom conveyor plate against the bag, thereby exerting pressure on the bag between the top conveyor plate and the bottom conveyor plate.

The top or bottom conveyor plates may comprise perforations (e.g. 2112) for contacting and degassing the bag, wherein the method comprises:
drawing air through the perforations in contact with the bag to degas the bag.

A system for manufacturing a Thermal insulation device (e.g. 100, 1500, 1608, 1800, 1804, 1900, 2004, 2200, 2400, 2500, 2510, 2520, 2530), wherein the system comprises:
a forming tool (e.g. 528, 1910, 8 to 18 of FIG. 19) for forming a bag (e.g. 100, 400, 410, 522, 532, 808, 900, 1010, 2500, 2510, 2520, 2530, 1110, 1804, 1900, 2130, 2400) from a film material (e.g. FML1, FML2, FML3, FF4, 406, 1800) comprising perforations (e.g. 1802);
a filler (e.g. 400, 404, 502, and 22 and 23 of FIG. 19) for filling the bag with thermal insulation particles (e.g. FF1, FF2 and FF3) having size that does not pass through the perforations;
one or more sealers (e.g. 514, 518, and 10, 11, 12, 25, and 26 of FIG. 19) for sealing one or more sides (e.g. 904, 906, 2538, 2016, 1904) of the bag so that the thermal insulation particles will not exit through the one or more sides of the bag; and
a compression apparatus (e.g. 1200, 2100) for compressing the bag to remove gas contained in the bag after an open side of the bag for filling the thermal insulation particles is sealed. The system may further comprise:
optionally, a heater (e.g. 1206a, 1206b, 1206c, 1206d, 1206e, 1212, 1214) for heating the bag as the bag is compressed; and optionally, a cooler (e.g. 1208, 1208a) for cooling the bag as the bag is compressed. In another example, there could be more than one open sides of the bag for filling the thermal insulation particles.

The system may comprise:
a tape and/or adhesive applicator (e.g. 908) for applying tape and/or adhesive (e.g. 902) on a portion of the one or more sealed sides (e.g. 904, 906) of the bag; and
a folding apparatus (e.g. 1000) for folding the one or more sealed sides of the bag to adhere the portion with the applied tape and/or adhesive to a main body of the bag.

The folding apparatus may comprise:
a transporter (e.g. 1001) for passing the bag and the one or more sealed sides through a plurality of roller sets (e.g. 1012, 1014, 1016, 1018, 1020, 1022, 1024) to fold the one or more sealed sides of the bag to adhere the portion with the applied tape and/or adhesive to the main body of the bag, wherein the plurality of roller sets comprises roller sets configured with angled slopes to guide the one or more sealed sides to fold towards the main body of the bag.

The plurality of roller sets may comprise:
a roller set (e.g. 1012) configured to imprint a folding line on the one or more sealed sides of the bag prior to the folding of the one or more sealed sides.

The folding apparatus may be configured for folding one or more corners (e.g. 804) of the bag before folding the one or more sealed sides of the bag to adhere the portion with the applied tape and/or adhesive to the main body of the bag.

The thermal insulation particles may comprise a mixture of particles from more than one types of materials, wherein the system may comprise:
different containers (e.g. 302, 304a, 306a) sorted by type of material for receiving the particles of the more than one types of materials;
a weighing device (e.g. load cells D) for weighing each container (e.g. 304a, 306a); and
a dispenser (e.g. 304a and 306a are configured for dispensing) for dispensing the particles of each type of the materials from the respective container simultaneously into a mixing container (e.g. 308a, 310),
wherein the dispensing of the particles from the respective container (e.g. 304a, 306a) is stopped when the weight of the respective container reaches a predetermined weight. Dosing system B of FIG. 3A is an example described by these features.

The thermal insulation particles may comprise a mixture of particles from more than one types of materials, wherein the system may comprise:
different containers (e.g. 302, 304b, 306b) sorted by type of material for receiving the particles of the more than one types of materials;
a dispenser for dispensing the particles of each type of the materials from the respective container (e.g. 304b, 306b) into a mixing container (e.g. 308b); and
a weighing device (e.g. load cells D) for weighing the mixing container, wherein the dispensing of the particles is stopped when the weight of the mixing container reaches a predetermined weight. Dosing system C of FIG. 3A is an example described by these features.

With regard to the system, the particles in the mixing container (e.g. 308a, 310) may be mixed homogeneously and transferred to more than one stores (e.g. 316, 318), wherein each storage is regarded as one batch of the mixed particles and the mixed particles are transferred to fill a plurality of the bag in batches.

The system may comprise:
a feeder (e.g. 406, 506, 524, 1 to 4 of FIG. 19) for feeding more than one layers of film and/or fabric;
a press and heat device for pressing and heating the more than one layers of film and/or fabric to form the film material; and
a perforation punch (e.g. 5 in FIG. 19) for perforating the film material to form the perforations. Examples of these steps are described with reference to FIG. 5 and FIG. 19.

The system may comprise:
a feeder (e.g. 406, 506, 524, 1 to 7 of FIG. 19) for feeding the film material to form the bag,
wherein the one or more sealers (e.g. 514, 518, and 10, 11, 12, 25, and 26 of FIG. 19) are configured for sealing the film material to form the one or more sealed sides of the bag but leaving one side of the bag unsealed,
wherein the filler is configured for filling the thermal insulation particles through the unsealed side of the bag, and
wherein one of the one or more sealers (e.g. 518, 25 and 26 of FIG. 19) is configured for sealing the unsealed side of the bag after the filling of the thermal insulation particles into the bag is finished.

The system may comprise:
a plurality of plates (e.g. plates of an apparatus based on MLHP, plates of modules for pressure and heating 1206) for receiving one or more of the bag between two plates of the plurality of plates, wherein distance between the plates is adjustable to exert or release pressure on the bag to degas the bag; and
a heating element for heating the plates to provide heat treatment to the bag as pressure is exerted on the bag.

The system may comprise:
a cooler (e.g. 1208, 1208a) for cooling the plates to cool the bag as pressure is exerted on the bag.

The system may comprise:
a double-belt press conveyor (e.g. 1200) comprising a first endless belt (e.g. 1226) and a second endless belt (e.g. 1228), wherein the bag is to be positioned between the first endless belt and the second endless belt and be conveyed along a length of both the first endless belt and the second endless belt through synchronous movements of the first endless belt and the second endless belt, wherein the distance between the first endless belt and the second endless belt is adjustable to exert or release pressure on the bag.

With regard to the system, a first piece of fabric may reside between the first endless belt and the bag, and a second piece of fabric may reside between the second endless belt and the bag, wherein the first piece of fabric and/or the second piece of fabric imprint a pattern on the bag when pressure is exerted on the bag by the first endless belt and the second endless belt respectively.

With regard to the system, a surface of the first endless belt contacting the bag may be coated, and a surface of the second endless belt contacting the bag may be coated, wherein one of or both the coated surfaces imprint a pattern on the bag when pressure is exerted on the bag by the first endless belt and the second endless belt respectively.

The system may comprise:
one or more heaters (e.g. 1206a, 1206b, 1206c, 1206d, 1206e, 1212, 1214) for heating the first endless belt and/or the second endless belt to provide heat treatment to the bag as pressure is exerted on the bag by the first endless belt and the second endless belt.

The system may comprise:
more than one of the heaters (e.g. 1206a, 1206b, 1206c, 1206d, 1206e, 1212, 1214) disposed along the first endless belt and the second endless belt for gradually increasing temperature of the first endless belt and/or the second endless belt in a direction the bag is conveyed by the first endless belt and/or the second endless belt to heat the bag while maintaining pressure on the bag; and
a heating and compression module (e.g. 1206b, 1206e) for exerting a predetermined highest pressure on the bag when the temperature is increased close to or is at a predetermined highest temperature.

The system may comprise:
one or more coolers (e.g. 1208, 1208a) for cooling the first endless belt and/or the second endless belt to cool the bag as pressure is exerted on the bag by the first endless belt and the second endless belt.

The system may comprise:
more than one of the coolers (e.g. 1208, 1208a) disposed along the first endless belt and the second endless belt for gradually decreasing temperature of the first endless belt and/or the second endless belt until a predetermined cooling temperature in a direction the bag is conveyed by the first endless belt and/or the second endless belt to cool the bag while maintaining pressure on the bag.

The system may comprise:
a cleaning apparatus for cleaning the bag after the thermal insulation particles are sealed in the bag and before compressing the bag to remove gas contained in the bag, and for cleaning the bag after the bag is cooled.

The system may comprise:
a tape and/or adhesive applicator for applying tape and/or adhesive (e.g. 1408a, 1410a, 1412a, 1414a, and 1414b) on the bag to enable the bag to be adhered to another object, wherein a release liner is provided on the applied tape and/or adhesive.

The system may comprise:
a first pick and place device for stacking more than one of the bag (e.g. 1500) on a bottom board (e.g. 1504) and stacking a top board (e.g. 1506) over a topmost stacked bag; and
a strapping device for strapping a bundle comprising the bottom board, the top board and the bags stacked between the bottom board and the top board.

The system may comprise:
a platform for holding a first frame layer (e.g. 1604, 2006, 2208); and a second pick and place device
for moving the bag to adhere the bag onto the first frame layer, and
for moving a second frame layer (e.g. 1604, 2002, 2210) to adhere the second frame layer over the bag to form a framed bag (e.g. 1600a, 1600b, 2130, 2214, 2400) comprising the first frame layer and the second frame layer as a frame structure.

The system may comprise:
a third pick and place device for moving a single piece frame structure (e.g. 2404) to adhere the single piece frame structure to the bag to form a framed bag (e.g. 1600a, 1600b, 2130, 2214, 2400).

The system may comprise:
a fourth pick and place device for inserting a first layer of Fire-retardant device (e.g. 1602, 2204) into a first opening (e.g. 2008, 2206, 2406) of the frame structure (e.g. 1604, 2006, 2208, 2404) to cover an exposed surface of the bag, and
for inserting a second layer of Fire-retardant device (e.g. 1602, 2204) into a second opening (e.g. 2008, 2206, 2406) of the frame structure to cover another exposed surface of the bag.

The system may comprise:
a seal applicator (e.g. 2220)
for sealing a first external side of the framed bag, and
for sealing a second external side of the framed bag, wherein the second external side is opposite of the first external side.

The system may comprise:
a vacuum suction device (e.g. 2114) for drawing air from the bag using vacuum suction to degas the bag.

The system may comprise:
a weighing device (e.g. 600, 2300) for weighing the bag after the bag is sealed and filled, wherein if the weight of the bag is close to or has exceeded limits of an acceptable weight range, a feedback data signal to adjust dosage of powder is communicated electronically to increase or decrease dosing amount of the thermal insulation particles to be filled into each bag.

The system may comprise:
a vibration device (e.g. 1204) for vibrating the bag to level the thermal insulation particles filled in the bag during or prior to compressing the bag to remove gas contained in the bag.

The system may comprise:
a top conveyor (e.g. 2102) comprising a plurality of top conveyor plates; and
a bottom conveyor (e.g. 2104) comprising a plurality of bottom conveyor plates, wherein a framed or frameless version of the bag (e.g. 2130, 1500) is disposed between a top conveyor plate (e.g. 2106) of the plurality of top conveyor plates and a bottom conveyor plate (e.g. 2108) of the plurality of bottom conveyor plates,
wherein the top conveyor plate is configured to exert pressure on the bag between the top conveyor plate and the bottom conveyor plate to degas the framed or frameless bag.

With regard to the system, the top conveyor plate or the bottom conveyor plate may comprise one or more biasing member (e.g. 2124) to facilitate release of pressure acting on the framed or frameless bag.

With regard to the system, the top or bottom conveyor plate may comprise a pushing mechanism comprising one or more cams (e.g. 2122) mounted to the top or bottom conveyor plate and a plurality of guides (e.g. 2134) for exerting pressure on the one or more cams to push the top or bottom conveyor plate against the bag, thereby exerting pressure on the bag between the top conveyor plate and the bottom conveyor plate.

With regard to the system, the top or bottom conveyor plates may comprise perforations (e.g. 2112) for contacting and degassing the bag, and the perforations are in fluid connection with a vacuum suction device (e.g. 2114) operable to draw air through the perforations.

All the apparatuses described in the present disclosure including 400, 600, 800, 1000, 1200, 1300, 2100, the stacking and/or packaging apparatus, the cleaning apparatuses, the framing apparatus, the assembly apparatus for inserting FR devices and sealing, and/or 2300 may have individual control stations as described. Some or all of these apparatuses, regardless whether they interact with or are linked to each other, can be said to be all part of one manufacturing system for making the Thermal insulation device according to examples of the present disclosure. In another example, it could be that there are lesser number of control stations or only one control station for controlling all the processes as described. Data communication between the control stations, computer vision systems, and/or testing systems or data communication between sensors and control station may be wired or wireless. The required electric cables and/or transceivers would be provided for this.

In the present disclosure, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

While the invention has been described in the present disclosure in connection with a number of examples, embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method for manufacturing a Thermal insulation device, wherein the method comprises:
forming a bag from a film material comprising perforations;
filling the bag with thermal insulation particles having size that does not pass through the perforations;
sealing one or more sides of the bag so that the thermal insulation particles will not exit through the one or more sides of the bag;
after an open side of the bag for filling the thermal insulation particles is sealed, compressing the bag to remove gas contained in the bag;
heating the bag as the bag is compressed; and
cooling the bag as the bag is compressed.

2. The method of claim 1, wherein the method comprises:
applying tape and/or adhesive on a portion of the one or more sealed sides of the bag; and
folding the one or more sealed sides of the bag to adhere the portion with the applied tape and/or adhesive to a main body of the bag.

3. The method of claim 2, wherein the method comprises:
passing the bag and the one or more sealed sides through a plurality of roller sets to fold the one or more sealed sides of the bag to adhere the portion with the applied tape and/or adhesive to the main body of the bag, wherein the plurality of roller sets comprises roller sets configured with angled slopes to guide the one or more sealed sides to fold towards the main body of the bag.

4. The method of claim 3, wherein the method comprises:
imprinting a folding line on the one or more sealed sides of the bag prior to folding the one or more sealed sides.

5. The method of claim 2, wherein the method comprises:
folding one or more corners of the bag before folding the one or more sealed sides of the bag to adhere the portion with the applied tape and/or adhesive to the main body of the bag.

6. The method of claim 1, wherein the thermal insulation particles comprise a mixture of particles from more than one types of materials, wherein the method comprises:
transferring the particles of the more than one types of materials into different containers sorted by the type of material;
weighing each container; and
dispensing the particles of each type of the materials from the respective container simultaneously into a mixing container,
wherein the dispensing of the particles from the respective container is stopped when the weight of the respective container reaches a predetermined weight.

7. The method of claim 1, wherein the thermal insulation particles comprise a mixture of particles from more than one types of materials, wherein the method comprises:
transferring the particles of the more than one types of materials into different containers sorted by the type of material;
dispensing the particles of each type of the materials from the respective container into a mixing container; and
weighing the mixing container,
wherein the dispensing of the particles is stopped when the weight of the mixing container reaches a predetermined weight.

8. The method of claim 4, wherein the particles in the mixing container are mixed homogeneously and transferred to more than one stores, wherein each storage is regarded as one batch of the mixed particles and the mixed particles are transferred to fill a plurality of the bag in batches.

9. The method of claim 1, wherein the method comprises:
feeding more than one layers of film and/or fabric;
pressing and heating the more than one layers of film and/or fabric to form the film material; and
perforating the film material to form the perforations.

10. The method of claim 1, wherein the method comprises:
feeding the film material to form the bag;
sealing the film material to form the one or more sealed sides of the bag but leaving one side of the bag unsealed;
filling the thermal insulation particles through the unsealed side of the bag; and
sealing the unsealed side of the bag after the filling of the thermal insulation particles into the bag is finished.

11. The method of claim 1, wherein the method comprises:
placing the bag between two plates, wherein distance between the plates is adjustable to exert or release pressure on the bag to degas the bag; and
heating the plates to provide heat treatment to the bag as pressure is exerted on the bag.

12. The method of claim 11, wherein the method comprises:
cooling the plates to cool the bag as pressure is exerted on the bag.

13. The method of claim 1, wherein the method comprises:
placing the bag in double-belt press conveyor comprising a first endless belt and a second endless belt, wherein the bag is to be positioned between the first endless belt and the second endless belt and be conveyed along a length of both the first endless belt and the second endless belt through synchronous movements of the first endless belt and the second endless belt, wherein the distance between the first endless belt and the second endless belt is adjustable to exert or release pressure on the bag.

14. The method of claim 13, wherein a first piece of fabric resides between the first endless belt and the bag, and a second piece of fabric resides between the second endless belt and the bag, wherein the method comprises:
imprinting a pattern provided by the first piece of fabric and/or the second piece of fabric on the bag when pressure is exerted on the bag by the first endless belt and the second endless belt respectively.

15. The method of claim 13, wherein a surface of the first endless belt contacting the bag is coated, and a surface of the second endless belt contacting the bag is coated, wherein the method comprises:
imprinting a pattern provided by one of or both the coated surfaces of the first endless belt and the second endless belt on the bag when pressure is exerted on the bag by the first endless belt and the second endless belt respectively.

16. The method of claim 13, wherein the method comprises:
heating the first endless belt and/or the second endless belt to provide heat treatment to the bag as pressure is exerted on the bag by the first endless belt and the second endless belt.

17. The method of claim 16, wherein the method comprises:
gradually increasing temperature of the first endless belt and/or the second endless belt in a direction the bag is conveyed by the first endless belt and/or the second endless belt to heat the bag while maintaining pressure on the bag; and
exerting a predetermined highest pressure on the bag when the temperature is increased close to or is at a predetermined highest temperature.

18. The method of claim 16, wherein the method comprises:
cooling the first endless belt and/or the second endless belt to cool the bag as pressure is exerted on the bag by the first endless belt and the second endless belt.

19. The method of claim 18, wherein the method comprises:
gradually decreasing temperature of the first endless belt and/or the second endless belt until a predetermined cooling temperature in a direction the bag is conveyed by the first endless belt and/or the second endless belt to cool the bag while maintaining pressure on the bag.

20. The method of claim 18, wherein the method comprises:
cleaning the bag after the thermal insulation particles are sealed in the bag and before compressing the bag to remove gas contained in the bag; and
cleaning the bag after the bag is cooled.

21. The method of claim 1, wherein the method comprises:
applying tape and/or adhesive on the bag to enable the bag to be adhered to another object, wherein a release liner is provided on the applied tape and/or adhesive.

22. The method of claim 1, wherein the method comprises:
stacking more than one of the bag on a bottom board and stacking a top board over a topmost stacked bag; and
strapping a bundle comprising the bottom board, the top board and the bags stacked between the bottom board and the top board.

23. The method of claim 1, wherein the method comprises:
adhering the bag on a first frame layer; and
adhering a second frame layer over the bag to form a framed bag comprising the first frame layer and the second frame layer as a frame structure.

24. The method of claim 23, wherein the method comprises:
adhering a single piece frame structure to the bag to form a framed bag.

25. The method of claim 23, wherein the method comprises:
inserting a first layer of Fire-retardant device into a first opening of the frame structure to cover an exposed surface of the bag; and
inserting a second layer of Fire-retardant device into a second opening of the frame structure to cover another exposed surface of the bag.

26. The method of claim 23, wherein the method comprises:
sealing a first external side of the framed bag; and
sealing a second external side of the framed bag, wherein the second external side is opposite of the first external side.

27. The method of claim 1, wherein the method comprises:
drawing air from the bag using vacuum suction to degas the bag.

28. The method of claim 1, wherein the method comprises:
weighing the bag after the bag is sealed and filled, wherein if the weight of the bag is close to or has exceeded limits of an acceptable weight range, a feedback data signal to adjust dosage is communicated electronically to increase or decrease dosing amount of the thermal insulation particles to be filled into each bag.

29. The method of claim 1, wherein the method comprises:
during or prior to compressing the bag to remove gas contained in the bag, vibrating the bag to level the thermal insulation particles filled in the bag.

30. The method of claim 1, wherein the method comprises:
disposing a framed or frameless version of the bag between a top conveyor plate of a plurality of top conveyor plates and a bottom conveyor plate of a plurality of bottom conveyor plates,
wherein the top conveyor plate is configured to exert pressure on the framed or frameless bag between the top conveyor plate and the bottom conveyor plate to degas the framed or frameless bag.

31. The method of claim 30, wherein the top conveyor plate or the bottom conveyor plate comprises one or more biasing member to facilitate release of pressure acting on the framed or frameless bag.

32. The method of claim 30, wherein the top or bottom conveyor plate comprises a pushing mechanism comprising one or more cams mounted to the top or bottom conveyor plate, wherein the method comprises:
moving the top or bottom conveyor plate pass a plurality of guides configured to exert pressure on the one or more cams to push the top or bottom conveyor plate against the bag, thereby exerting pressure on the bag between the top conveyor plate and the bottom conveyor plate.

33. The method of claim 30, wherein the top or bottom conveyor plates comprises perforations for contacting and degassing the bag, wherein the method comprises:
drawing air through the perforations in contact with the bag to degas the bag.

34. A system for manufacturing a Thermal insulation device, wherein the system comprises:
a forming tool for forming a bag from a film material comprising perforations;
a filler for filling the bag with thermal insulation particles having size that does not pass through the perforations;
one or more sealers for sealing one or more sides of the bag so that the thermal insulation particles will not exit through the one or more sides of the bag; and
a compression apparatus for compressing the bag to remove gas contained in the bag after an open side of the bag for filling the thermal insulation particles is sealed,
wherein the bag is to be subjected to heating as the bag is compressed and the bag is to be subjected to cooling as the bag is compressed.

35. The system of claim 34, wherein the system comprises:
a tape and/or adhesive applicator for applying tape and/or adhesive on a portion of the one or more sealed sides of the bag; and
a folding apparatus for folding the one or more sealed sides of the bag to adhere the portion with the applied tape and/or adhesive to a main body of the bag.

36. The system of claim 35, wherein the folding apparatus comprises:
a conveyor for passing the bag and the one or more sealed sides through a plurality of roller sets to fold the one or more sealed sides of the bag to adhere the portion with the applied tape and/or adhesive to the main body of the bag, wherein the plurality of roller sets comprises roller sets configured with angled slopes to guide the one or more sealed sides to fold towards the main body of the bag.

37. The system of claim 36, wherein the plurality of roller sets comprises:
a roller set configured to imprint a folding line on the one or more sealed sides of the bag prior to the folding of the one or more sealed sides.

38. The system of claim 35, wherein the folding apparatus is configured for folding one or more corners of the bag before folding the one or more sealed sides of the bag to adhere the portion with the applied tape and/or adhesive to the main body of the bag.

39. The system of claim 34, wherein the thermal insulation particles comprise a mixture of particles from more than one types of materials, wherein the system comprises:
different containers sorted by type of material for receiving the particles of the more than one types of materials;
a weighing device for weighing each container; and
a dispenser for dispensing the particles of each type of the materials from the respective container simultaneously into a mixing container,
wherein the dispensing of the particles from the respective container is stopped when the weight of the respective container reaches a predetermined weight.

40. The system of claim 34, wherein the thermal insulation particles comprise a mixture of particles from more than one types of materials, wherein the system comprises:
different containers sorted by type of material for receiving the particles of the more than one types of materials;
a dispenser for dispensing the particles of each type of the materials from the respective container into a mixing container; and
a weighing device for weighing the mixing container,
wherein the dispensing of the particles is stopped when the weight of the mixing container reaches a predetermined weight.

41. The system of claim 39, wherein the particles in the mixing container are mixed homogeneously and transferred to more than one stores, wherein each storage is regarded as one batch of the mixed particles and the mixed particles are transferred to fill a plurality of the bag in batches.

42. The system of claim 34, wherein the system comprises:
a feeder for feeding more than one layers of film and/or fabric;
a press and heat device for pressing and heating the more than one layers of film and/or fabric to form the film material; and
a perforation punch for perforating the film material to form the perforations.

43. The system of claim 34, wherein the system comprises:
a feeder for feeding the film material to form the bag,
wherein the one or more sealers are configured for sealing the film material to form the one or more sealed sides of the bag but leaving one side of the bag unsealed,
wherein the filler is configured for filling the thermal insulation particles through the unsealed side of the bag, and
wherein one of the one or more sealers is configured for sealing the unsealed side of the bag after the filling of the thermal insulation particles into the bag is finished.

44. The system of claim 34, wherein the system comprises:
a plurality of plates for receiving one or more of the bag between two plates of the plurality of plates, wherein distance between the plates is adjustable to exert or release pressure on the bag to degas the bag; and
a heating element for heating the plates to provide heat treatment to the bag as pressure is exerted on the bag.

45. The system of claim 44, wherein the system comprises:
a cooler for cooling the plates to cool the bag as pressure is exerted on the bag.

46. The system of claim 34, wherein the system comprises:
a double-belt press conveyor comprising a first endless belt and a second endless belt, wherein the bag is to be positioned between the first endless belt and the second endless belt and be conveyed along a length of both the first endless belt and the second endless belt through synchronous movements of the first endless belt and the second endless belt, wherein the distance between the first endless belt and the second endless belt is adjustable to exert or release pressure on the bag.

47. The system of claim 46, wherein a first piece of fabric resides between the first endless belt and the bag, and a second piece of fabric resides between the second endless belt and the bag, wherein the first piece of fabric and/or the second piece of fabric imprint a pattern on the bag when pressure is exerted on the bag by the first endless belt and the second endless belt respectively.

48. The system of claim 46, wherein a surface of the first endless belt contacting the bag is coated, and a surface of the second endless belt contacting the bag is coated, wherein one of or both the coated surfaces imprint a pattern on the bag when pressure is exerted on the bag by the first endless belt and the second endless belt respectively.

49. The system of claim 46, wherein the system comprises:
one or more heaters for heating the first endless belt and/or the second endless belt to provide heat treatment to the bag as pressure is exerted on the bag by the first endless belt and the second endless belt.

50. The system of claim 49, wherein the system comprises:
more than one of the heaters disposed along the first endless belt and the second endless belt for gradually increasing temperature of the first endless belt and/or the second endless belt in a direction the bag is conveyed by the first endless belt and/or the second endless belt to heat the bag while maintaining pressure on the bag; and
a heating and compression module for exerting a predetermined highest pressure on the bag when the temperature is increased close to or is at a predetermined highest temperature.

51. The system of claim 49, wherein the system comprises:
one or more coolers for cooling the first endless belt and/or the second endless belt to cool the bag as pressure is exerted on the bag by the first endless belt and the second endless belt.

52. The system of claim 51, wherein the system comprises:
more than one of the coolers disposed along the first endless belt and the second endless belt for gradually decreasing temperature of the first endless belt and/or the second endless belt until a predetermined cooling temperature in a direction the bag is conveyed by the first endless belt and/or the second endless belt to cool the bag while maintaining pressure on the bag.

53. The system of claim 51, wherein the system comprises:
a cleaning apparatus
for cleaning the bag after the thermal insulation particles are sealed in the bag and before compressing the bag to remove gas contained in the bag, and
for cleaning the bag after the bag is cooled.

54. The system of claim 34, wherein the system comprises:
a tape and/or adhesive applicator for applying tape and/or adhesive on the bag to enable the bag to be adhered to another object,
wherein a release liner is provided on the applied tape and/or adhesive.

55. The system of claim 34, wherein the system comprises:
a first pick and place device for stacking more than one of the bag on a bottom board and stacking a top board over a topmost stacked bag; and
a strapping device for strapping a bundle comprising the bottom board, the top board and the bags stacked between the bottom board and the top board.

56. The system of claim 55, wherein the system comprises:
a platform for holding a first frame layer; and
a second pick and place device
for moving the bag to adhere the bag onto the first frame layer, and
for moving a second frame layer to adhere the second frame layer over the bag to form a framed bag comprising the first frame layer and the second frame layer as a frame structure.

57. The system of claim 55, wherein the system comprises:
a second pick and place device for moving a single piece frame structure to adhere the single piece frame structure to the bag to form a framed bag.

58. The system of claim 56, wherein the system comprises:
a third pick and place device
for inserting a first layer of Fire-retardant device into a first opening of the frame structure to cover an exposed surface of the bag, and
for inserting a second layer of Fire-retardant device into a second opening of the frame structure to cover another exposed surface of the bag.

59. The system of claim 56, wherein the system comprises:
a seal applicator
for sealing a first external side of the framed bag, and
for sealing a second external side of the framed bag, wherein the second external side is opposite of the first external side.

60. The system of claim 34, wherein the system comprises:
a vacuum suction device for drawing air from the bag using vacuum suction to degas the bag.

61. The system of claim 34, wherein the system comprises:
a weighing device for weighing the bag after the bag is sealed and filled, wherein if the weight of the bag is close to or has exceeded limits of an acceptable weight range, a feedback data signal to adjust dosage of powder is communicated electronically to increase or decrease dosing amount of the thermal insulation particles to be filled into each bag.

62. The system of claim 34, wherein the system comprises:
a vibration device for vibrating the bag to level the thermal insulation particles filled in the bag during or prior to compressing the bag to remove gas contained in the bag.

63. The system of claim 34, wherein the system comprises:
a top conveyor comprising a plurality of top conveyor plates; and
a bottom conveyor comprising a plurality of bottom conveyor plates,
wherein a framed or frameless version of the bag is disposed between a top conveyor plate of the plurality of top conveyor plates and a bottom conveyor plate of the plurality of bottom conveyor plates,
wherein the top conveyor plate is configured to exert pressure on the bag between the top conveyor plate and the bottom conveyor plate to degas the framed or frameless bag.

64. The system of claim 63, wherein the top conveyor plate or the bottom conveyor plate comprises one or more biasing member to facilitate release of pressure acting on the framed or frameless bag.

65. The system of claim 63, wherein the top or bottom conveyor plate comprises a pushing mechanism comprising one or more cams mounted to the top or bottom conveyor plate and a plurality of guides for exerting pressure on the one or more cams to push the top or bottom conveyor plate against the bag, thereby exerting pressure on the bag between the top conveyor plate and the bottom conveyor plate.

66. The system of claim 63, wherein the top or bottom conveyor plates comprises perforations for contacting and degassing the bag, and the perforations are in fluid connection with a vacuum suction device operable to draw air through the perforations.
